(19) United States
(12) Patent Application Publication
(10) Pub. No.: US 2019/0205972 A1
(43) Pub. Date: Jul. 4, 2019

(54) METHOD AND SYSTEM FOR CLOUD/INTERNET GRAPHICAL INCLUSIVE DEPICTION OF CONSANGUINITY AFFINITY FICTIVE KINSHIP FAMILY TREES

(71) Applicant: ELIAS ANDRES CIUDAD, PARLIN, NJ (US)

(72) Inventor: ELIAS ANDRES CIUDAD, PARLIN, NJ (US)

(21) Appl. No.: 15/858,996

(22) Filed: Dec. 29, 2017

(51) Int. Cl. G06Q 30/06; G06F 17/30

(52) U.S. Cl. CPC G06Q 30/0641; H04L 67/10; G06F 17/30604; G06F 17/30327

(57) ABSTRACT

The present invention relates to the field of internet and cloud electronic graphical depiction of family and organizational trees, more specifically in the method and system for internet/cloud graphical depiction of inclusive of consanguinity, affinity and fictive kinship family tree members nodes using hierarchy of relationships. The present invention also directed to a method and system for usage and enhancing of family and relational hierarchies composed of member nodes to procure goods and services from participating merchants in a selected internet network/marketplace to procure and provide goods and services to all member nodes using their geo locations.

### BACKGROUND

### 1. Field of the Invention

The present invention relates generally to the field of internet and cloud electronic graphical depiction of family and organizational trees. More particularly, the present invention relates to a method and system for internet/cloud graphical depiction of inclusive of consanguinity, affinity and fictive kinship family tree members nodes using hierarchy of relationships. The invention also present is also directed to a method and system for usage and enhancing of family and relational hierarchies composed of member nodes to procure goods and services from participating merchants in a selected internet network/marketplace to procure and provide goods and services to all member nodes using their geo locations.

### 2. Related Art

The Internet, also known as the cloud has done a remarkable job of bringing people together. There are many relational hierarchy services available through the Internet and the cloud with the goal of building family and relational trees. The continue changes in our societies have redefined the terms and structure of traditional families. Modern families are now composed of members that are not only bound by consanguinity hierarchy relations, since many jurisdictions have enacted various statutory mandates redefining the traditional family, encompassing relations not limited to civil unions, same sex civil unions, surrogate family relationships, foster parenting, adoption parenting, affinity law and fictive kinship relationship. Modern families do not have the methodology to concatenate, trace and depict its hierarchy as it changes through the passage of time, social interaction and statutory changes. The traditional anthropologist concept of building and depicting family and hierarchy trees, does not help the modern family anymore. Member nodes of a traditional family tree do not have means to access a market place and expend a great deal of time on researching for goods and services of all types and magnitudes for the members of the family hierarchy, even if they are deceased, after all, members of a family group that have passed away still have the need for goods and services.

### BRIEF SUMMARY OF THE INVENTION

These and other problems are solved by the present invention which comprises of a system and method for internet/cloud graphical depiction of inclusive of consanguinity, affinity and fictive kinship family tree members nodes using hierarchy of relationships, will be delivered or rendered as shown in some embodiments.

In some embodiments, with this invention of method and system for graphical depiction of inclusive of consanguinity, affinity and fictive kinship family tree members nodes using hierarchy of relationships and members nodes, not limited to modern and traditional families, will be able to use their member node profiles and current locations defined by longitude and latitude in combination with geo location position to depict, obtain and interact with all members their family and hierarchy. As well as, obtain services and products available at a network/marketplace in the internet, as shown on other embodiments.

Method and system for internet/cloud graphical depiction of inclusive of consanguinity, affinity and fictive kinship family tree members, are presented in other embodiments. In some embodiments, a method includes the display of login member node in a display device of a computer system or other devices connected to the internet, also known as the cloud. In other embodiments, a method further includes member node flow into the network/marketplace from the family tree and hierarchy in which the member's node is associated. The method further includes the display of one or more than one node inclusive and not limited to consanguinity, affinity and fictive kinship associated with the family tree and hierarchy for each parent generations pertaining to the member tree owner login node. A method further displays the geo locations of the login member tree owner node and additional nodes associated with the family tree and hierarchy and the login node.

In some other embodiments, a method further graphically depicts and displays all the member nodes associated with the family tree and hierarchy, without limitation of quantity or member nor generations and it goes back to the beginning of times as long as there is a member node profile and its linked to a member in the hierarchy inclusive of consanguinity, affinity and fictive kinship.

### BRIEF DESCRIPTION OF THE DRAWINGS

A further understanding of the nature and capabilities of the present invention may be realized by reference to the drawings. In the enclosed figures, elements and components may have reference labels.

FIG. 1A-1E show an exemplary flow of the system and method for the present invention;

FIGS. 2 shows an exemplary of the flow for the of the member login node access for the present invention;

FIGS. 3A-3G show an exemplary of the logic flow for the of the member tree owner building of relationship nodes;

FIGS. 4A-4B show an exemplary of the logic flow for the selection of both parental family tree root nodes of the member tree owner;

FIGS. 5A-5E show an exemplary list of the member nodes selection for the graphical depiction of the one first parental node of the member tree owner;

FIGS. 6A-6C show an exemplary list of the member nodes selection for the graphical depiction of the one second parental node of the member tree owner;

FIGS. 7A-7F show an exemplary of the logic block diagram of the method for selecting and identifying the unique member nodes belonging to the member tree owner;

FIGS. 8A-8B show an exemplary of a simplified block diagram of the method for graphically depicting both parental for the tree owner node;

FIG. 9 shows an exemplary of a simplified method for mapping the geo location for all member nodes to graphically depict them on a global map;

FIG. 10 shows an exemplary of the services available to each member node in the graphically depicted family tree.

FIGS. 11A-11T show an exemplary of graphical view of the depiction of the second parental family tree of the tree owner node.

FIG. 12 shows an exemplary of the services available to all member nodes in the graphically depicted family tree.

FIGS. 13A-13Z show an exemplary of graphical view of the depiction of the first parental family tree of the tree owner node.

FIG. 14 shows an exemplary of the tags to join all member nodes in the graphically depicted family tree.

### DETAILED DESCRIPTION OF THE INVENTION

While various aspects of certain embodiments have been summarized above, these and other aspects at the present invention shall now be described by the way of exemplary embodiments to which the present invention is not limited with reference to the accompanying drawing figures in which:

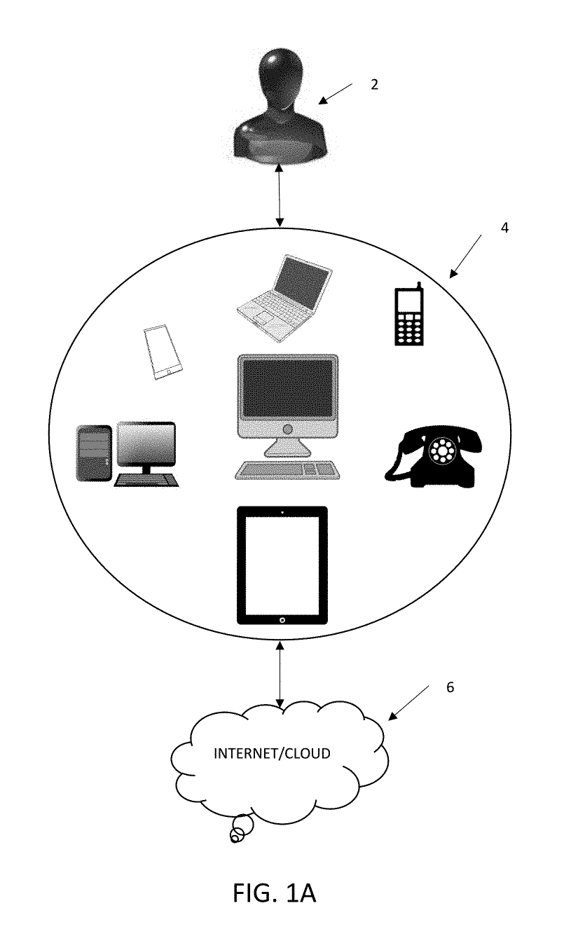

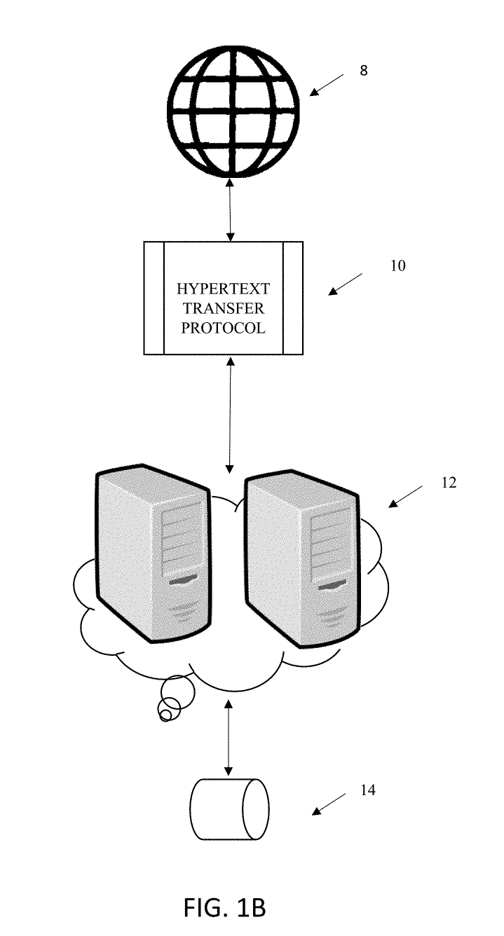

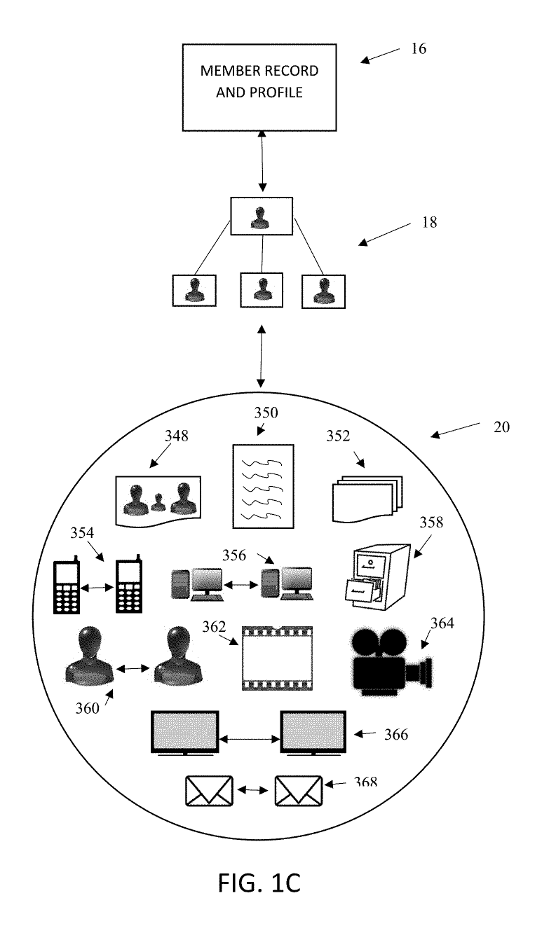

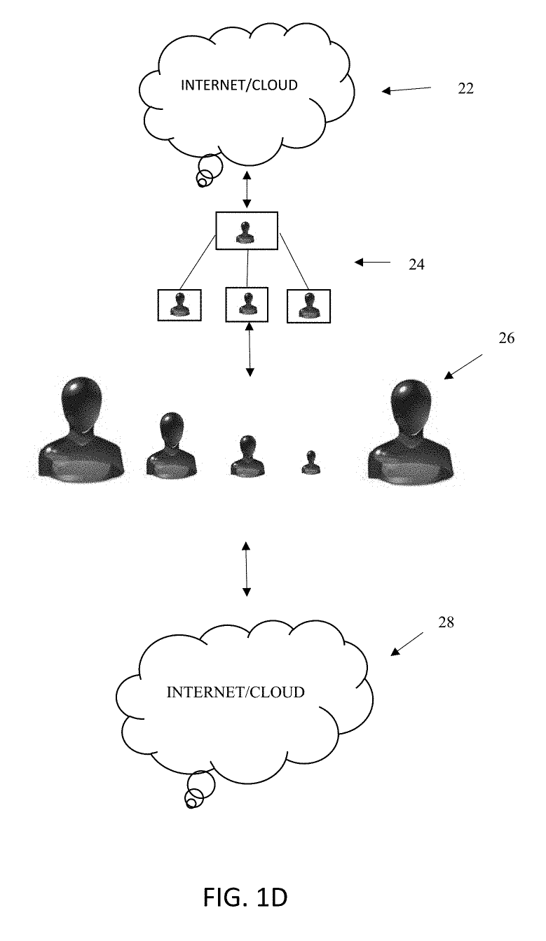

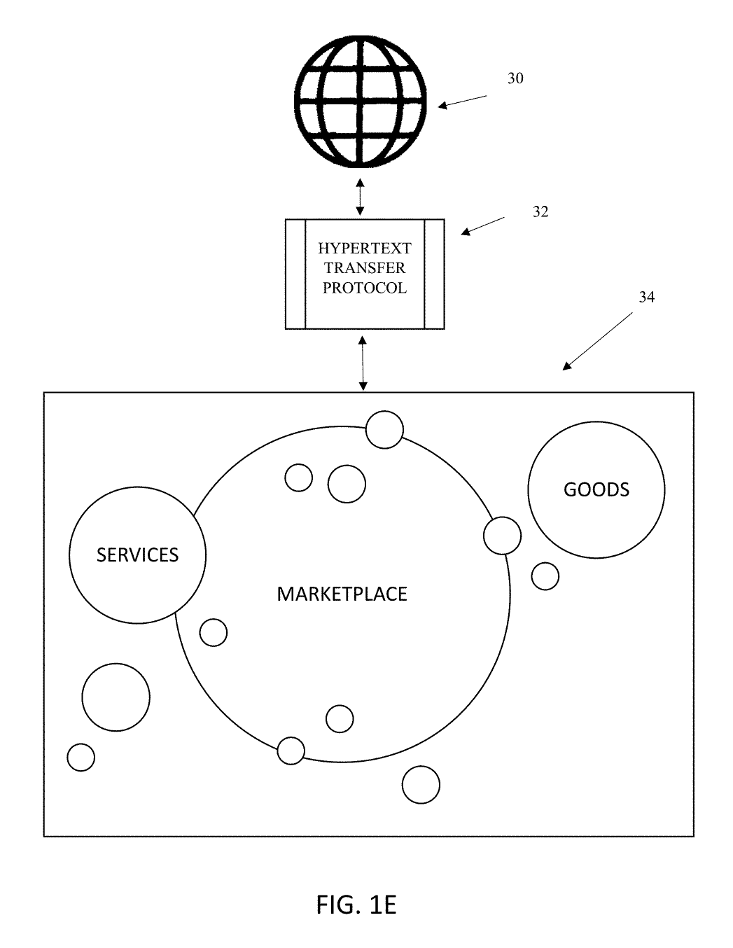

With reference now to the figures and in particular with references to FIGS. 1A-1E, exemplary diagrams of the flow of the system and method are provided in which illustrative embodiments may be implemented. It should be appreciated that FIGS. 1A-1E are only exemplary and are not intended to assert or imply any limitation with regards to the environment in which different embodiments may be implemented. Many modifications to the depicted environments may be made.

With reference now to the figures, FIG. 1A depicts a pictorial representation of the flow of system and method in which an illustrative embodiment may be implemented. The flow contains a login member node 2, which is the starting point of system, an individual that may belong to an organization such as a family and others, an is the medium that through the usage of a computer or other devices in circle 4, such as but not limited a personal computer, tablet, smartphones, Macintosh computers, iPad, iPhone and laptops computers, which may include connections, such as wire, wireless communication links of fiber optics cables connect to the internet/cloud 6.

With reference now to figure, FIG. 1B and proceeding from FIG. 1A, FIG. 1B depicts a pictorial representation of the flow of system and method in which an illustrative embodiment may be implemented. The flow contains the continuation and starting point of the World Wide Web. In the depicted example, World Wide Web 8, a connection from the internet/cloud 6 on FIG. 1A, connects to hypertext transfer protocol page 10, which on turns connects to applet in a server in the internet/cloud 12, along with a database 14.

With reference now to figure, FIG. 1C and proceeding from FIG. 1B, FIG. 1C depicts a pictorial representation of the flow of system and method in which an illustrative embodiment may be implemented. The flow contains the continuation and starting point of the login member node record and profile 16. In the depicted example, the login member node record and profile 16, access his or her organizational tree 18, and access the amenities of his or her organization membership 20, such as but not limited to file storage 358, and archiving 352, music storing and playing 350, video clip storing and playing 362, voice messaging storing and recording 354, presentation storing and displaying 366, email and messaging 368, conferencing 366, video recording 364, file exchange 356, media and picture storing, displaying 348 and member chat 360.

With reference now to figure, FIG. 1D and proceeding from FIG. 1C, FIG. 1D depicts a pictorial representation of the flow of system and method in which an illustrative embodiment may be implemented. The flow contains the continuation and starting point of the Internet/Cloud 22. In the depicted example, the Internet/Cloud 22, flows through the member login node organizational tree 24, from the point a selection by the member login node 2 on FIG. 1A, select member(s) from his or her organization 26, as a recipient for goods and services to be acquired, the flows connect and continues to the internet/cloud 28.

With reference now to figured, FIG. 1E and proceeding from FIG. 1D, FIG. 1E depicts a pictorial representation of the flow of system and method in which an illustrative embodiment may be implemented. The flow contains the continuation and starting point of the World Wide Web 68. In the depicted example, the World Wide Web 30, flows through the hypertext transfer protocol page 32, from this with the information of the recipient location and good and services to be acquired a search in performed in the network/marketplace 34 for such goods or services.

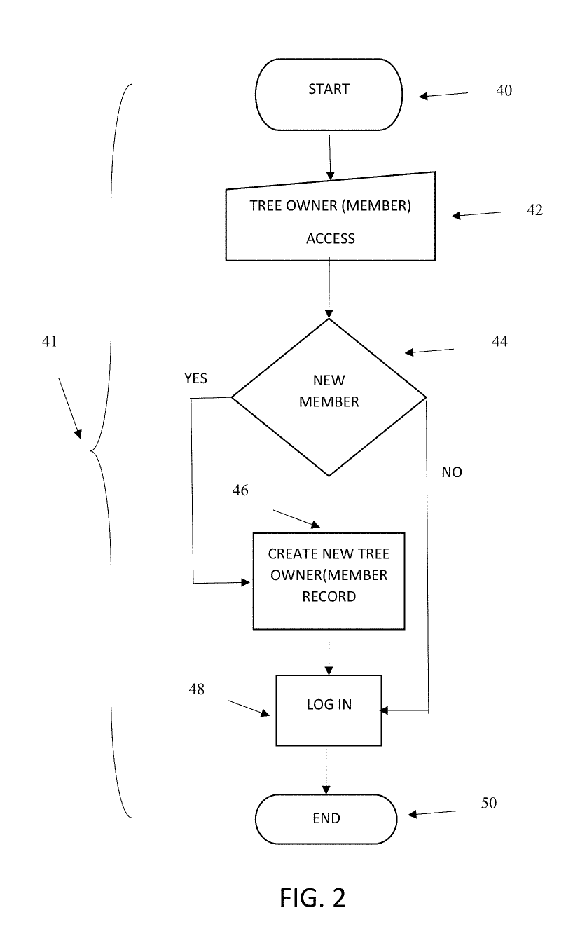

With reference now to FIG. 2, is an exemplary diagram for the flow of the member login node access, in which an illustrative embodiment may be implemented 41. It should be appreciated that FIG. 2 is only exemplary and is not intended to assert or imply any limitation with regards to the environment in which different embodiments may be implemented. Many modifications to the depicted environments may be made.

With reference now to the figures, FIG. 2 depicts a pictorial representation of an exemplary embodiment of the flow to create a tree owner record access node 40. The member login node is able to create access by logging into the system through the hypertext transfer protocol page on an internet web portal 42, if she or he is a new member node 44, the member is required to create a new member login node record 46, if the member is an existing member, he or she is required to login 48, once the member creates the record 46, member is able to login 48, once the member is log into the system, member should be able to access members node 50.

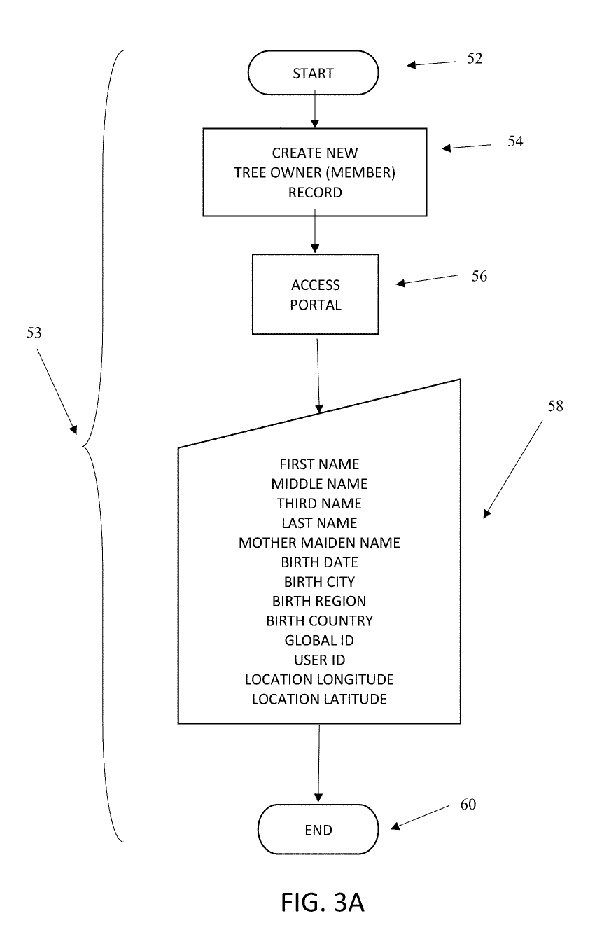

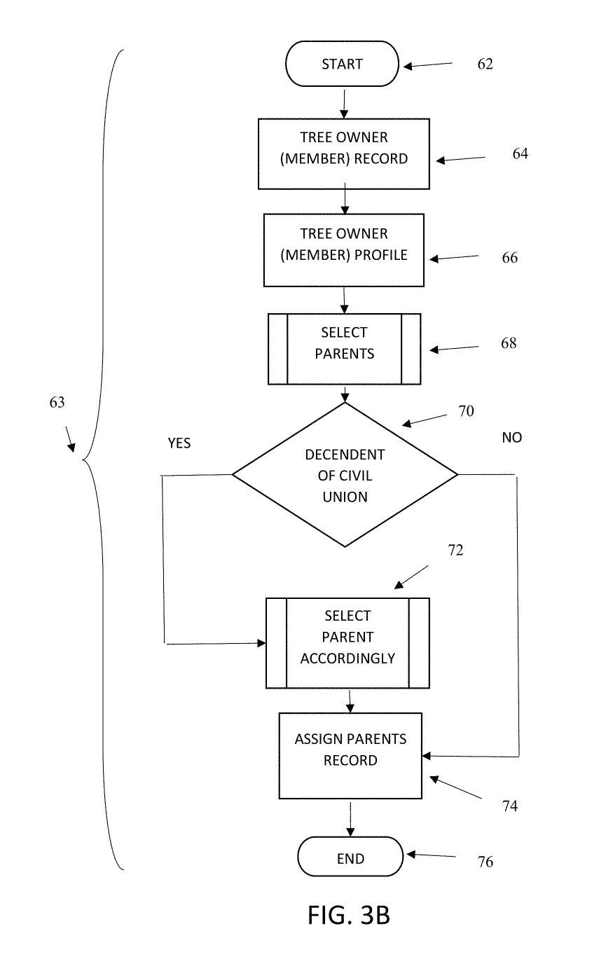

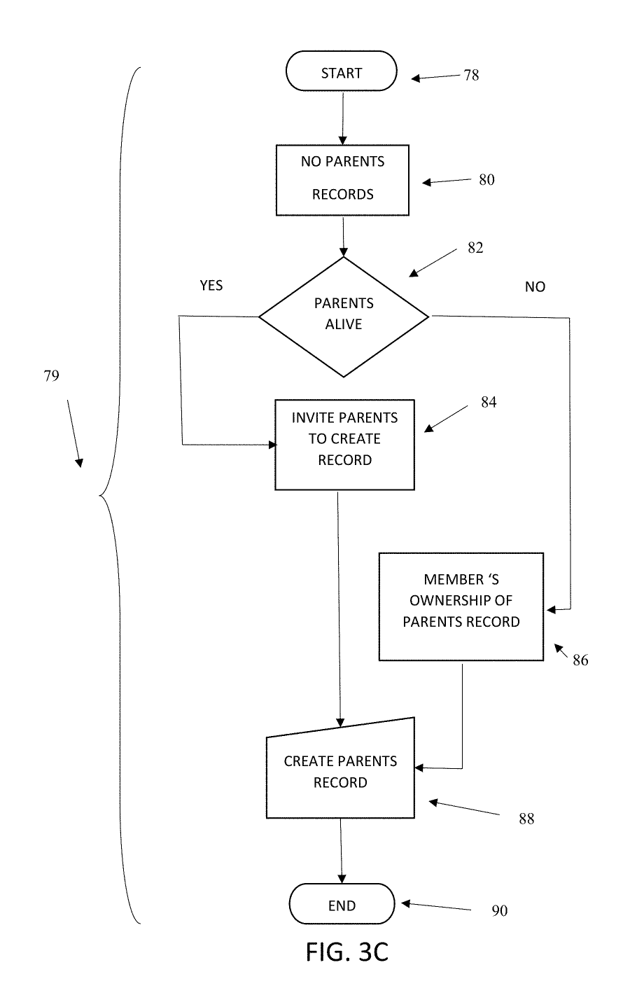

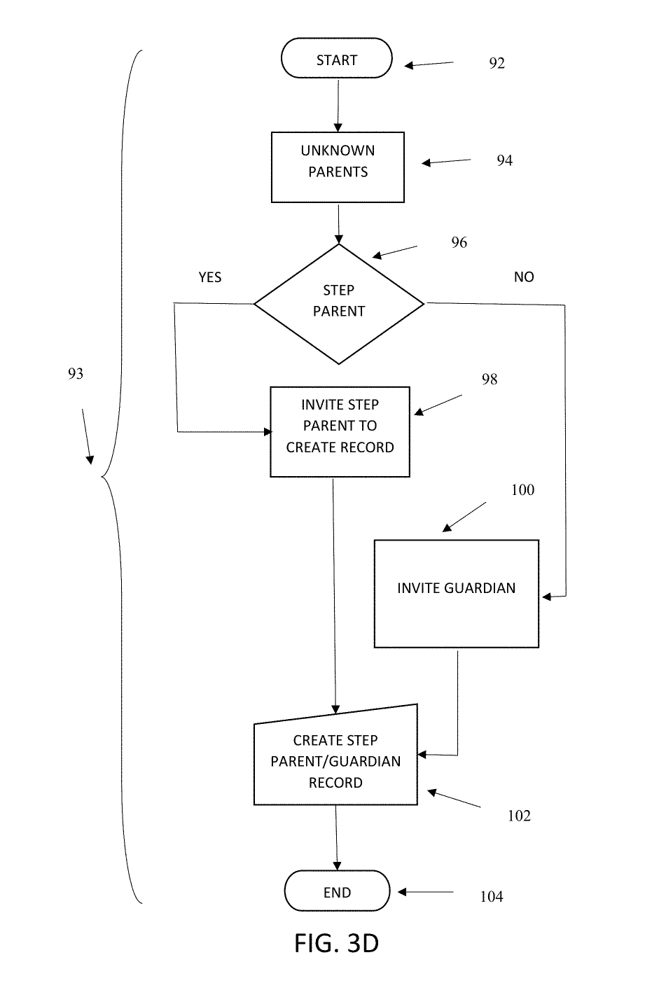

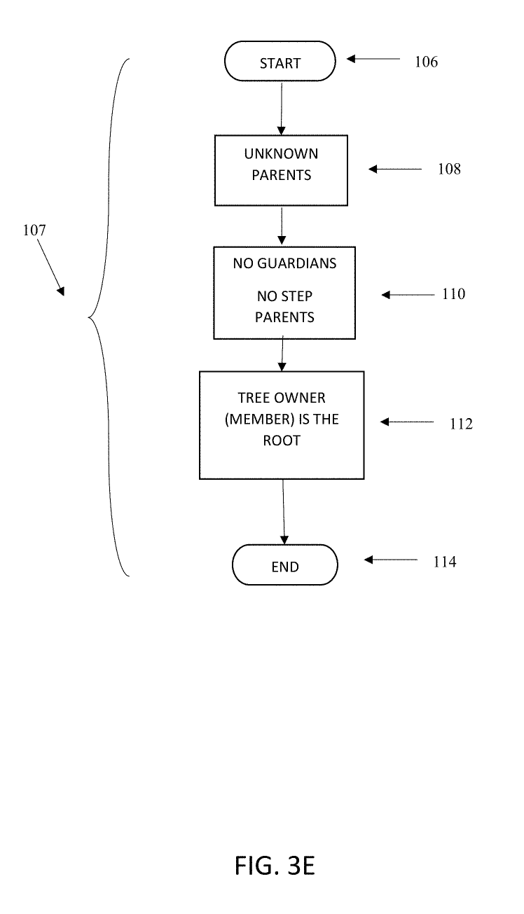

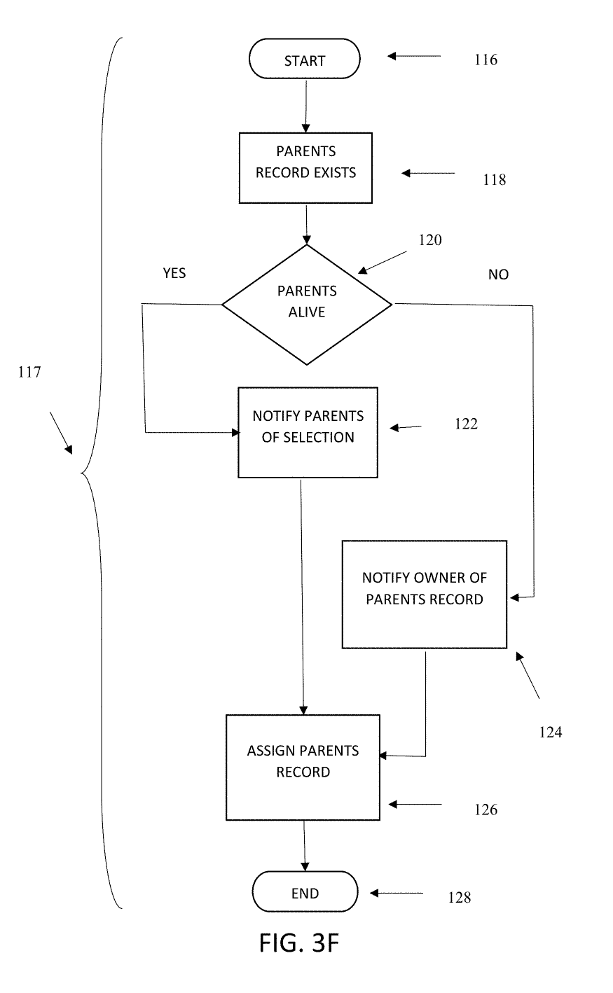

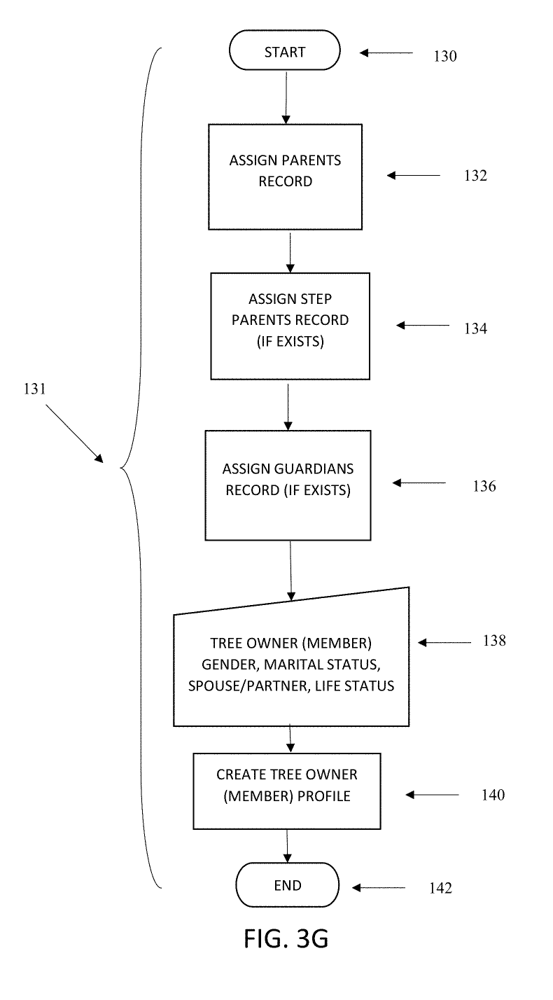

With reference now to the figures and in particular with references to FIGS. 3A-3G, are exemplary diagrams of the flow of the system and method are provided in which illustrative embodiments may be implemented. It should be appreciated that FIGS. 3A-3G are only exemplary and are not intended to assert or imply any limitation with regards to the environment in which different embodiments may be implemented. Many modifications to the depicted environments may be made.

With reference now to the figures, FIG. 3A depicts a pictorial representation of the flow of system and method in which an illustrative embodiment may be implemented. The flow 53 contains the starting logical point 52 of creating a tree owner record node 54 through the access portal 56. The new member is required to enter basic information such as but not limited to first name, middle name (if given), third name (if given), last name or first parent last name, mother maiden name or second parent last name, birth date, birth city, birth region, birth country, enter a unique global identification code, enter a unique user identification code, select longitude and latitude of current residence 58 and save the basic record 60.

With reference now to figure, FIG. 3B and proceeding from FIG. 3A, FIG. 3B depicts a pictorial representation of the flow of system and method in which an illustrative embodiment may be implemented. The flow contains the continuation and starting point of the basic record 60 on FIG. 3A. The flow 63 contains the starting logical point 62 for the tree owner 64 in his or her member profile 66, selecting both or a single parent 68. The tree owner must specify if he or she is a descendent of a civil union or not 70 and select his or her parent accordingly 72 and assign parents to his or her record correctly 74, then save record 76.

With reference now to figure, FIG. 3C and proceeding from FIG. 3B, FIG. 3C depicts a pictorial representation of the flow of system and method in which an illustrative embodiment may be implemented. The flow contains the continuation and starting point of the basic record 76 on FIG. 3B. The flow 79 contains the starting logical point 78 for the tree owner in which no parent record assignment was found in the entire tree 80, if his or her parents are alive 82, the tree owner should invite them to create their owner records in the system 84, otherwise the tree owner should take control or assign a representative to control their records 86, then his or her parent records should be created 88 and save in the system 90.

With reference now to figure, FIG. 3D and proceeding from FIG. 3C, FIG. 3D depicts a pictorial representation of the flow of system and method in which an illustrative embodiment may be implemented. The flow contains the continuation and starting point of the basic record 76 on FIG. 3B. The flow 93 contains the starting logical point 92 for the tree owner in which his or her parents are unknown 94. If parents are from affinity source 96, the invite parents to create record 98, otherwise invite fictive kinship to create records 100, then create affinity or fictive kinship records in system 102 and save records 104.

With reference now to figure, FIG. 3E and proceeding from FIG. 3D, FIG. 3E depicts a pictorial representation of the flow of system and method in which an illustrative embodiment may be implemented. The flow contains the continuation and starting point of the basic record 76 on FIG. 3B. The flow 107 contains the starting logical point 106 for the tree owner in which his or her parents are unknown 108. If parents are not from affinity source nor from fictive kinship 110, the tree owner becomes the root of the family tree 112 and save records 114.

With reference now to figure, FIG. 3F and proceeding from FIG. 3E, FIG. 3F depicts a pictorial representation of the flow of system and method in which an illustrative embodiment may be implemented. The flow contains the continuation and starting point of the basic record 76 on FIG. 3B. The flow 117 contains the starting logical point 116 for the tree owner in which his or her parents exist in the system 118. If parents are alive 120, system will notify them of the tree owner selection as parents 122, otherwise system will notify the records administrator of the tree owner selection as parents 124, assign records in system 126 and save records 128.

With reference now to figure, FIG. 3G and proceeding from FIG. 3F, FIG. 3G depicts a pictorial representation of the flow of system and method in which an illustrative embodiment may be implemented. The flow contains the continuation and starting point of the basic record 76 on FIG. 3B. The flow 131 contains the starting logical point 130 for the tree owner in which his or her parents exist in the system and are assigned 132, the tree owner in which his or her affinity parents exist in the system and are assigned 134, the tree owner in which his or her fictive kinship relation or guardians exist in the system and are assigned 136. Then, the tree owner selection of his or her gender, marital status, spouse or partner and life status are recorded in system 138. The creation of the tree owner record profile 140 and saving of record 142.

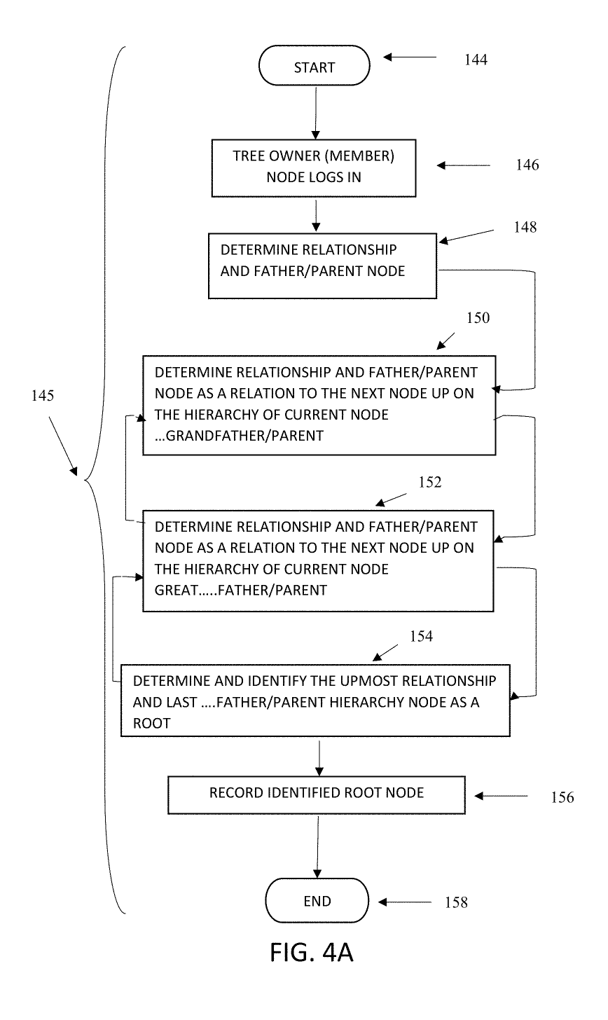

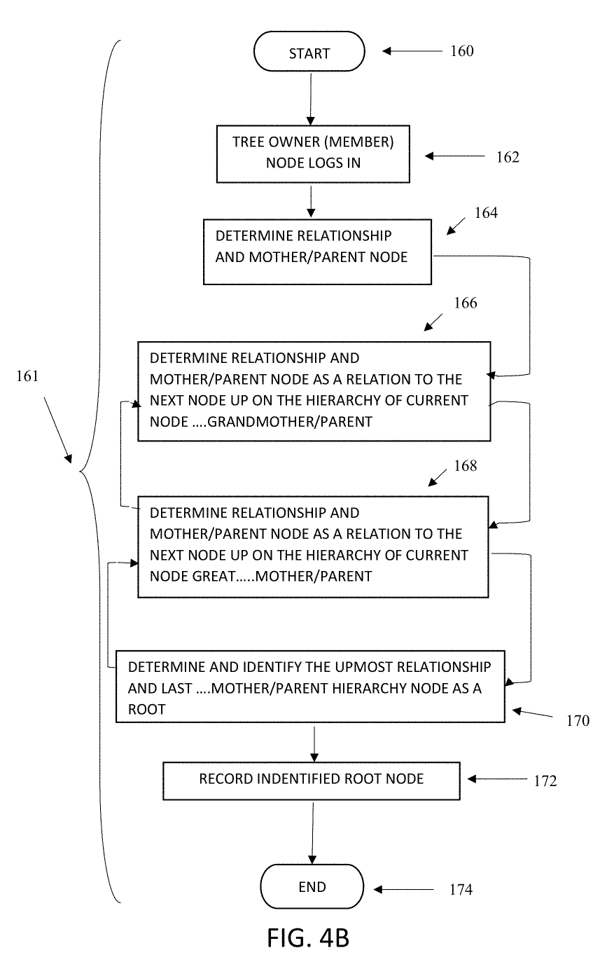

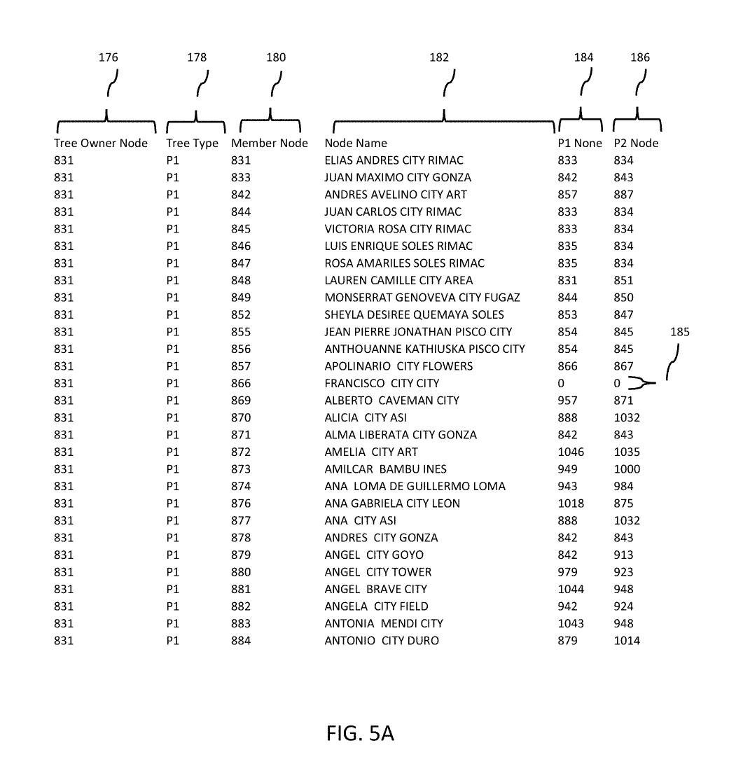

With reference now to the figures and in particular with references to FIGS. 4A-4B, are exemplary diagrams for the tree owner member root of family identification in preparation to graphically depicting the family tree, in which illustrative embodiments may be implemented. It should be appreciated that FIGS. 4A-4B are only exemplary and are not intended to assert or imply any limitation with regards to the environment in which different embodiments may be implemented. Many modifications to the depicted environments may be made.

With reference now to figure, FIG. 4A depicts a pictorial representation of an exemplary embodiment for the flow of the tree owner first parent root of family identification in preparation to graphically depicting the family tree. The flow 145, contains the starting point of the basic record 144. The tree owner member logs in to his or her profile 146, the system determines the first parent's relationship and nodes from the tree owner 148. The system login further analyses the tree owner parent's relationship to their parents 150, the further evaluates and determines the relationship to grandparents to their parents 152. Then the system determines and identifies if the later is the relationship node is the upmost the member tree owner hierarchy 154. If it is not, the system loops back to 150. If it, then the system identifies record as the root of the family for the first parent (consanguinity, affinity and fictive kinship) of the tree owner 156 and save the records 158.

With reference now to figure, FIG. 4B and proceeding from FIG. 4A, FIG. 4B depicts a pictorial representation of an exemplary embodiment for the flow of the tree owner second parent root of family identification in preparation to graphically depicting the family tree. The flow 161, contains the starting point of the basic record 160. The tree owner member logs in to his or her profile 162, the system determines the second parent's relationship and nodes from the tree owner 164. The system login further analyses the tree owner parent's relationship to their parents 166, the further evaluates and determines the relationship to grandparents to their parents 168. Then the system determines and identifies if the latter is the relationship node is the upmost the member tree owner hierarchy 170. If it is not, the system loops back to 166. If it is, then the system identifies record as the root of the family for the second parent (consanguinity, affinity and fictive kinship) of the tree owner 172 and save the records 174.

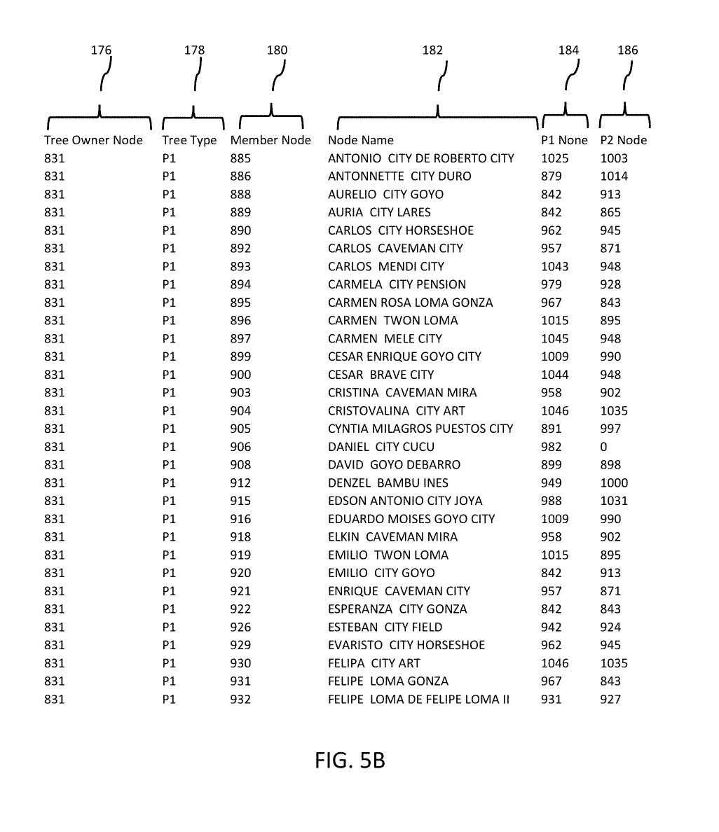

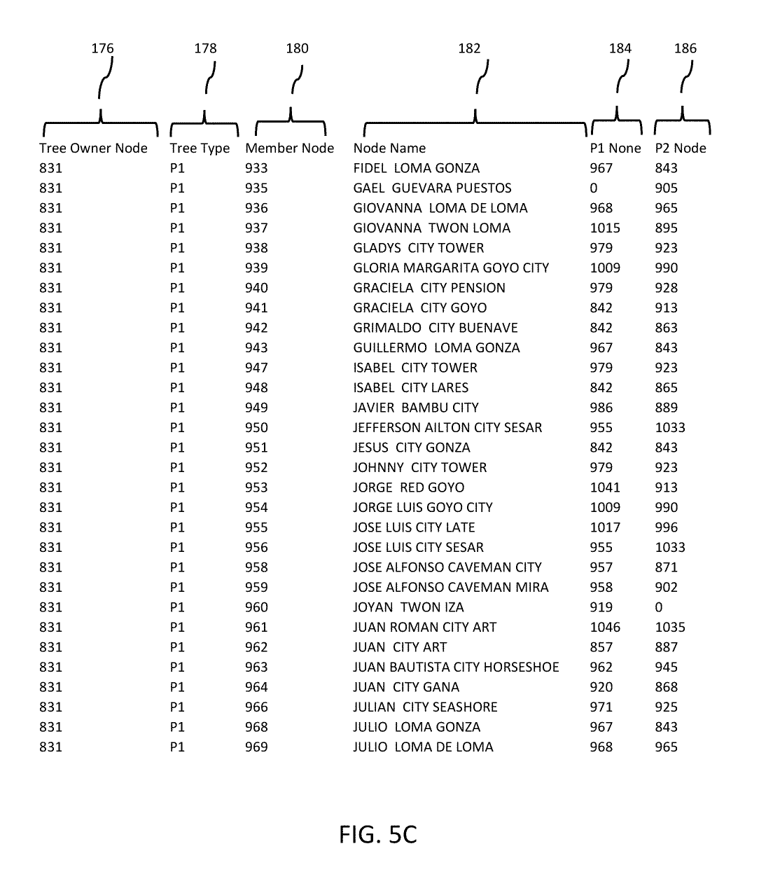

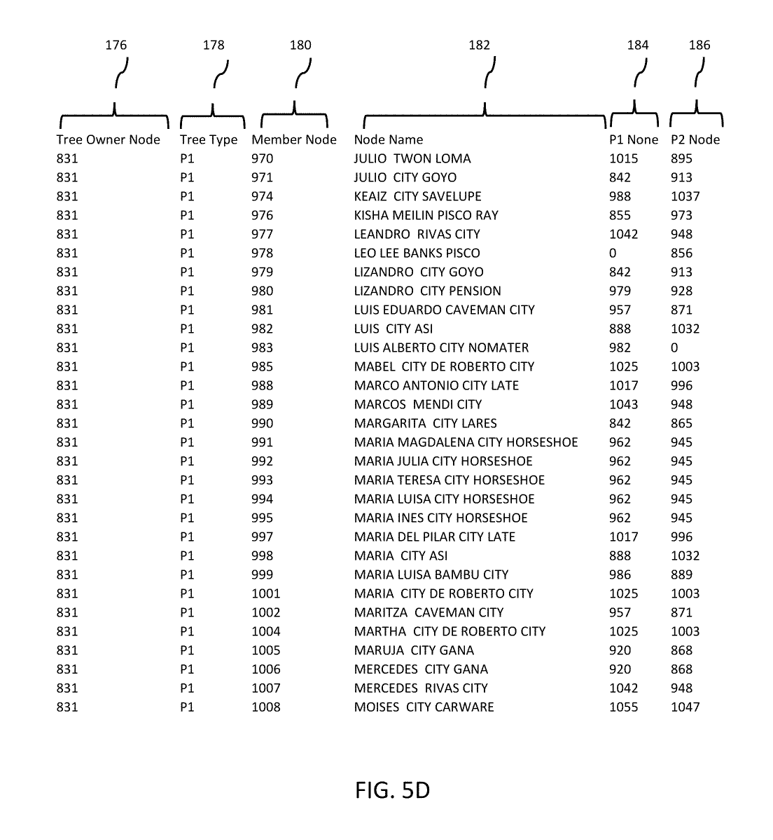

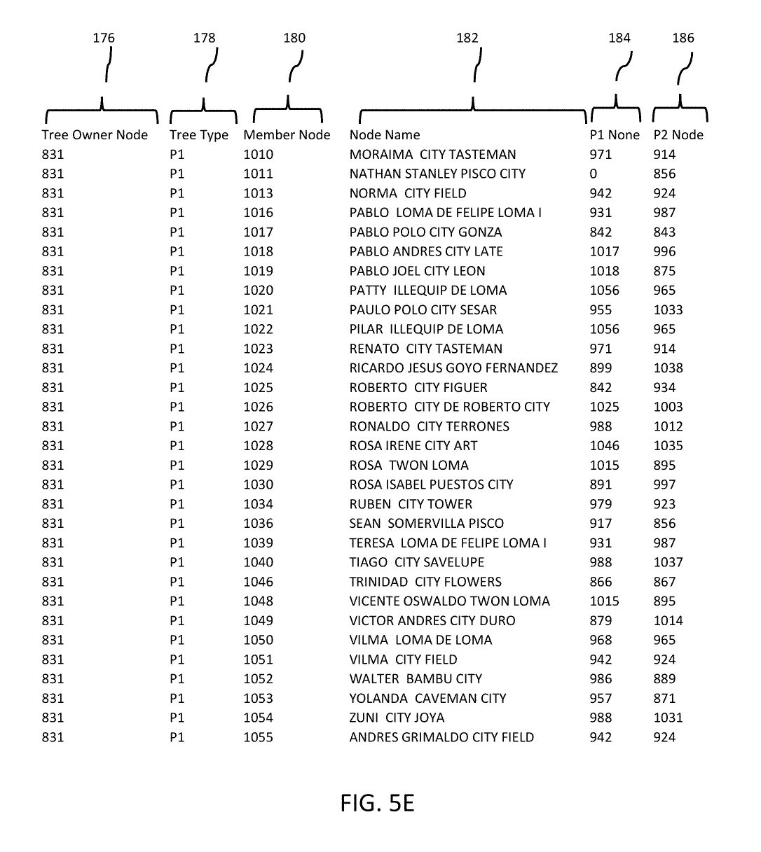

With reference now to the figures and in particular with references to FIGS. 5A-5E, are exemplary diagrams listing for the tree owner member identifying root of family and members that are part of the tree structure select for the graphical depiction of the family tree, in which illustrative embodiments may be implemented. It should be appreciated that FIGS. 5A-5E are only exemplary and are not intended to assert or imply any limitation with regards to the environment in which different embodiments may be implemented. Many modifications to the depicted environments may be made.

With reference now to figure, FIG. 5A depicts a pictorial representation of an exemplary embodiment for the listing of the members of the tree owner first parent hierarchy that are being used in the depiction of the family tree. The tree owner node is the unique code assigned to owner 176. The tree type is the unique code assigned to owner's first parent tree type 178. The member node is the unique code assigned to each member node 180. The node name is the tree member node's display name in the graphical depiction of the tree 182. The P1 None is the unique code assigned to each tree member first parent 184. The P2 Node is the unique code assigned to each tree member second parent 186. The root of the family is member node FRANCISCO CITY CITY 185 and the tree owner is ELIAS ANDRES CITY RIMAC with a Member Node of 831.

With reference now to figure, FIG. 5B and proceeding from FIG. 5A, FIG. 5B depicts a pictorial representation of an exemplary embodiment for the continued listing of the members of the tree owner first parent hierarchy that are being used in the depiction of the family tree. The tree owner node is the unique code assigned to owner 176. The tree type is the unique code assigned to owner's first parent tree type 178. The member node is the unique code assigned to each member node 180. The node name is the tree member node's display name in the graphical depiction of the tree 182. The P1 None is the unique code assigned to each tree member first parent 184. The P2 Node is the unique code assigned to each tree member second parent 186.

With reference now to figure, FIG. 5C and proceeding from FIG. 5B, FIG. 5C depicts a pictorial representation of an exemplary embodiment for the continued listing of the members of the tree owner first parent hierarchy that are being used in the depiction of the family tree. The tree owner node is the unique code assigned to owner 176. The tree type is the unique code assigned to owner's first parent tree type 178. The member node is the unique code assigned to each member node 180. The node name is the tree member node's display name in the graphical depiction of the tree 182. The P1 None is the unique code assigned to each tree member first parent 184. The P2 Node is the unique code assigned to each tree member second parent 186.

With reference now to figure, FIG. 5D and proceeding from FIG. 5C, FIG. 5D depicts a pictorial representation of an exemplary embodiment for the continued listing of the members of the tree owner first parent hierarchy that are being used in the depiction of the family tree. The tree owner node is the unique code assigned to owner 176. The tree type is the unique code assigned to owner's first parent tree type 178. The member node is the unique code assigned to each member node 180. The node name is the tree member node's display name in the graphical depiction of the tree 182. The P1 None is the unique code assigned to each tree member first parent 184. The P2 Node is the unique code assigned to each tree member second parent 186.

With reference now to figure, FIG. 5E and proceeding from FIG. 5D, FIG. 5E depicts a pictorial representation of an exemplary embodiment for the continued listing of the members of the tree owner first parent hierarchy that are being used in the depiction of the family tree. The tree owner node is the unique code assigned to owner 176. The tree type is the unique code assigned to owner's first parent tree type 178. The member node is the unique code assigned to each member node 180. The node name is the tree member node's display name in the graphical depiction of the tree 182. The P1 None is the unique code assigned to each tree member first parent 184. The P2 Node is the unique code assigned to each tree member second parent 186.

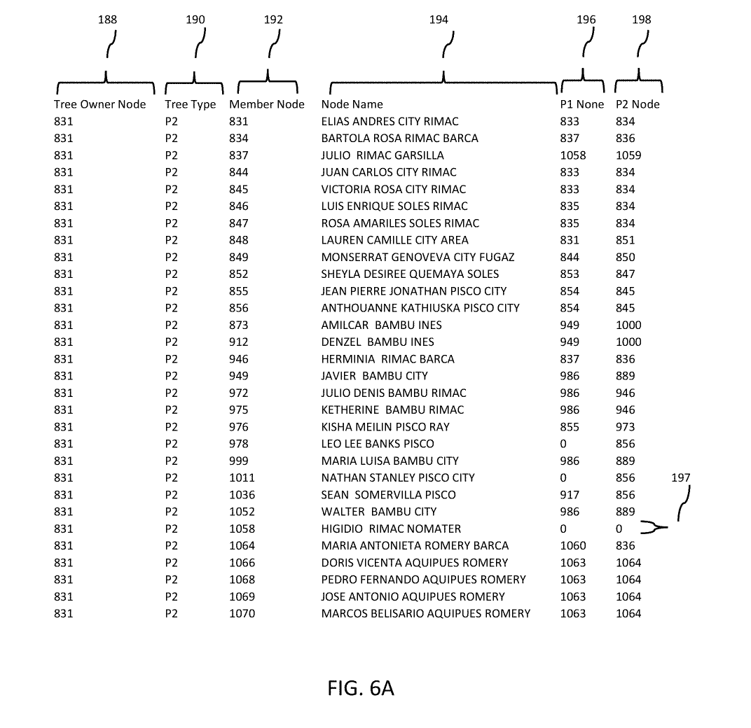

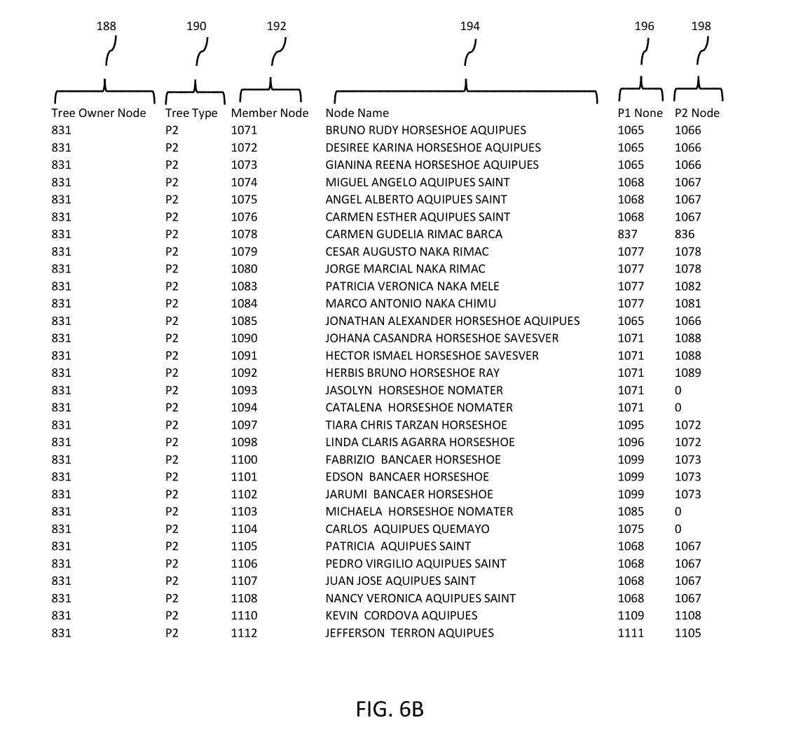

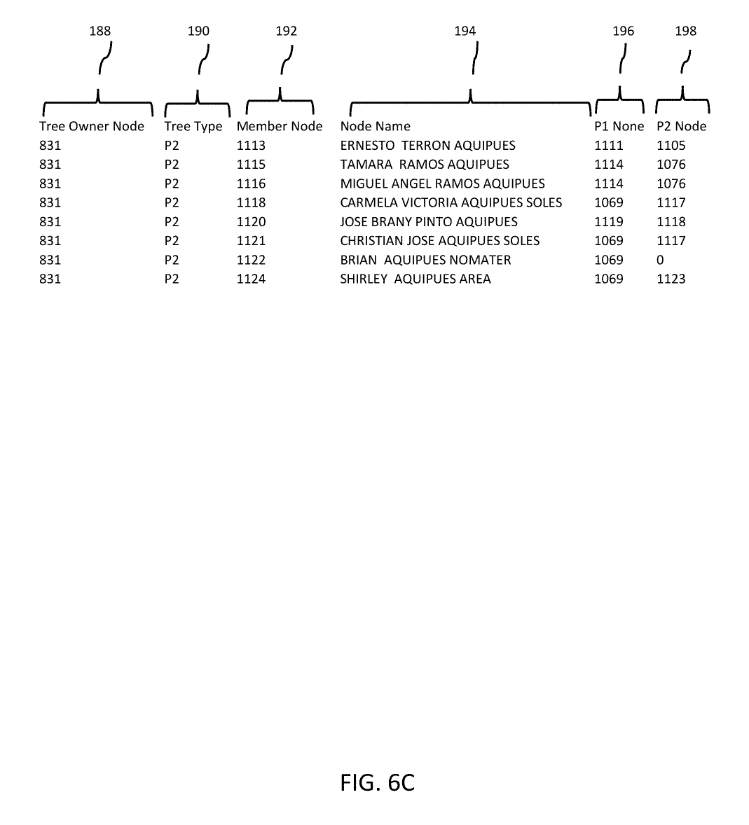

With reference now to the figures and in particular with references to FIGS. 6A-6C, are exemplary diagrams listing for the tree owner member identifying root of family and members that are part of the tree structure select for the graphical depiction of the family tree, in which illustrative embodiments may be implemented. It should be appreciated that FIGS. 6A-6C are only exemplary and are not intended to assert or imply any limitation with regards to the environment in which different embodiments may be implemented. Many modifications to the depicted environments may be made.

With reference now to figure, FIG. 6A depicts a pictorial representation of an exemplary embodiment for the listing of the members of the tree owner second parent hierarchy that are being used in the depiction of the family tree. The tree owner node is the unique code assigned to owner 188. The tree type is the unique code assigned to owner's second parent tree type 190. The member node is the unique code assigned to each member node 192. The node name is the tree member node's display name in the graphical depiction of the tree 194. The P1 None is the unique code assigned to each tree member first second 196. The P2 Node is the unique code assigned to each tree member second parent 198. The root of the family is member node HIGIDIO RIMAC MOMATER 197 and the tree owner is ELIAS ANDRES CITY RIMAC with a Member Node of 831.

With reference now to figure, FIG. 6B and proceeding from FIG. 6A, FIG. 6B depicts a pictorial representation of an exemplary embodiment for the continued listing of the members of the tree owner second parent hierarchy that are being used in the depiction of the family tree. The tree owner node is the unique code assigned to owner 188. The tree type is the unique code assigned to owner's first parent tree type 190. The member node is the unique code assigned to each member node 192. The node name is the tree member node's display name in the graphical depiction of the tree 194. The P1 None is the unique code assigned to each tree member second parent 196. The P2 Node is the unique code assigned to each tree member second parent 198.

With reference now to figure, FIG. 6C and proceeding from FIG. 6B, FIG. 6C depicts a pictorial representation of an exemplary embodiment for the continued listing of the members of the tree owner second parent hierarchy that are being used in the depiction of the family tree. The tree owner node is the unique code assigned to owner 188. The tree type is the unique code assigned to owner's first parent tree type 190. The member node is the unique code assigned to each member node 192. The node name is the tree member node's display name in the graphical depiction of the tree 194. The P1 None is the unique code assigned to each tree member second parent 196. The P2 Node is the unique code assigned to each tree member second parent 198.

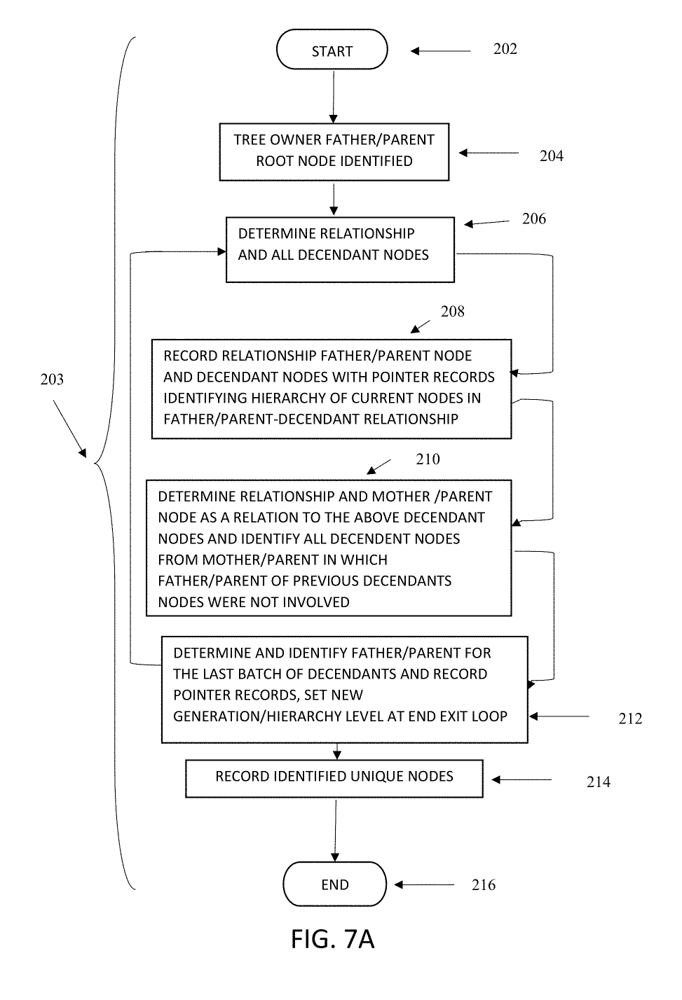

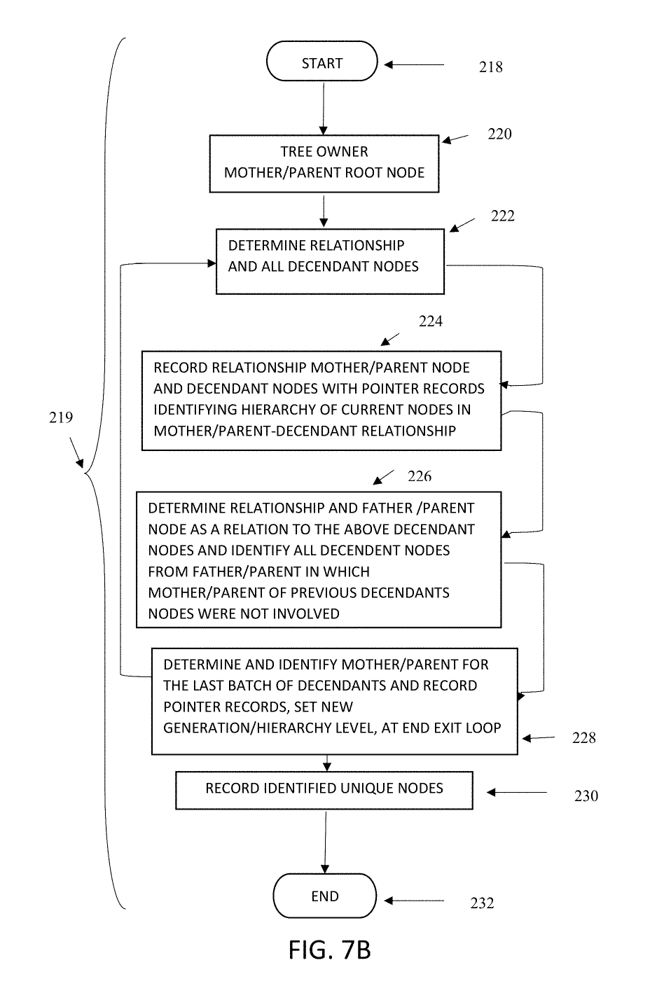

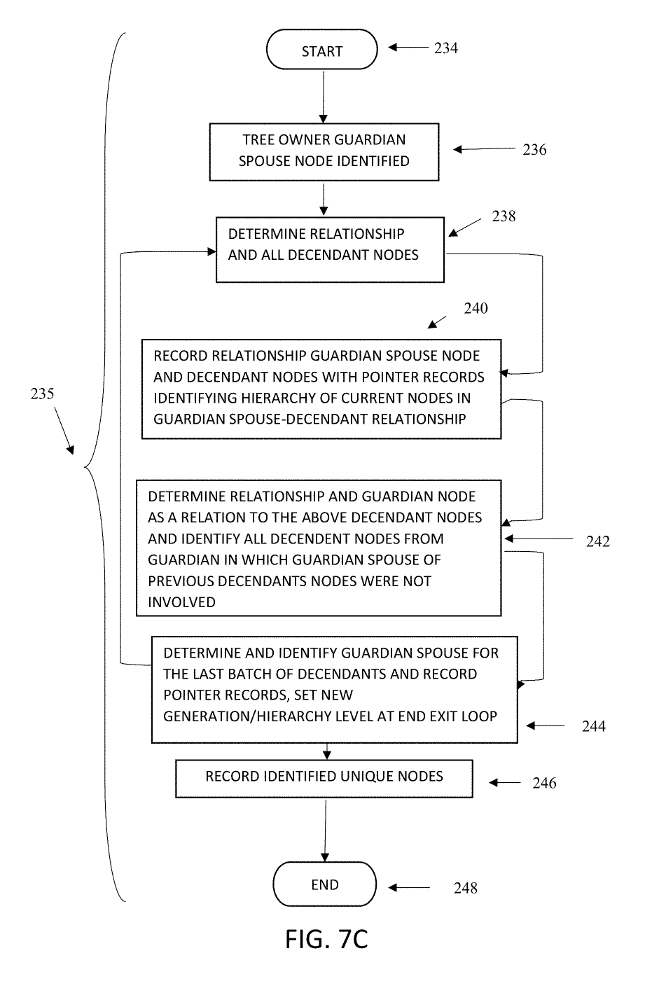

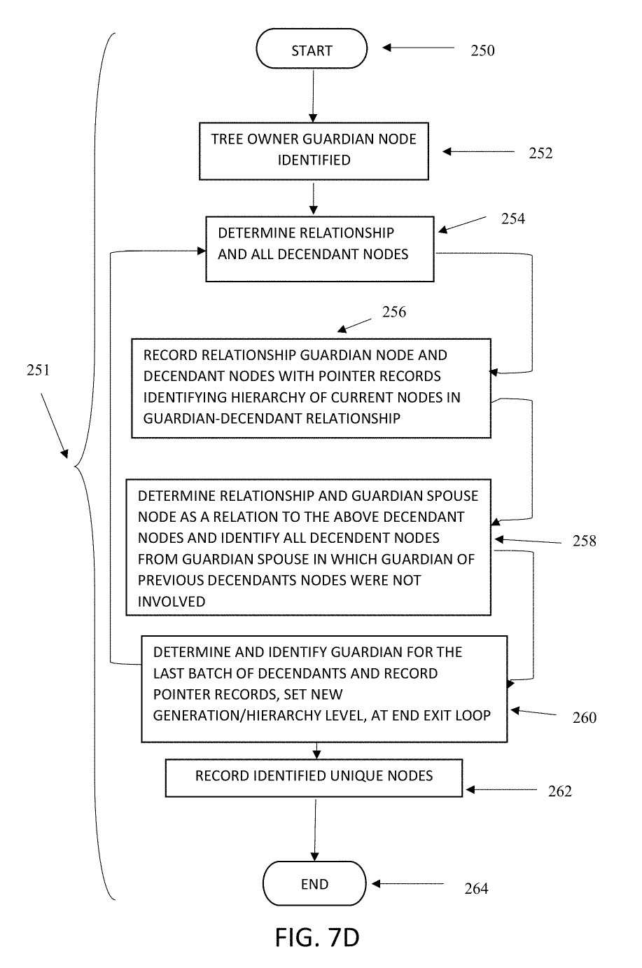

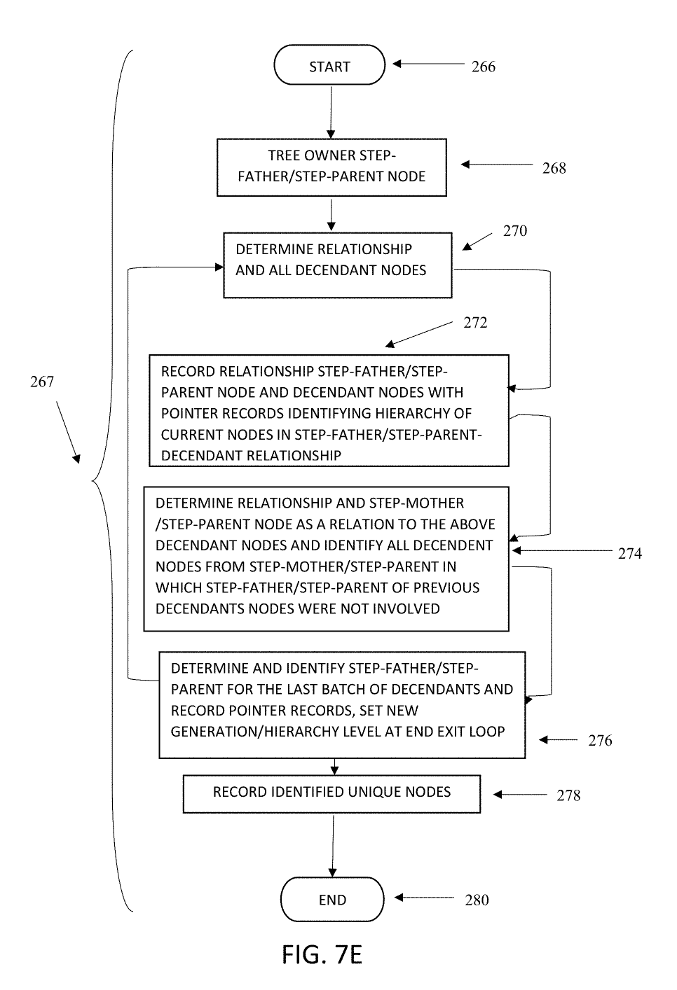

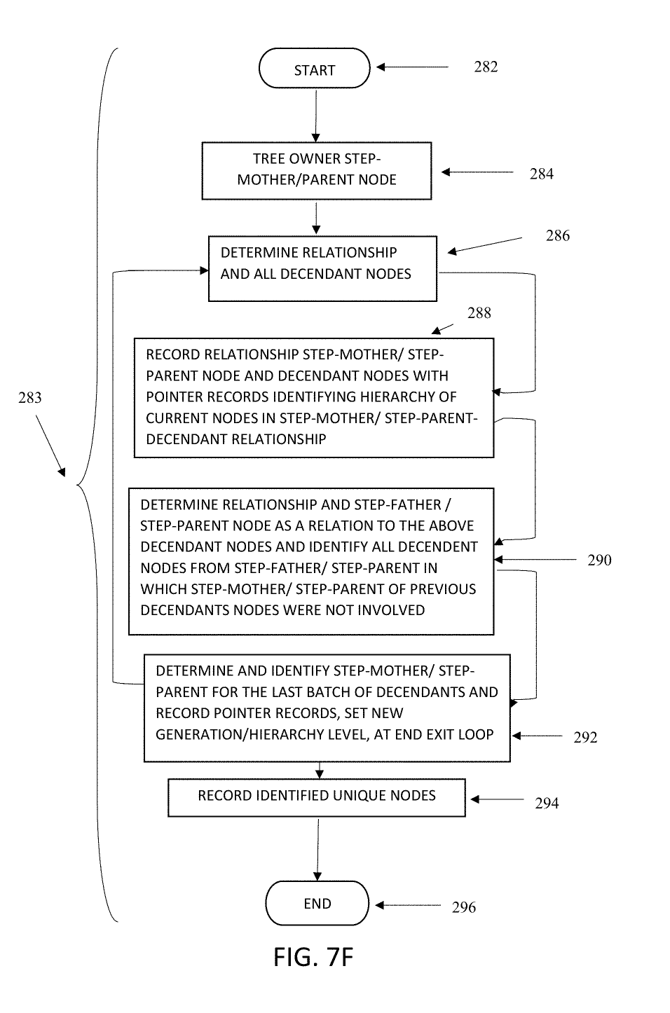

With reference now to the figures and in particular with references to FIGS. 7A-7F, are exemplary diagrams for the tree owner member identification and evaluation of the hierarchy for the relationship and all descendant nodes with their respective family generation in preparation to graphically depicting the family tree, in which illustrative embodiments may be implemented. It should be appreciated that FIGS. 7A-7F are only exemplary and are not intended to assert or imply any limitation with regards to the environment in which different embodiments may be implemented. Many modifications to the depicted environments may be made.

With reference now to figure, FIG. 7A depicts a pictorial representation of an exemplary embodiment for the flow of the tree owner first parent root of family identification and their relationship to the descendant nodes 203, in preparation to graphically depicting the family tree 202. The tree owner first parent root node is identified 204. The relationship and all tree descendant nodes are determined 206. The system process records all relationship between the first parent node and descendant nodes with pointer records, identifying hierarchy for the current nodes in the first parent-descendants relationship 208. The next logical process, the system determines and processes records of all relationship between the second parent node as a relation to the descendant nodes which were part of the selection in 208 for the first parent 210. The subsequent process by the system is the identification and determination of the last batch of records of descendants for the first parent and assignment pointer record. If there are more records system loops to 206, otherwise it ends the looping 212. The system process records the unique identified nodes 214 and saves records 216.

With reference now to figure, FIG. 7B and proceeding from FIG. 7A, FIG. 7B depicts a pictorial representation of an exemplary embodiment for the flow of the tree owner second parent root of family identification and their relationship to the descendant nodes 219, in preparation to graphically depicting the family tree 218. The tree owner second parent root node is identified 220. The relationship and all tree descendant nodes are determined 222. The system process records all relationship between the second parent node and descendant nodes with pointer records, identifying hierarchy for the current nodes in the second parent-descendants relationship 224. The next logical process, the system determines and processes records of all relationship between the first parent nodes as a relation to the descendant nodes which were part of the selection in 224 for the first parent 226. The subsequent process by the system is the identification and determination of the last batch of records of descendants for the second parent and assignment pointer record. If there are more records system loops to 222, otherwise it ends the looping 228. The system process records the unique identified nodes 230 and saves records 232.

With reference now to figure, FIG. 7C and proceeding from FIG. 7B, FIG. 7C depicts a pictorial representation of an exemplary embodiment for the flow of the tree owner fictive kinship (guardian spouse) root of family identification and their relationship to the descendant nodes 235, in preparation to graphically depicting the family tree 234. The tree owner fictive kinship (guardian spouse) root node is identified 236. The relationship and all tree descendant nodes are determined 238. The system process records all relationship between the fictive kinship (guardian spouse) node and descendant nodes with pointer records, identifying hierarchy for the current nodes in the fictive kinship (guardian spouse)-descendants relationship 240. The next logical process, the system determines and processes records of all relationship between the fictive kinship (guardian) nodes as a relation to the descendant nodes which were part of the selection in 240 for the fictive kinship (guardian spouse) 242. The subsequent process by the system is the identification and determination of the last batch of records of descendants for the fictive kinship (guardian spouse) and assignment pointer record. If there are more records system loops to 238, otherwise it ends the looping 244. The system process records the unique identified nodes 246 and saves records 248.

With reference now to figure, FIG. 7D and proceeding from FIG. 7C, FIG. 7D depicts a pictorial representation of an exemplary embodiment for the flow of the tree owner fictive kinship (guardian) root of family identification and their relationship to the descendant nodes 251, in preparation to graphically depicting the family tree 250. The tree owner fictive kinship (guardian) root node is identified 252. The relationship and all tree descendant nodes are determined 254. The system process records all relationship between the fictive kinship (guardian) node and descendant nodes with pointer records, identifying hierarchy for the current nodes in the fictive kinship (guardian)-descendant's relationship 256. The next logical process, the system determines and processes records of all relationship between the fictive kinship (guardian spouse) nodes as a relation to the descendant nodes which were part of the selection in 256 for the fictive kinship (guardian) 258. The subsequent process by the system is the identification and determination of the last batch of records of descendants for the fictive kinship (guardian) and assignment pointer record. If there are more records system loops to 254, otherwise it ends the looping 260. The system process records the unique identified nodes 262 and saves records 264.

With reference now to figure, FIG. 7E and proceeding from FIG. 7D, FIG. 7E depicts a pictorial representation of an exemplary embodiment for the flow of the tree owner Affinity first parent root of family identification and their relationship to the descendant nodes 267, in preparation to graphically depicting the family tree 266. The tree owner Affinity first parent root node is identified 268. The relationship and all tree descendant nodes are determined 270. The system process records all relationship between the Affinity first parent node and descendant nodes with pointer records, identifying hierarchy for the current nodes in the Affinity first parent descendant's relationship 272. The next logical process, the system determines and processes records of all relationship between the Affinity second parent nodes as a relation to the descendant nodes which were part of the selection in 272 for the Affinity first parent 274. The subsequent process by the system is the identification and determination of the last batch of records of descendants for the Affinity first parent and assignment pointer record. If there are more records system loops to 270, otherwise it ends the looping 276. The system process records the unique identified nodes 278 and saves records 280.

With reference now to figure, FIG. 7F and proceeding from FIG. 7E, FIG. 7F depicts a pictorial representation of an exemplary embodiment for the flow of the tree owner Affinity second parent root of family identification and their relationship to the descendant nodes 283, in preparation to graphically depicting the family tree 282. The tree owner Affinity second parent root node is identified 284. The relationship and all tree descendant nodes are determined 286. The system process records all relationship between the Affinity second parent node and descendant nodes with pointer records, identifying hierarchy for the current nodes in the Affinity second parent descendant's relationship 288. The next logical process, the system determines and processes records of all relationship between the Affinity first parent nodes as a relation to the descendant nodes which were part of the selection in 288 for the Affinity second parent 290. The subsequent process by the system is the identification and determination of the last batch of records of descendants for the Affinity second parent and assignment pointer record. If there are more records system loops to 286, otherwise it ends the looping 292. The system process records the unique identified nodes 294 and saves records 296.

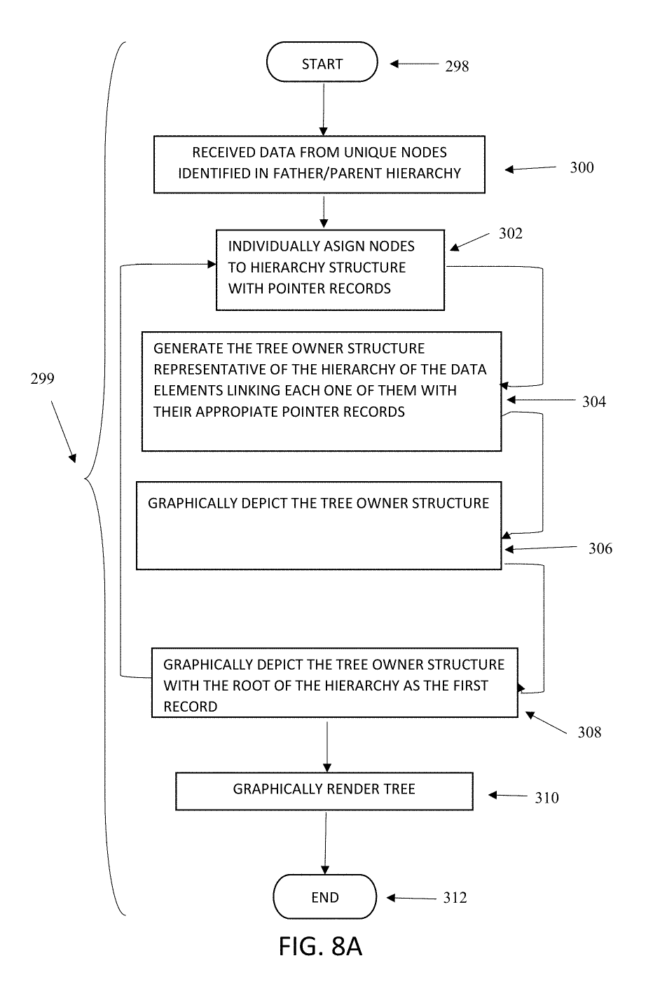

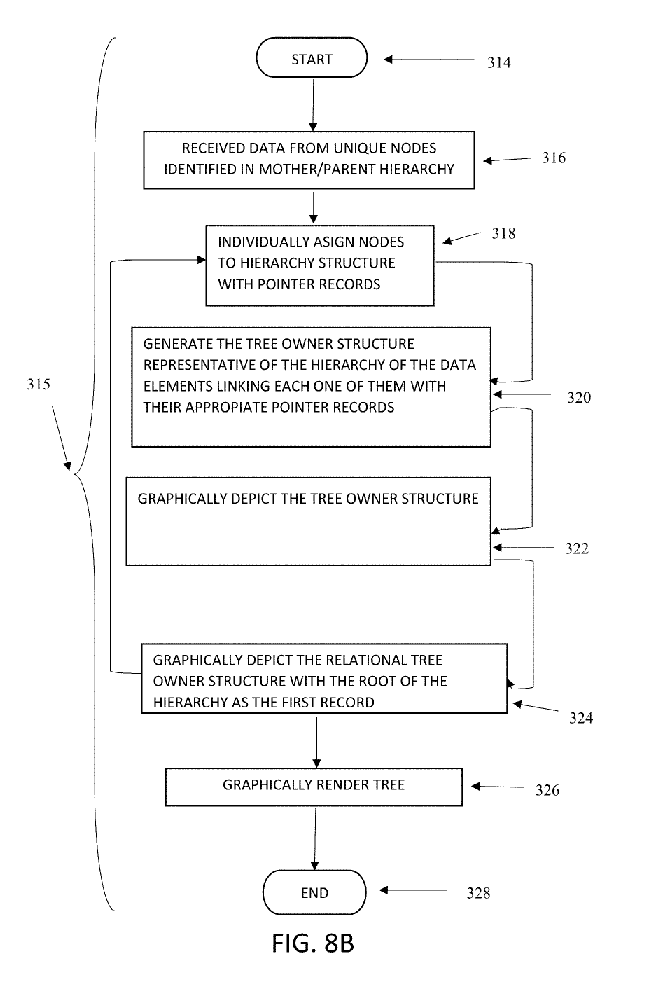

With reference now to the figures and in particular with references to FIGS. 8A-8B, are exemplary diagrams for the graphical depiction of family tree for its owner, evaluation the hierarchy of the relationship and for all descendant nodes with their respective family generation, in which illustrative embodiments may be implemented. It should be appreciated that FIGS. 8A-8B are only exemplary and are not intended to assert or imply any limitation with regards to the environment in which different embodiments may be implemented. Many modifications to the depicted environments may be made.

With reference now to figure, FIG. 8A depicts a pictorial representation of an exemplary embodiment for the flow of the process for the graphical depiction tree owner first parent generation family tree 299. The system pulls data from the tree owner records 298. The data is received from the unique nodes identified for the first parent records 300. Nodes are assigned to the appropriate hierarchy structure with pointer records 302. The system process generates the structure of the representative data, linking each node with its appropriate pointer record 304. The next system process graphically depicts the family tree structure 306. The next system process graphically depicts the family tree with root of the family as the first pointer record and it loops until last record is accounted for 308. The system record graphically renders the family tree for the first parent generations 310 and displays family tree 312.

With reference now to figure, FIG. 8B and proceeding from FIG. 8A, FIG. 8B depicts a pictorial representation of an exemplary embodiment for the flow of the process for the graphical depiction tree owner second parent generation family tree 315. The system pulls data from the tree owner records 314. The data is received from the unique nodes identified for the second parent records 316. Nodes are assigned to the appropriate hierarchy structure with pointer records 318. The system process generates the structure of the representative data, linking each node with its appropriate pointer record 320. The next system process graphically depicts the family tree structure 322. The next system process graphically depicts the family tree with root of the family as the first pointer record and it loops until last record is accounted for 324. The system record graphically renders the family tree for the second parent generations 326 and displays family tree 328.

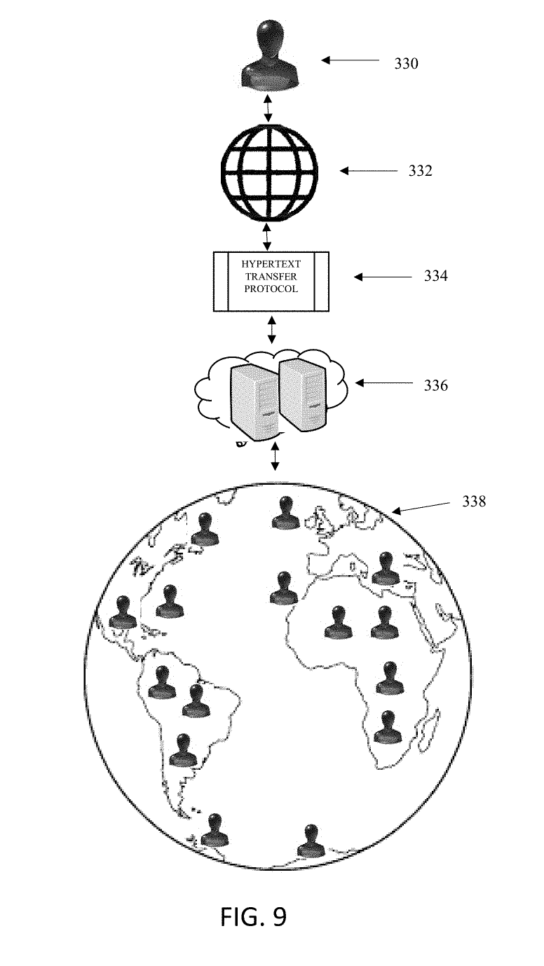

With reference now to FIG. 9, is an exemplary diagram for the flow of the simplified method for mapping the geo location for all member nodes to graphically depict them on a global map, in which an illustrative embodiment may be implemented. It should be appreciated that FIG. 9 is only exemplary and is not intended to assert or imply any limitation with regards to the environment in which different embodiments may be implemented. Many modifications to the depicted environments may be made.

With reference now to the figure, FIG. 9 depicts a pictorial representation of an exemplary embodiment for the process displaying the simplified method for mapping the geo location for all member nodes to graphically depict them on a global map, the member login node accesses the system 330, continuation and starting point of the World Wide Web 332. In the depicted example, World Wide Web 332, with a connection from the internet/cloud, connects to hypertext transfer protocol page 334, which on turns connects to applet in a server in the internet/cloud, to a database server 336, based on geo locations of all member in the tree owner hierarchy, members icons are displayed on a map showing the geographical locations for each member 338.

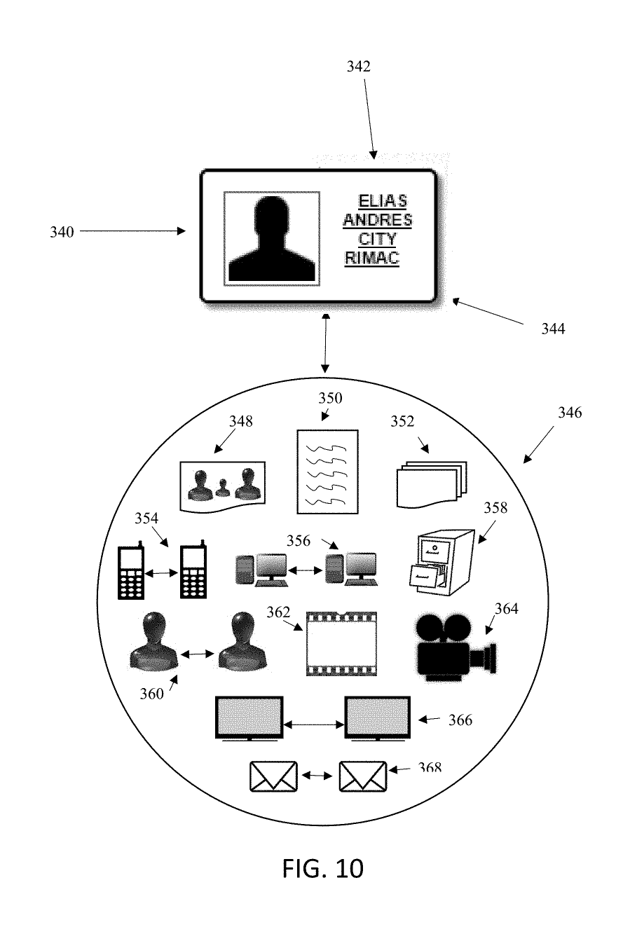

With reference now to FIG. 10, is an exemplary of the services available to each member node in the graphically depicted family tree, in which an illustrative embodiment may be implemented. It should be appreciated that FIG. 10 is only exemplary and is not intended to assert or imply any limitation with regards to the environment in which different embodiments may be implemented. Many modifications to the depicted environments may be made.

With reference now to the figure, FIG. 10 depicts a pictorial representation of an exemplary embodiment for the process of displaying the services available to each member node in the graphically depicted family tree, each member node accesses the graphical interface 342, the graphical interface contains a photograph 340, it also contains de name of the member 344. Upon selection from the user, all services available but not limited to are encompassed in 346, such as file storage 358, and archiving 352, music storing and playing 350, video clip storing and playing 362, voice messaging storing and recording 354, presentation storing and displaying 366, email and messaging 368, conferencing 366, video recording 364, file exchange 356, media and picture storing, displaying 348 and member chat 360.

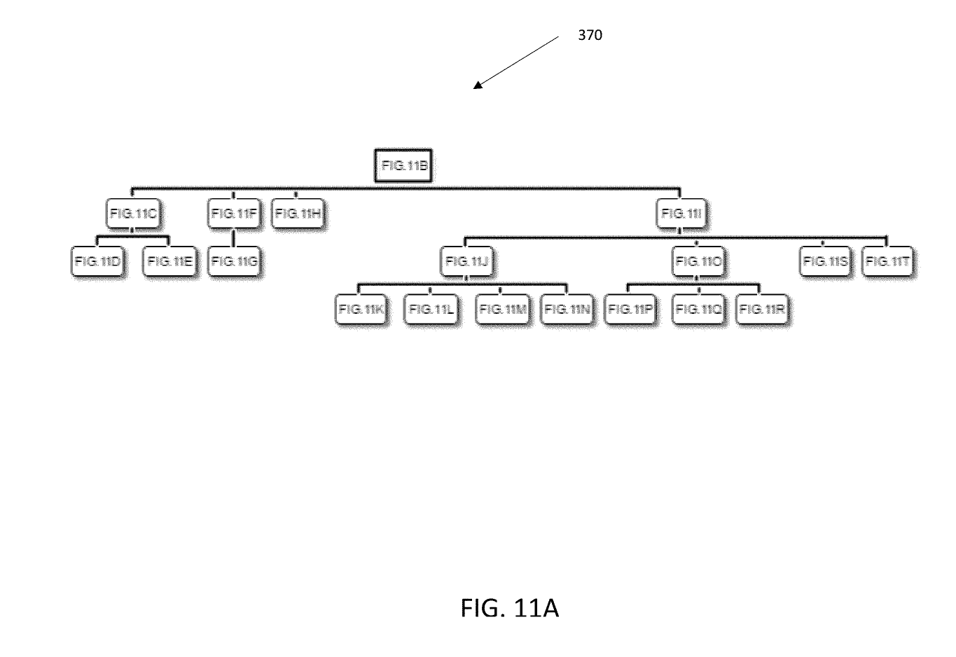

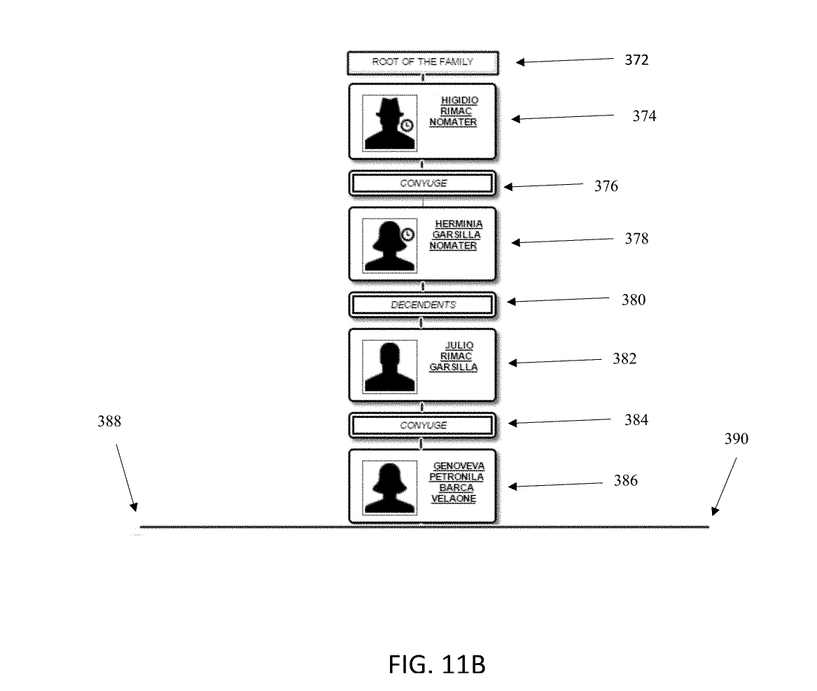

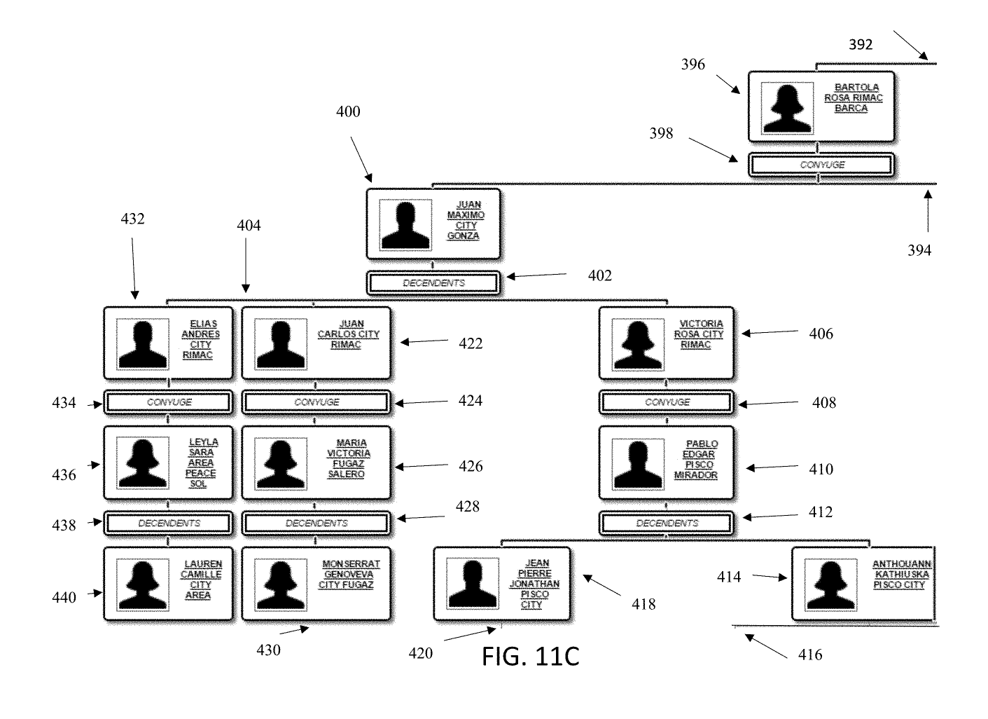

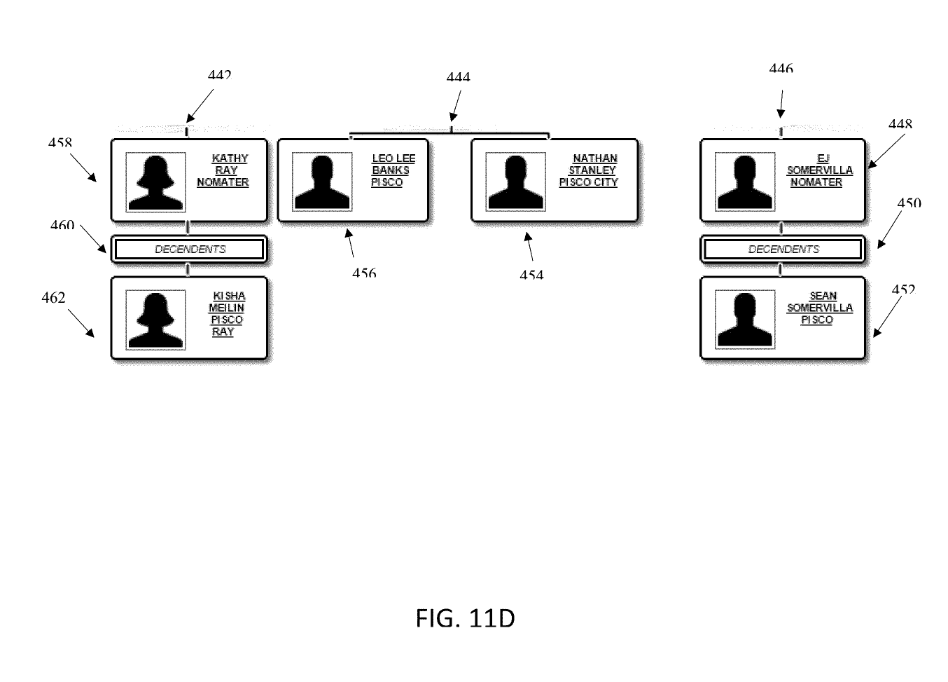

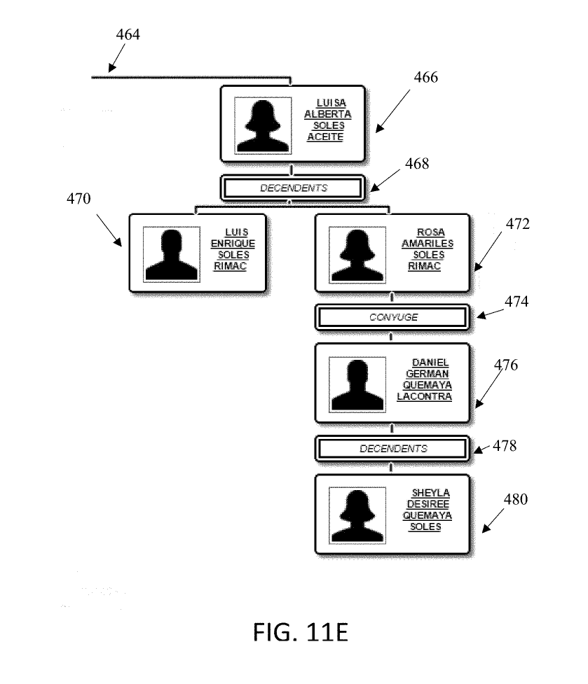

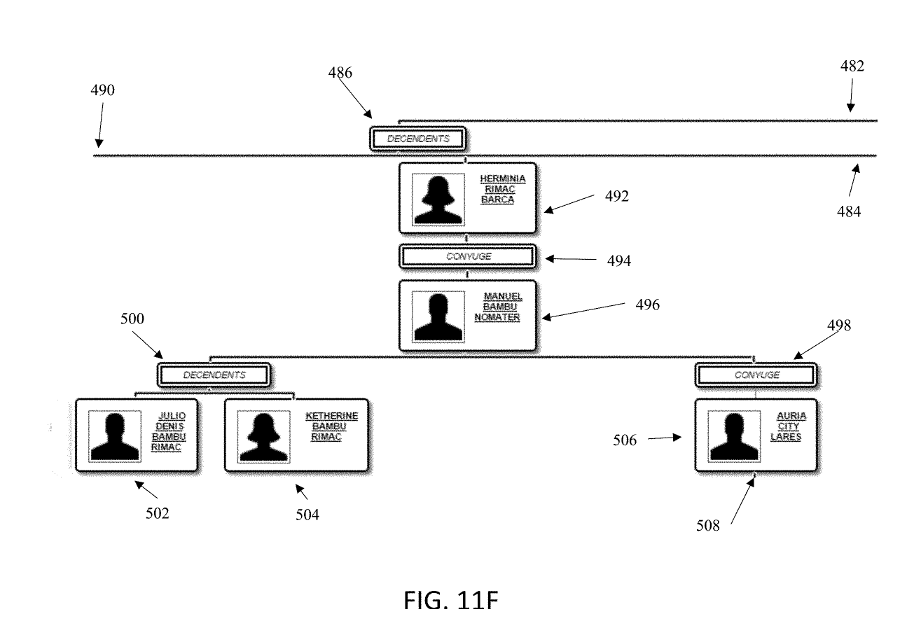

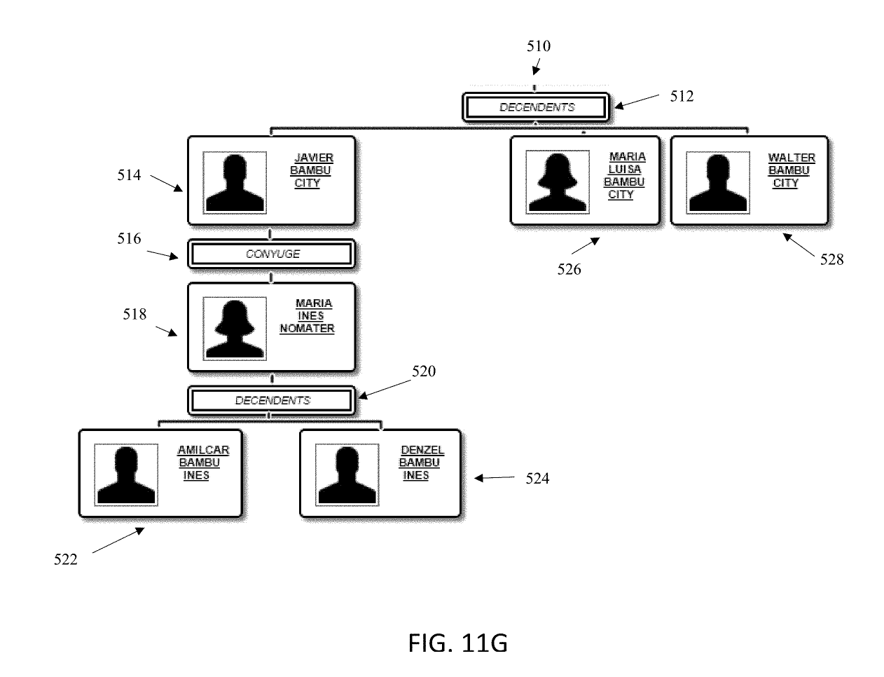

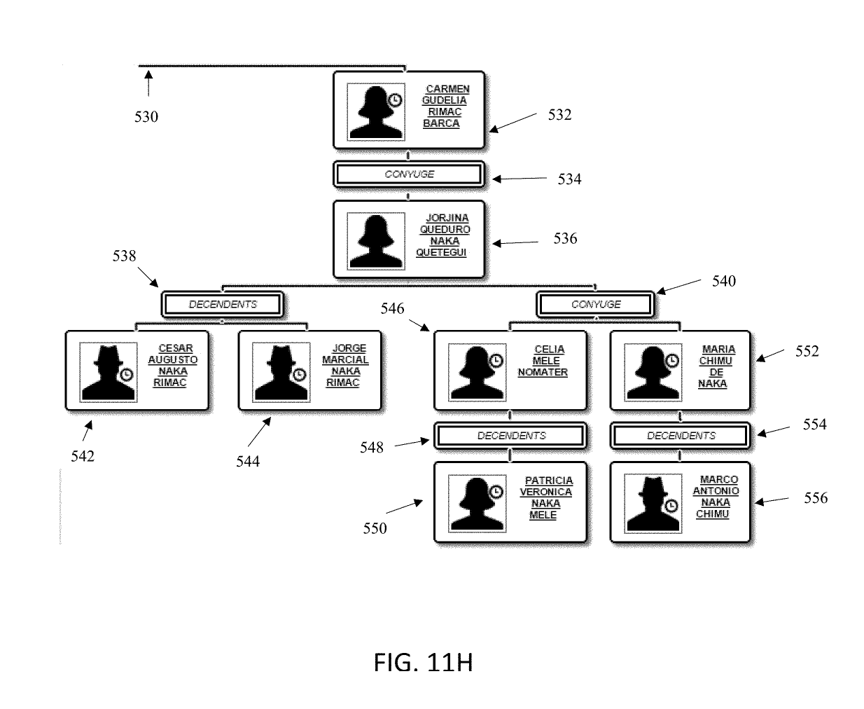

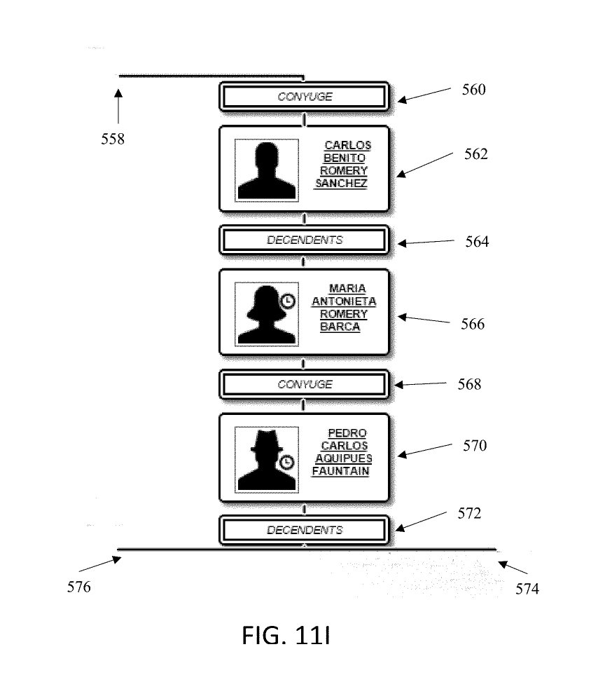

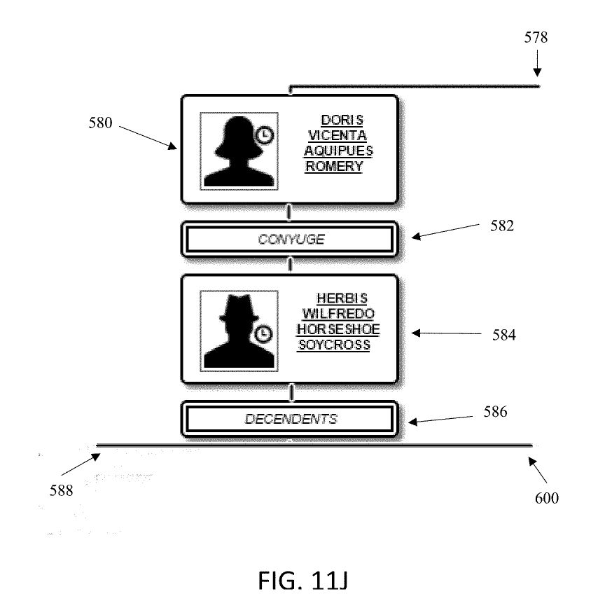

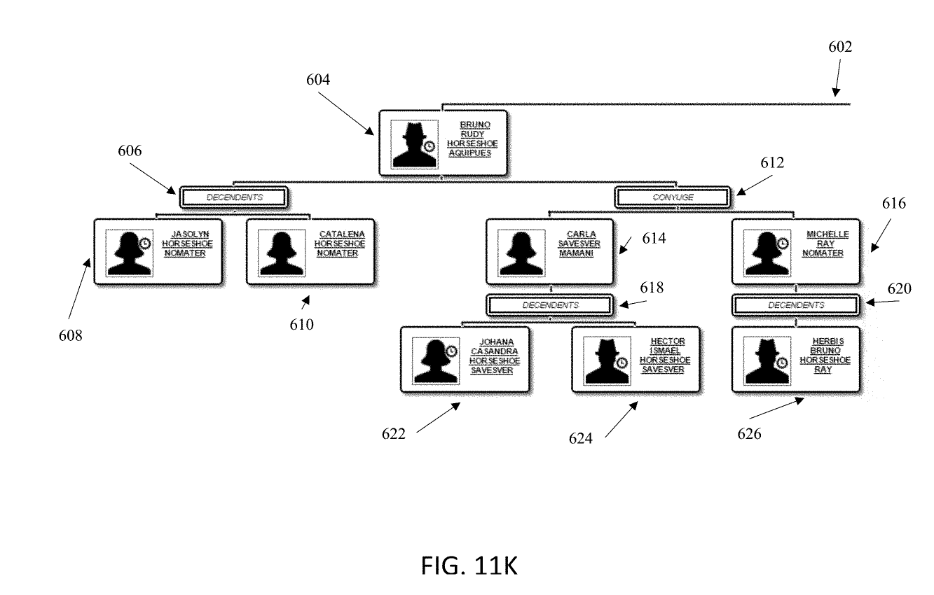

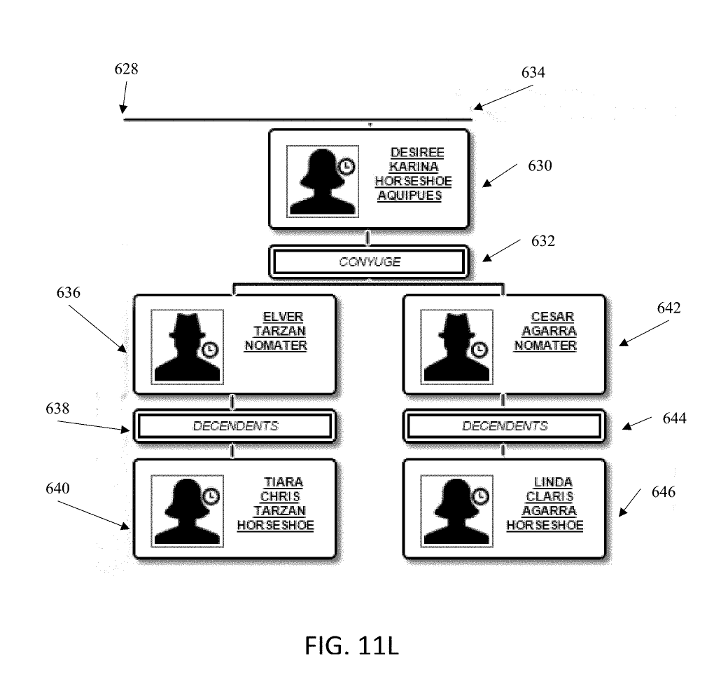

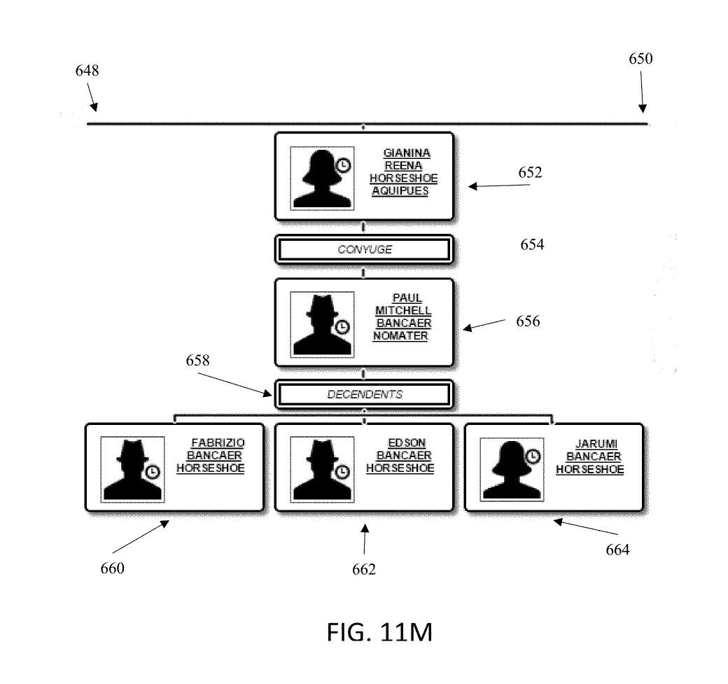

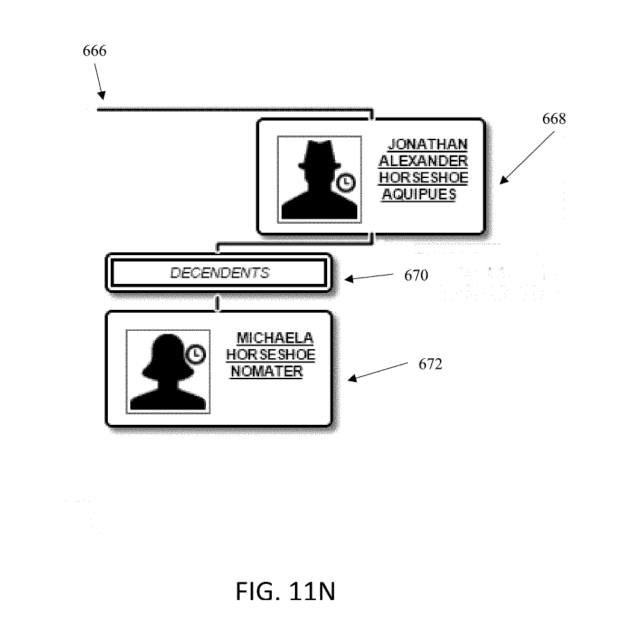

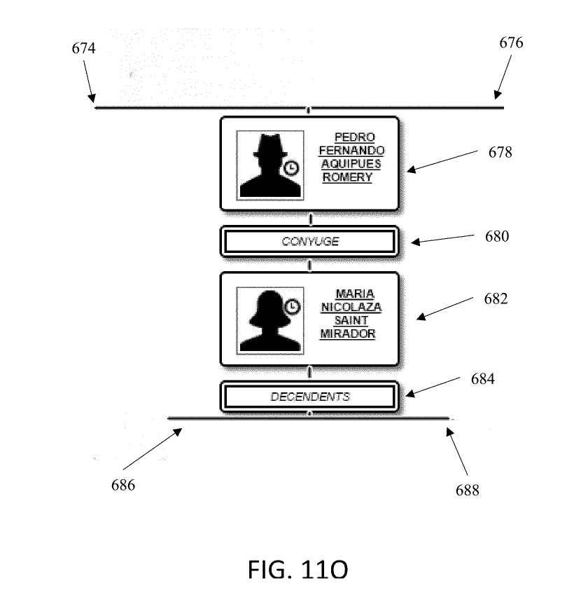

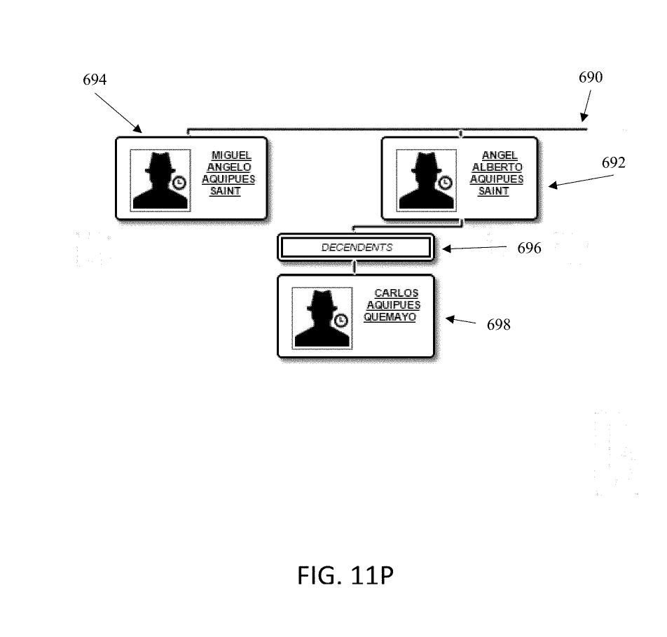

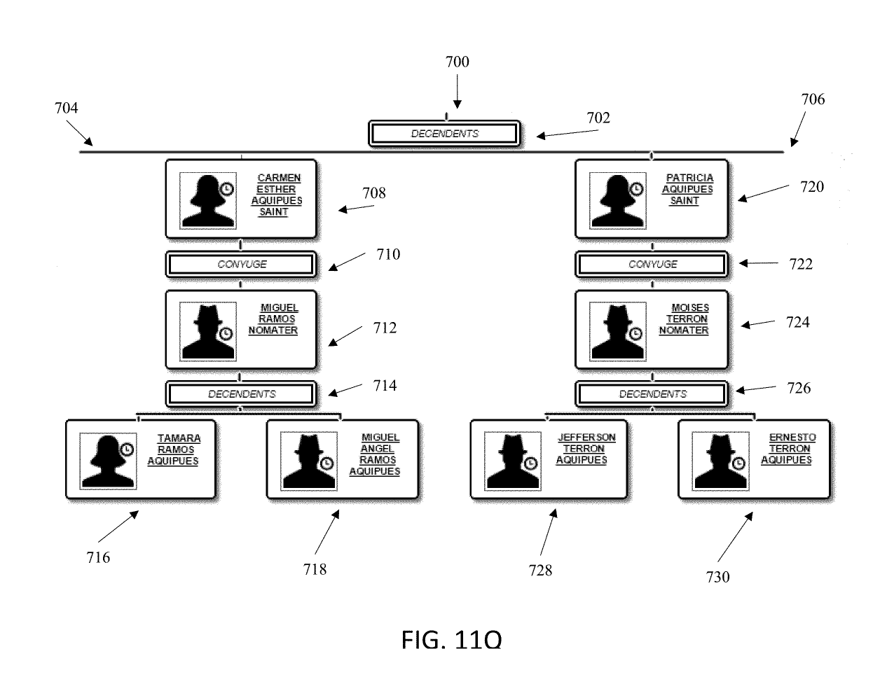

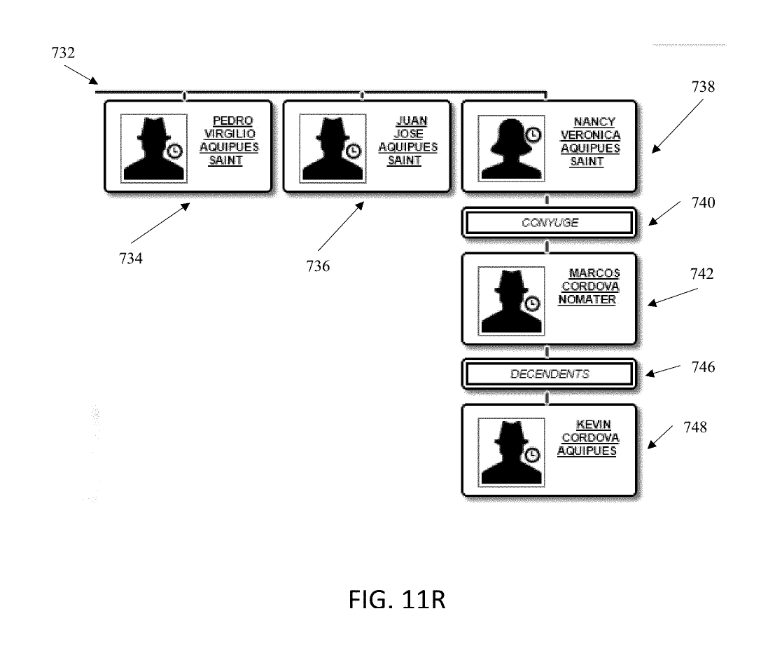

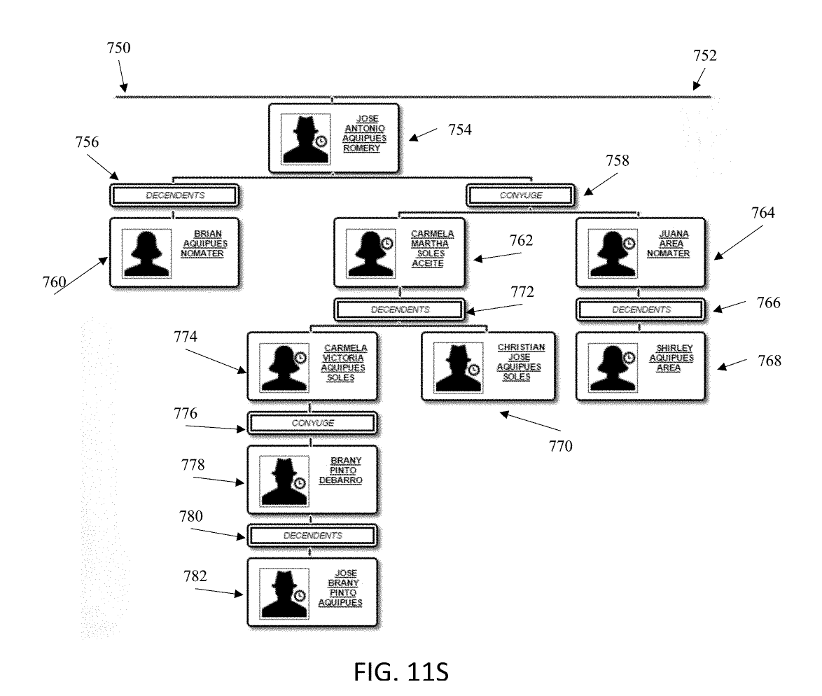

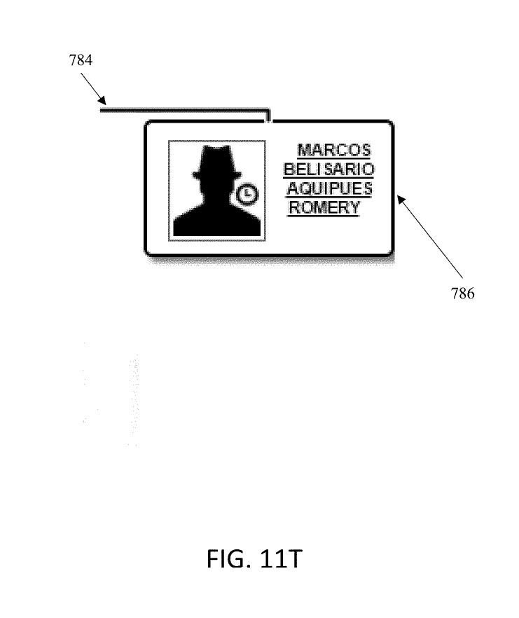

With reference now to the figures and in particular with references to FIGS. 11A-11T, are exemplary diagrams of graphical view of the depiction of the second parental family tree of the tree owner node, in which illustrative embodiments may be implemented. It should be appreciated that FIGS. 11A-11T are only exemplary and are not intended to assert or imply any limitation with regards to the environment in which different embodiments may be implemented. Many modifications to the depicted environments may be made.

With reference now to figure, FIG. 11A depicts a pictorial representation of an exemplary embodiment graphical summary view of the depiction of the second parental family tree of the tree owner node 370. It should be appreciated that FIG. 11A is only exemplary and is not intended to assert or imply any limitation with regards to the environment in which different embodiments may be implemented. Many modifications to the depicted environments may be made. Due to the vast representation of the graphical view and the magnitude of the embodiment of the family tree of less than 300 members, FIGS. 11B through 11T were located in the summary on their right position of overlay and subsequently discussed.

With reference now to figure, FIG. 11B and proceeding from FIG. 11A, FIG. 11B depicts a pictorial representation of an exemplary embodiment for the sectional view of the depiction of the second parental family tree of the tree owner node. It should be appreciated that FIG. 11B is only exemplary and is not intended to assert or imply any limitation with regards to the environment in which different embodiments may be implemented. Many modifications to the depicted environments may be made. The root of the family label 372, the root of the family 374, the spouse or partner label 376, the spouse or partner for the root 378, label for children or off spring from the root 380, child of the root 382, spouse or partner label for the child of the root 384, spouse or partner of the child of the root 386. Reference 388 points to FIG. 11H and reference 390 points to FIG. 11I.

With reference now to figure, FIG. 11C and proceeding from FIG. 11B, FIG. 11C depicts a pictorial representation of an exemplary embodiment for the sectional view of the depiction of the second parental family tree of the tree owner node. It should be appreciated that FIG. 11C is only exemplary and is not intended to assert or imply any limitation with regards to the environment in which different embodiments may be implemented. Many modifications to the depicted environments may be made. Reference 392 is proceeding from FIG. 11F. The reference 396 is a child of references 384 and 386. Reference 398 is spouse or partner label of 396. Reference 400 is the spouse or partner of 396. Reference 402 is the label for the children of references 400 and 396 connected by reference 404. References 432 (the tree owner), 422 and 406 are the children or offspring of references 400 and 396. Reference 434 is the spouse or partner label for between 432 and 436. Reference 436 is the spouse or partner of 432. Reference 438 is the child label of 440. Reference 440 is the child od 432 and 436. Reference 424 is the spouse or partner label for between 422 and 426. Reference 426 is the spouse or partner of 422. Reference 428 is the child label of 430. Reference 430 is the child of 422 and 436. Reference 408 is the spouse or partner label for between 410 and 406. Reference 410 is the spouse or partner of 406. Reference 412 is the children label of 418 and 414. References 418 and 414 are the children of 406 and 410. References 420 points to reference 442 on FIG. 11D. Reference 416 points to references 444 and 446 on FIG. 11D. Reference 394 points to FIG. 11F.

With reference now to figure, FIG. 11D and proceeding from FIG. 11C, FIG. 11D depicts a pictorial representation of an exemplary embodiment for the sectional view of the depiction of the second parental family tree of the tree owner node. It should be appreciated that FIG. 11D is only exemplary and is not intended to assert or imply any limitation with regards to the environment in which different embodiments may be implemented. Many modifications to the depicted environments may be made. References 442, 444 and 446 are proceeding connection to 420 and 416 on FIG. 11C. Reference 458 is the spouse or partner of 420 on FIG. 11C. Reference 460 is the child or offspring label between 458 and 420 on FIG. 11C. Reference 462 is the child or offspring of 458 and 420 on FIG. 11C. References 456 and 454 are the children or off springs of 414 on FIG. 11C. Reference 448 is the new spouse or partner of 414 on FIG. 11C. Reference 420 is the label for the child or offspring between 448 and 414 om FIG. 11C. Reference 452 is the child between 448 and 414 om FIG. 11C.

With reference now to figure, FIG. 11E and proceeding from FIG. 11D, FIG. 11E depicts a pictorial representation of an exemplary embodiment for the sectional view of the depiction of the second parental family tree of the tree owner node. It should be appreciated that FIG. 11E is only exemplary and is not intended to assert or imply any limitation with regards to the environment in which different embodiments may be implemented. Many modifications to the depicted environments may be made. Reference 464 is proceeding from reference 394 on FIG. 11C. Reference 466 is the same sex spouse or partner of 396 on FIG. 11C. Reference 468 is the civil union child or offspring label between 466 and 396 on FIG. 11C. References 470 and 472 are the civil union children or offspring between 466 and 396 on FIG. 11C. Reference 474 is the spouse label between 472 and 476. Reference 476 is the spouse of 472. Reference 478 is the label for the child or offspring between 472 and 476. 480 is the child or offspring between 472 and 476.

With reference now to figure, FIG. 11F and proceeding from FIG. 11E, FIG. 11F depicts a pictorial representation of an exemplary embodiment for the sectional view of the depiction of the second parental family tree of the tree owner node. It should be appreciated that FIG. 11F is only exemplary and is not intended to assert or imply any limitation with regards to the environment in which different embodiments may be implemented. Many modifications to the depicted environments may be made. Reference 490 is proceeding from 392 on FIG. 11C. Reference 486 is the child or spring label between 382 and 386 on FIG. 11B. Reference 482 points to 388 on FIG. 11B. Reference 484 points to 530 on FIG. 11H. Reference 492 is the child between 382 and 386 on FIG. 11B. Reference 494 is the spouse label between 492 and 496. Reference 496 is the spouse of 492. Reference 500 is the children label between 492 and 496. References 502 and 504 are the children between 492 and 496. Reference 496 is the spouse label for another partner with 496. Reference 506 is a civil union same sex spouse of 496. Reference 508 points to 510 on FIG. 11G.

With reference now to figure, FIG. 11G and proceeding from FIG. 11F, FIG. 11G depicts a pictorial representation of an exemplary embodiment for the sectional view of the depiction of the second parental family tree of the tree owner node. It should be appreciated that FIG. 11G is only exemplary and is not intended to assert or imply any limitation with regards to the environment in which different embodiments may be implemented. Many modifications to the depicted environments may be made. Reference 510 is proceeding from 508 on FIG. 11F. Reference 512 is the same sex or civil union children between 496 and 506 on FIG. 11F. References 514, 526 and 528 are the civil union children between 506 and 496 on FIG. 11F. Reference 516 is the spouse label between 514 and 518. Reference 518 is the spouse of 514. Reference 520 is the children label between 514 and 518. References 522 and 524 are the children between 514 and 518.

With reference now to figure, FIG. 11H and proceeding from FIG. 11G, FIG. 11H depicts a pictorial representation of an exemplary embodiment for the sectional view of the depiction of the second parental family tree of the tree owner node. It should be appreciated that FIG. 11H is only exemplary and is not intended to assert or imply any limitation with regards to the environment in which different embodiments may be implemented. Many modifications to the depicted environments may be made. Reference 530 points to 484 on FIG. 11F. Reference 532 is the child between 382 and 386 on FIG. 11B. Reference 534 is the same sex spouse or civil union label between 532 and 536. Reference 536 is the civil union spouse of 532. Reference 538 is the civil union children label between 532 and 536. References 542 and 544 and the civil union children between 532 and 536. Reference 5400 is the spouse civil union label between 536 and 546, plus 536 and 552. Reference 546 is civil union spouse of 536 and Reference 552 is another civil union spouse of 536. Reference 548 is the civil union child label between 546 and 536. Reference 550 is the civil union child between 546 and 536. Reference 554 is the civil union child label between 552 and 536. Reference 556 is the civil union child between 552 and 536.

With reference now to figure, FIG. 11I and proceeding from FIG. 11H, FIG. 11I depicts a pictorial representation of an exemplary embodiment for the sectional view of the depiction of the second parental family tree of the tree owner node. It should be appreciated that FIG. 11I is only exemplary and is not intended to assert or imply any limitation with regards to the environment in which different embodiments may be implemented. Many modifications to the depicted environments may be made. Reference 558 points to 390 on FIG. 11B. Reference 560 is another spouse label between 562 and 386 on FIG. 11B. Reference 562 is another spouse for 386 on FIG. 11B. Reference 564 is the child label between 562 and 386 on FIG. 11B. Reference 566 is the child between 562 and 386 on FIG. 11B. Reference 568 is the spouse label between 566 and 570. Reference 570 is the spouse of 566. Reference 572 is the children label between 566 and 570. Reference 576 points to 578 on FIG. 11J. Reference 574 points to 674 on FIG. 11O.

With reference now to figure, FIG. 11J and proceeding from FIG. 11I, FIG. 11J depicts a pictorial representation of an exemplary embodiment for the sectional view of the depiction of the second parental family tree of the tree owner node. It should be appreciated that FIG. 11J is only exemplary and is not intended to assert or imply any limitation with regards to the environment in which different embodiments may be implemented. Many modifications to the depicted environments may be made. Reference 578 points to 576 on FIG. 11I. Reference 580 is the child between 566 and 570 on FIG. 11I. Reference 582 is the spouse label between 580 and 584. Reference 584 is the spouse of 580. Reference 586 is the children label between 580 and 584. Reference 588 points to 634 on FIG. 11L. Reference 600 points to 648 on FIG. 11M.

With reference now to figure, FIG. 11K and proceeding from FIG. 11J, FIG. 11K depicts a pictorial representation of an exemplary embodiment for the sectional view of the depiction of the second parental family tree of the tree owner node. It should be appreciated that FIG. 11K is only exemplary and is not intended to assert or imply any limitation with regards to the environment in which different embodiments may be implemented. Many modifications to the depicted environments may be made. Reference 602 points to 628 on FIG. 11L. Reference 604 is the child of between 580 and 584 on FIG. 11J. Reference 606 is the children label for single parent of 604. References 608 and 610 are the children of 604. Reference 612 is the spouse label between 604 and 614 and 604 and 616. Reference 614 is another spouse for 604. Reference 616 is another spouse for 604. Reference 618 is the children label between 614 and 604. References 622 and 624 are the children between 604 and 614. Reference 620 is the child label between 604 and 616.

With reference now to figure, FIG. 11L and proceeding from FIG. 11K, FIG. 11L depicts a pictorial representation of an exemplary embodiment for the sectional view of the depiction of the second parental family tree of the tree owner node. It should be appreciated that FIG. 11L is only exemplary and is not intended to assert or imply any limitation with regards to the environment in which different embodiments may be implemented. Many modifications to the depicted environments may be made. Reference 628 points to 602 on FIG. 11K. Reference 634 points to 648 on FIG. 11M. Reference 630 is another child between 580 and 584 on FIG. 11J. Reference 632 is the spouse label between 630 and 6360 and 630 and 642. Reference 636 is the spouse of 630. Reference 638 is the child label between 630 and 636. Reference 640 is the child between 630 and 636. Reference 642 is another spouse of 630. Reference 644 is the child label between 630 and 642. Reference 646 is the child between 6300 and 642.

With reference now to figure, FIG. 11M and proceeding from FIG. 11L, FIG. 11M depicts a pictorial representation of an exemplary embodiment for the sectional view of the depiction of the second parental family tree of the tree owner node. It should be appreciated that FIG. 11M is only exemplary and is not intended to assert or imply any limitation with regards to the environment in which different embodiments may be implemented. Many modifications to the depicted environments may be made. Reference 648 points to 634 on FIG. 11L. Reference 650 points to 666 on FIG. 11N. Reference 652 is another child between 580 and 584 on FIG. 11J. Reference 654 is spouse label between 652 and 656. Reference 656 is the spouse of 652. Reference 658 is the children label between 652 and 656. References 660, 662 and 664 are children between 652 and 656.

With reference now to figure, FIG. 11N and proceeding from FIG. 11M, FIG. 11N depicts a pictorial representation of an exemplary embodiment for the sectional view of the depiction of the second parental family tree of the tree owner node. It should be appreciated that FIG. 11N is only exemplary and is not intended to assert or imply any limitation with regards to the environment in which different embodiments may be implemented. Many modifications to the depicted environments may be made. Reference 666 points to 650 on FIG. 11M. Reference 668 is another child between 580 and 584 on FIG. 11J. Reference 670 is the child label for single parenting of 668. Reference 672 is a child of 668.

With reference now to figure, FIG. 11O and proceeding from FIG. 11N, FIG. 11O depicts a pictorial representation of an exemplary embodiment for the sectional view of the depiction of the second parental family tree of the tree owner node. It should be appreciated that FIG. 11O is only exemplary and is not intended to assert or imply any limitation with regards to the environment in which different embodiments may be implemented. Many modifications to the depicted environments may be made. Reference 674 points to 578 on FIG. 11J. Reference 676 points to 750 on FIG. 11S. Reference 678 is the child between 566 and 570 on FIG. 11I. Reference 680 is the spouse label between 678 and 682. Reference 682 is the spouse of 678. Reference 684 is the children label between 678 and 682. Reference 686 points to 690 on FIG. 11P. Reference 688 points to 704 on FIG. 11Q.

With reference now to figure, FIG. 11P and proceeding from FIG. 11O, FIG. 11P depicts a pictorial representation of an exemplary embodiment for the sectional view of the depiction of the second parental family tree of the tree owner node. It should be appreciated that FIG. 11P is only exemplary and is not intended to assert or imply any limitation with regards to the environment in which different embodiments may be implemented. Many modifications to the depicted environments may be made. Reference 690 points to 686 on FIG. 11O. Reference 690 is a child between 678 and 682 on FIG. 11O. Reference 692 is another child between 678 and 682 on FIG. 11O. Reference 696 is the child label for single parenting of 692. Reference 698 is a child of 692.

With reference now to figure, FIG. 11Q and proceeding from FIG. 11P, FIG. 11Q depicts a pictorial representation of an exemplary embodiment for the sectional view of the depiction of the second parental family tree of the tree owner node. It should be appreciated that FIG. 11Q is only exemplary and is not intended to assert or imply any limitation with regards to the environment in which different embodiments may be implemented. Many modifications to the depicted environments may be made. Reference 704 points to 690 on FIG. 11P. Reference 706 points to 732 on FIG. 11R. Reference 700 points to the bottom (688) of FIG. 11O. Reference 702 is the children label between 678 and 682 on FIG. 11O. Reference 708 is another child between 678 and 682 on FIG. 11O. Reference 710 is the spouse label between 708 and 712. Reference 712 is the spouse of 708. Reference 714 is the children label between 708 and 712. References 716 and 718 are the children between 708 and 712. Reference 720 is another child between 678 and 682 on FIG. 11O. Reference 722 is the spouse label between 720 and 724. Reference 724 is the spouse of 720. Reference 726 is the children label between 720 and 724. References 728 and 730 are the children between 720 and 724.

With reference now to figure, FIG. 11R and proceeding from FIG. 11Q, FIG. 11R depicts a pictorial representation of an exemplary embodiment for the sectional view of the depiction of the second parental family tree of the tree owner node. It should be appreciated that FIG. 11R is only exemplary and is not intended to assert or imply any limitation with regards to the environment in which different embodiments may be implemented. Many modifications to the depicted environments may be made. Reference 732 points to 706 on FIG. 11Q. Reference 734 is another child between 678 and 682 on FIG. 11O. Reference 736 is another child between 678 and 682 on FIG. 11O. Reference 738 is another child between 678 and 682 on FIG. 11O. Reference 740 is the spouse label between 738 and 742. Reference 742 is the spouse of 738. Reference 746 is the child label between 738 and 742. Reference 748 is the child between 738 and 742.

With reference now to figure, FIG. 11S and proceeding from FIG. 11R, FIG. 11S depicts a pictorial representation of an exemplary embodiment for the sectional view of the depiction of the second parental family tree of the tree owner node. It should be appreciated that FIG. 11S is only exemplary and is not intended to assert or imply any limitation with regards to the environment in which different embodiments may be implemented. Many modifications to the depicted environments may be made. Reference 750 points to 676 on FIG. 11Q. Reference 752 points to 784 on FIG. 11T. Reference 754 is the child between 566 and 570 on FIG. 11I. Reference 756 is the child label for single parenting for 754. Reference 760 is the child of 754. Reference 758 is the spouse label between 754 and 762 and 754 and 764. Reference 762 is the spouse of 754. Reference 772 is the children label between 754 and 762. References 774 and 770 are children between 754 and 762. Reference 776 is the spouse label between 774 and 778. Reference 778 is the spouse of 774. Reference 780 is the child label between 774 and 778. Reference 782 is the child between 774 and 778. Reference 764 is another spouse of 754. Reference 766 is the child label between 754 and 764. Reference 768 is the child between 754 and 764.

With reference now to figure, FIG. 11T and proceeding from FIG. 11S, FIG. 11T depicts a pictorial representation of an exemplary embodiment for the sectional view of the depiction of the second parental family tree of the tree owner node. It should be appreciated that FIG. 11T is only exemplary and is not intended to assert or imply any limitation with regards to the environment in which different embodiments may be implemented. Many modifications to the depicted environments may be made. Reference 784 points to 752 on FIG. 11S. Reference 782 is the child between 566 and 570 on FIG. 11I.

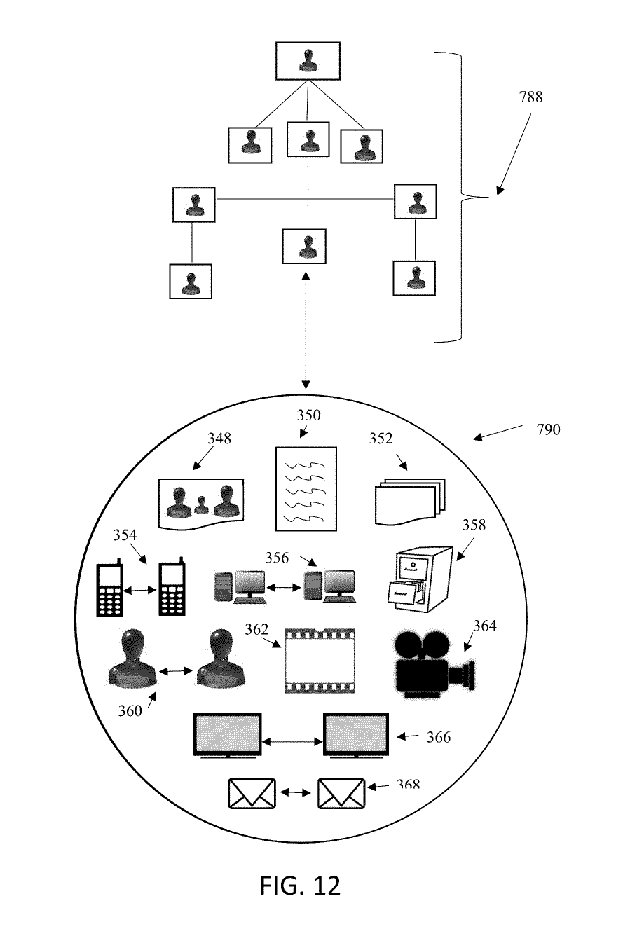

With reference now to FIG. 12, is an exemplary of the services available to all member nodes in the graphically depicted family tree, in which an illustrative embodiment may be implemented. It should be appreciated that FIG. 12 is only exemplary and is not intended to assert or imply any limitation with regards to the environment in which different embodiments may be implemented. Many modifications to the depicted environments may be made.

With reference now to the figure, FIG. 12 depicts a pictorial representation of an exemplary embodiment for the process of displaying the services available to all member nodes in the graphically depicted family tree, each member node in the family tree accesses all services available but not limited to are encompassed in 790, such as file storage 358, and archiving 352, music storing and playing 350, video clip storing and playing 362, voice messaging storing and recording 354, presentation storing and displaying 366, email and messaging 368, conferencing 366, video recording 364, file exchange 356, media and picture storing, displaying 348 and member chat 360.

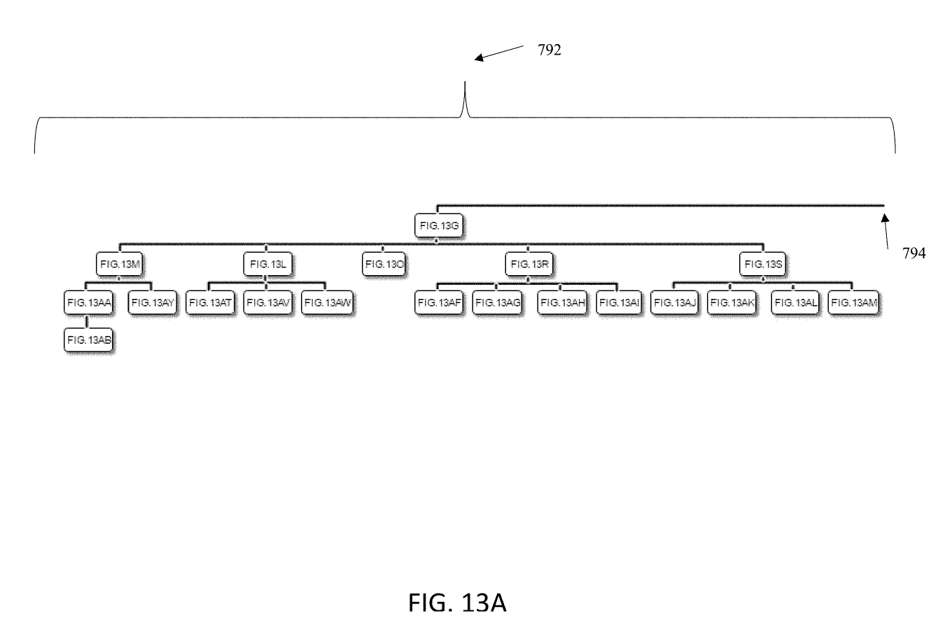

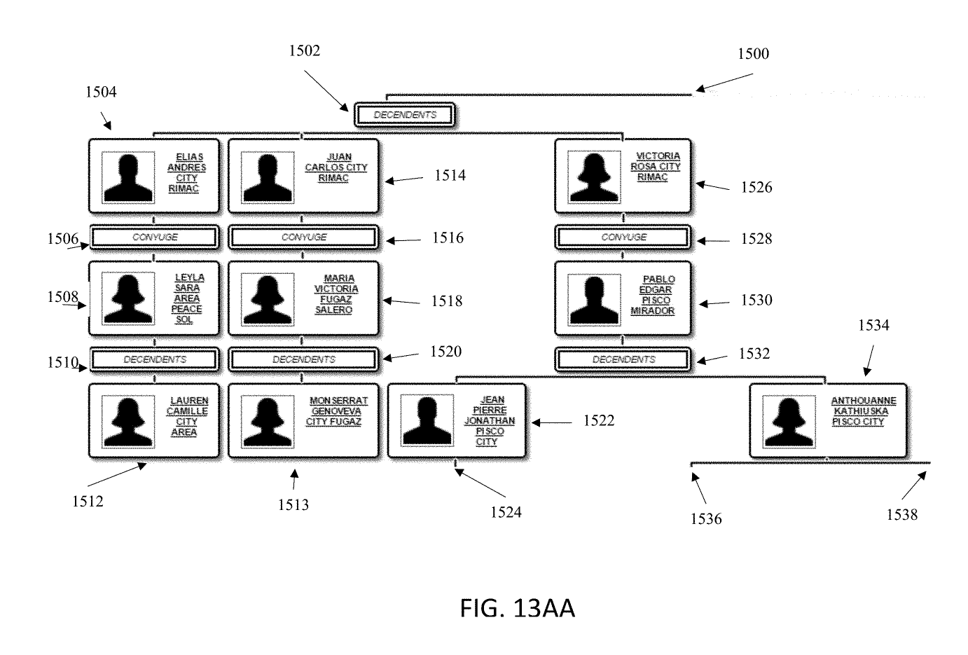

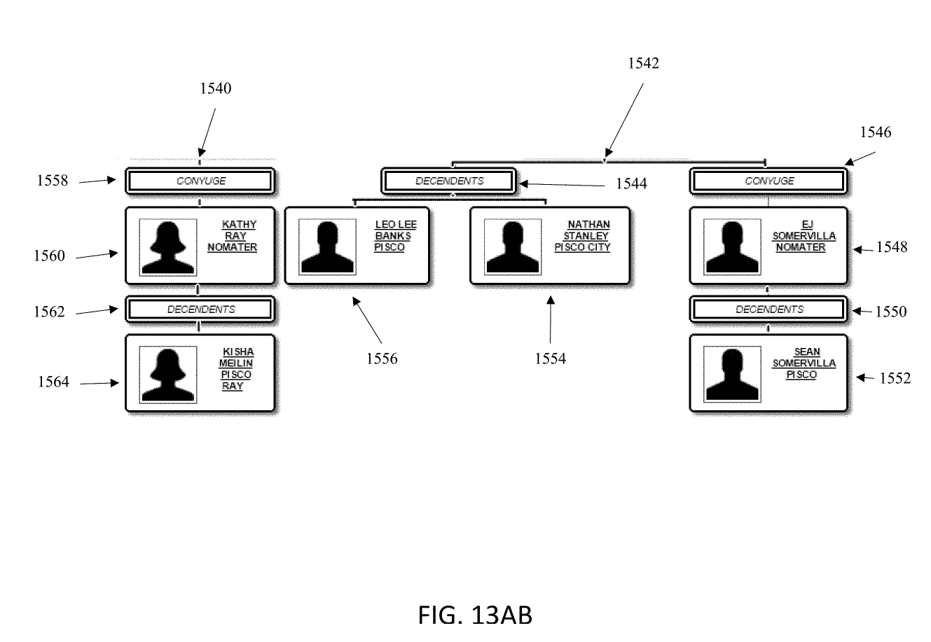

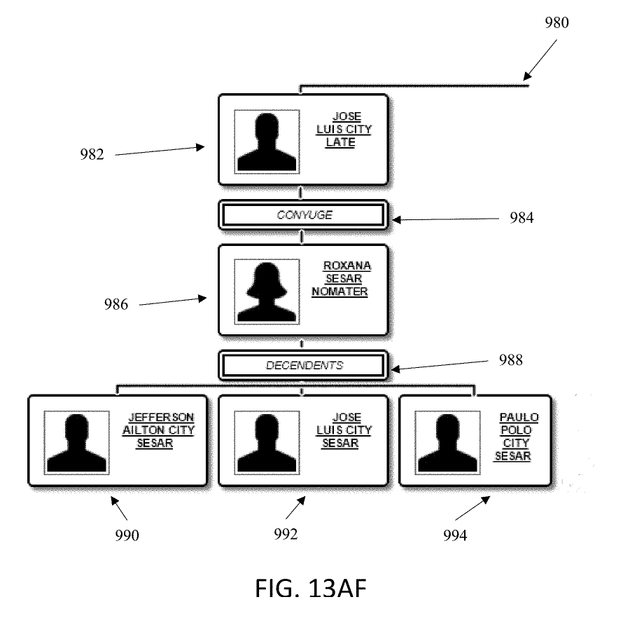

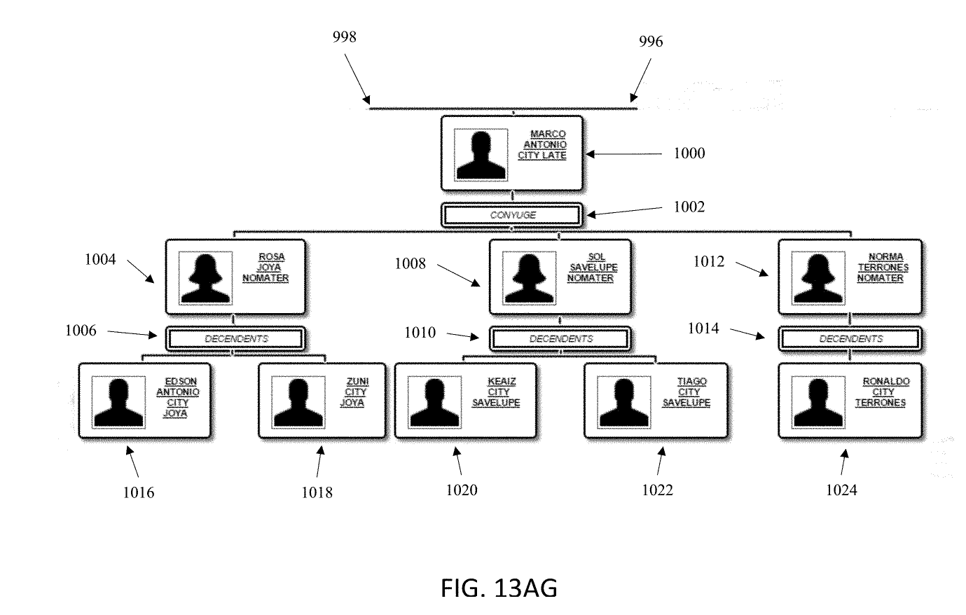

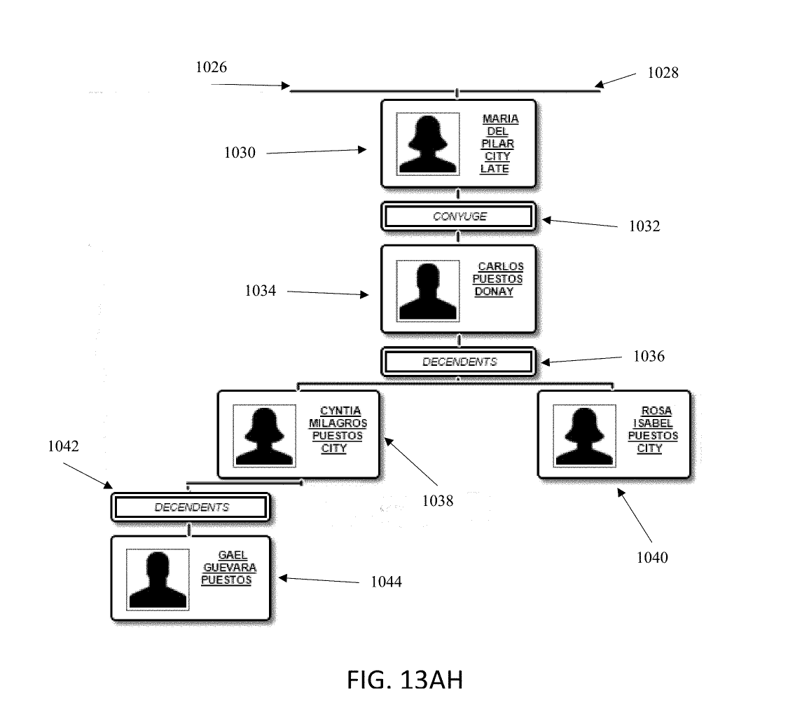

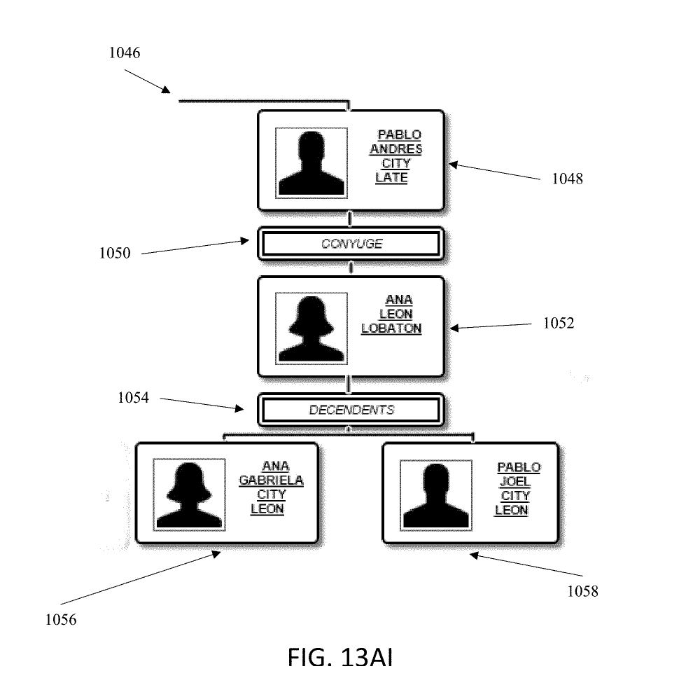

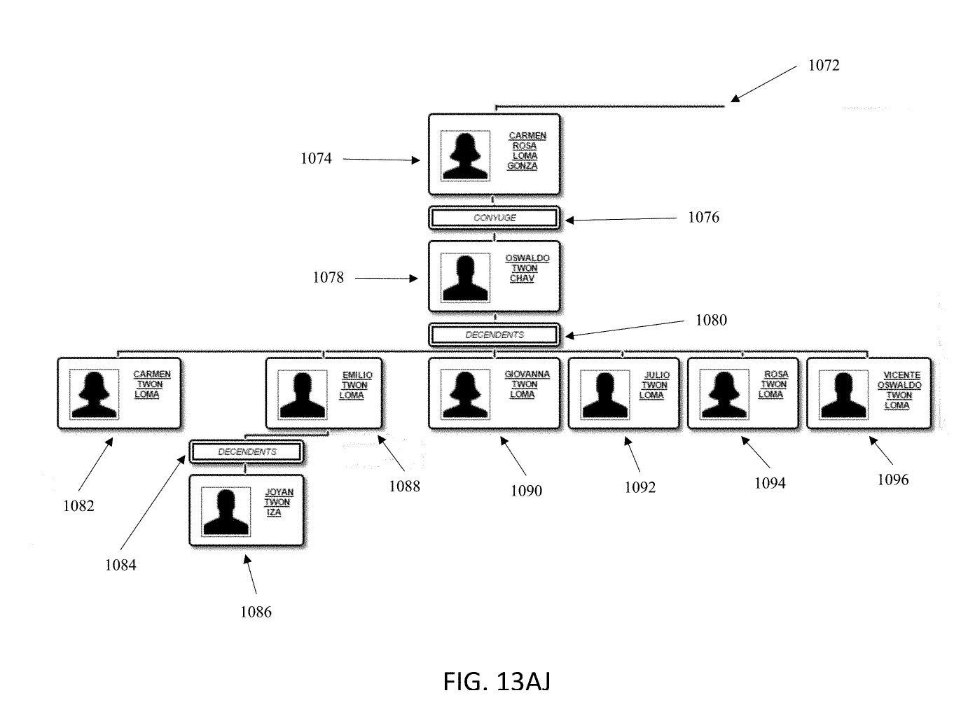

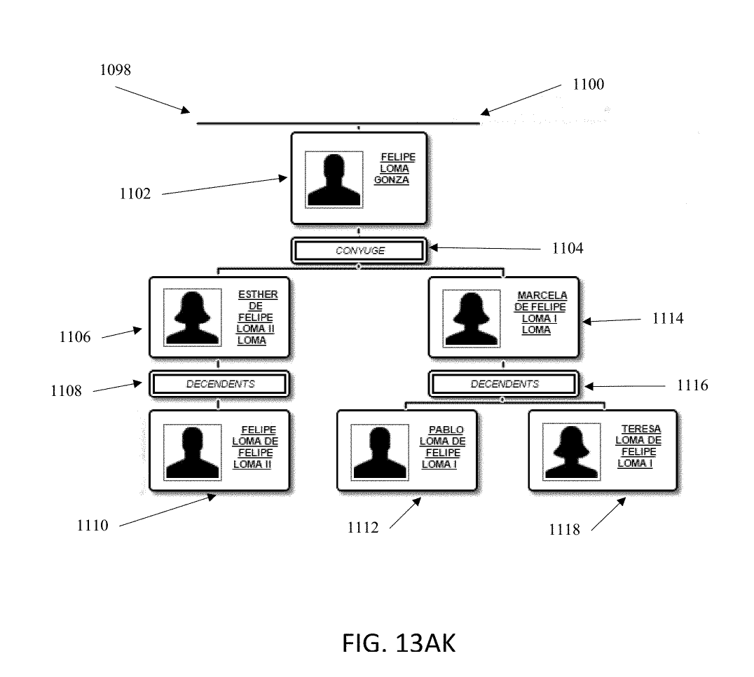

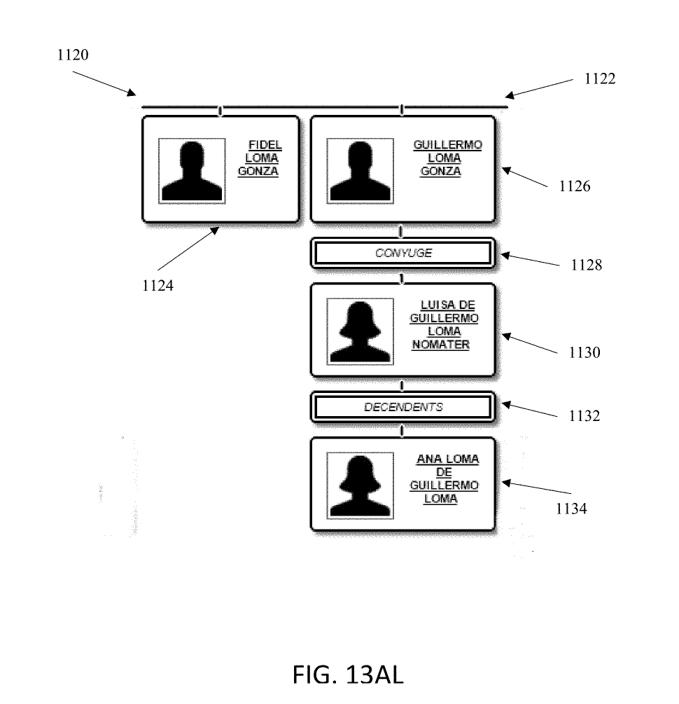

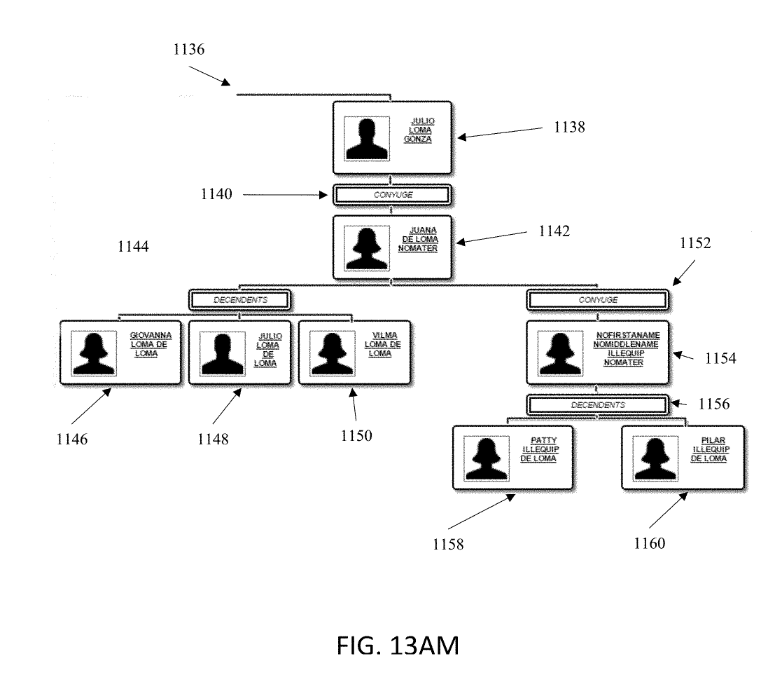

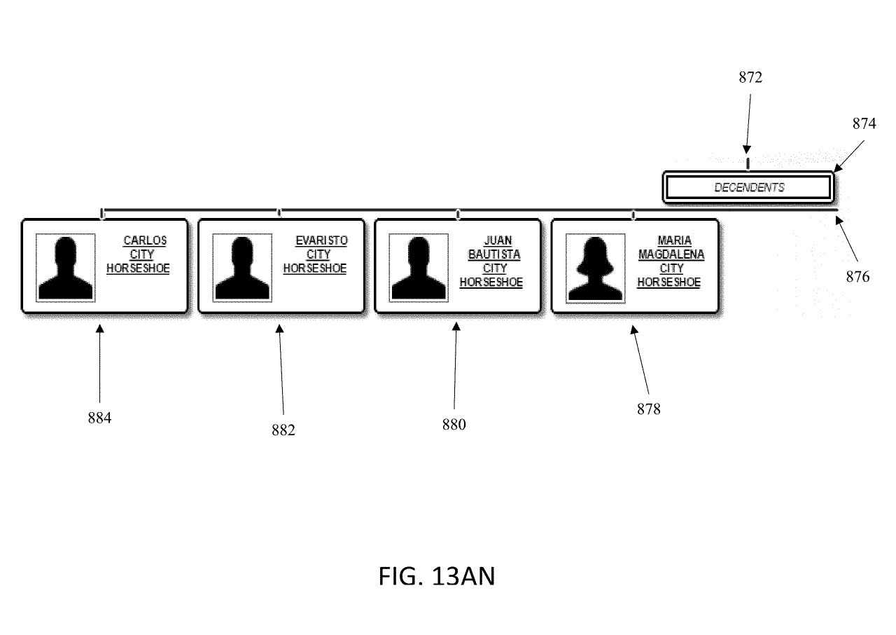

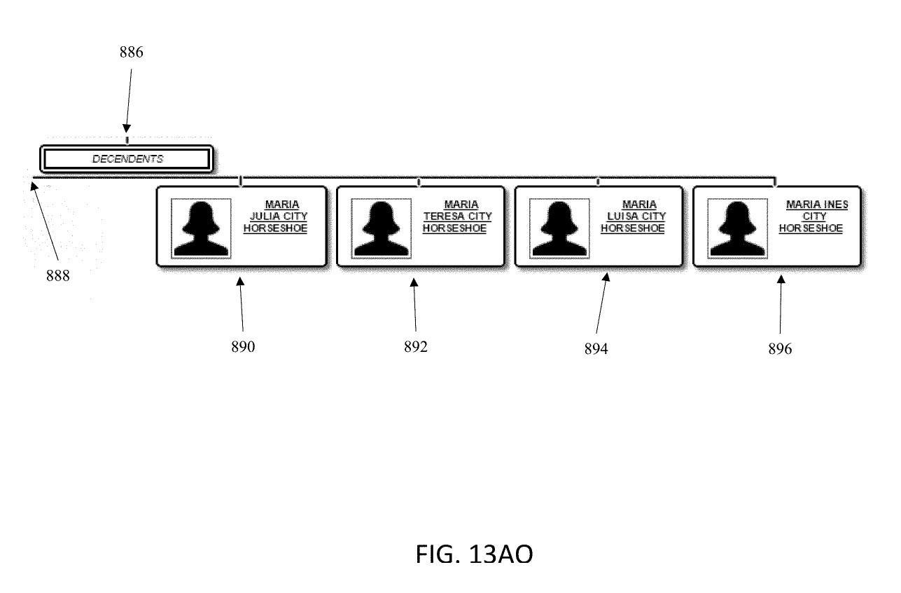

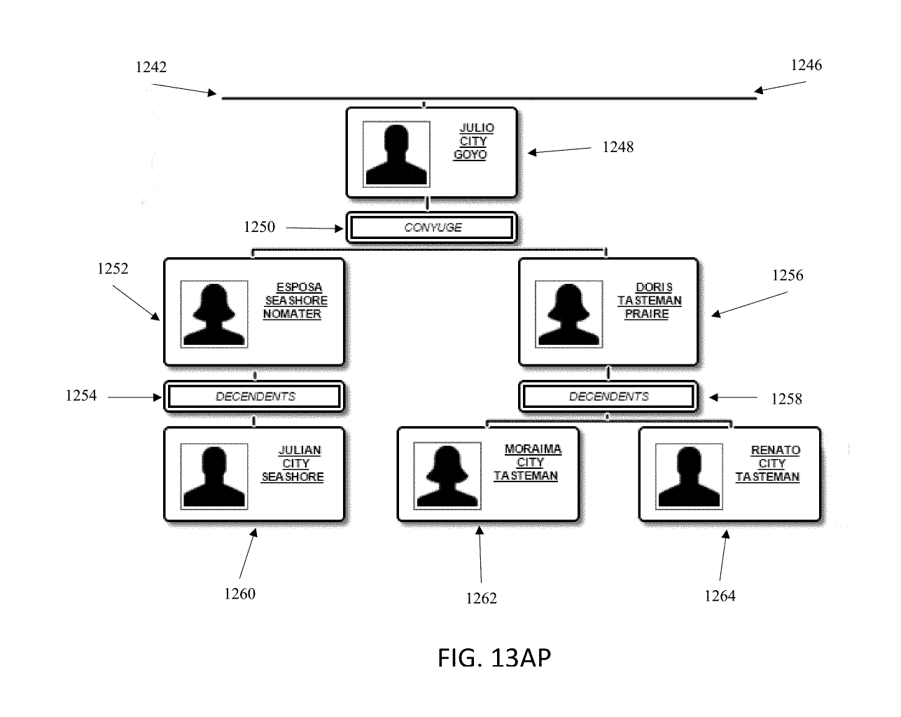

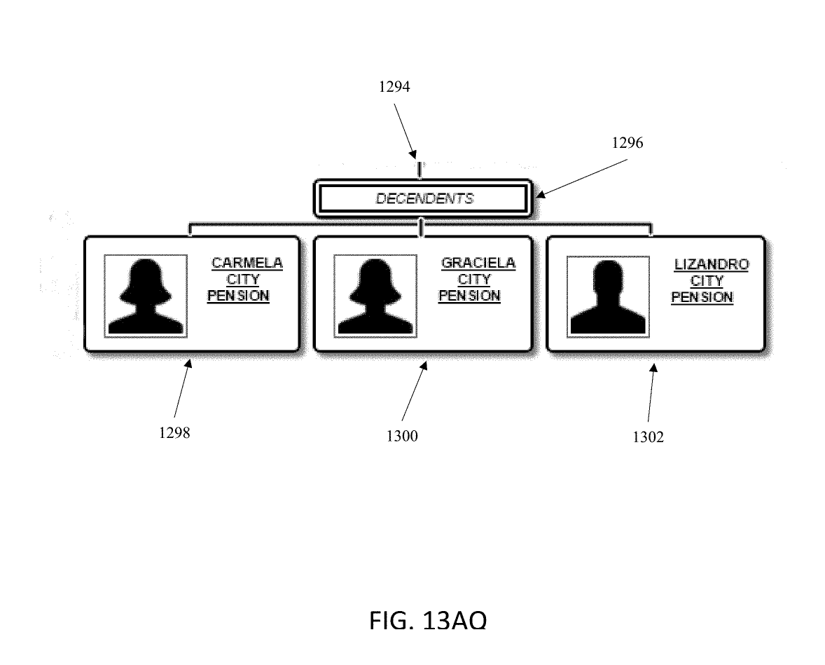

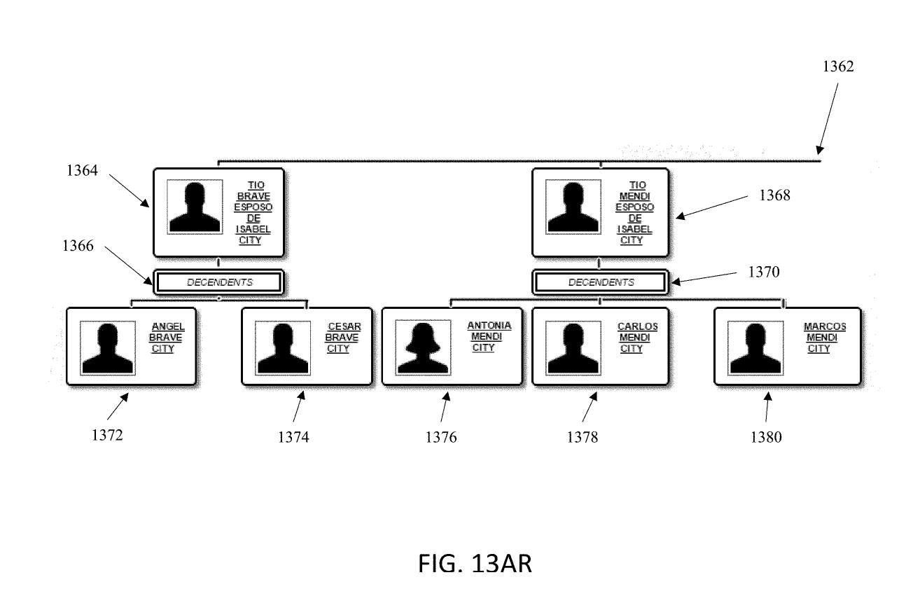

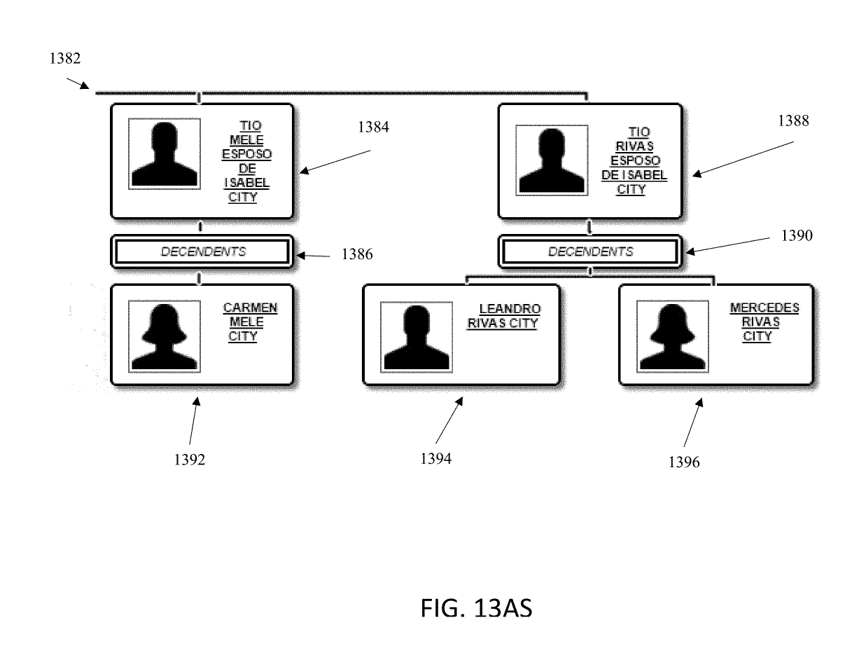

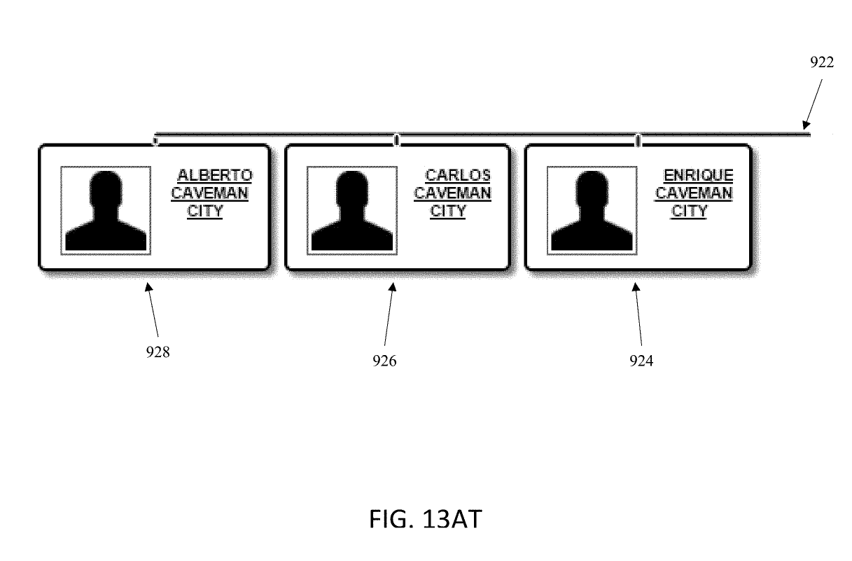

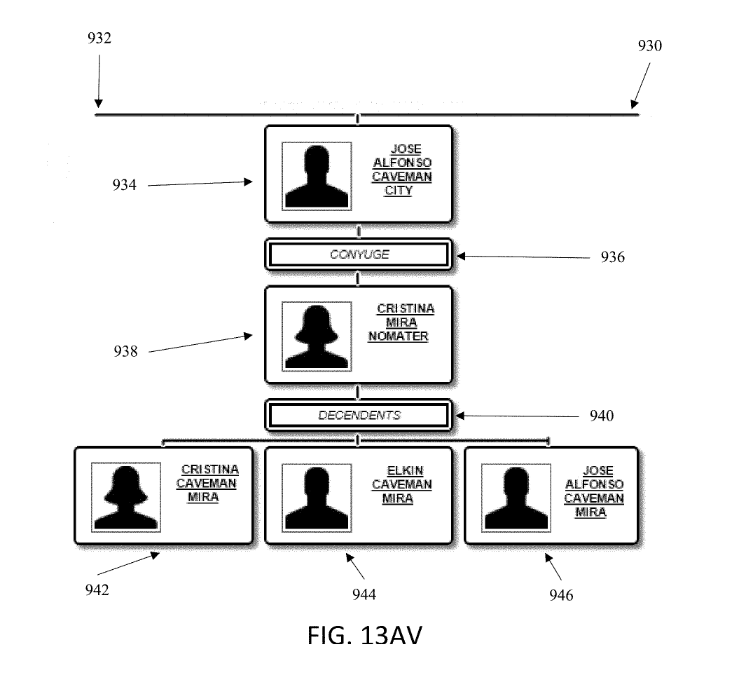

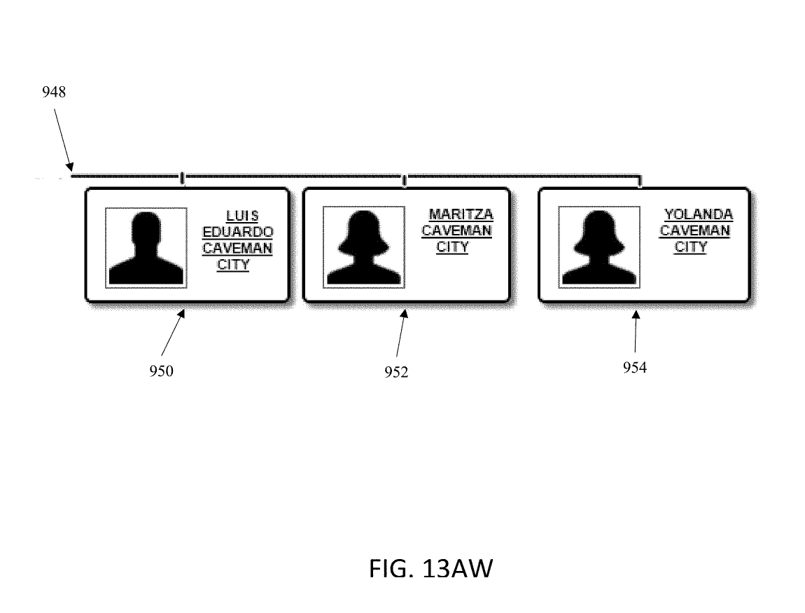

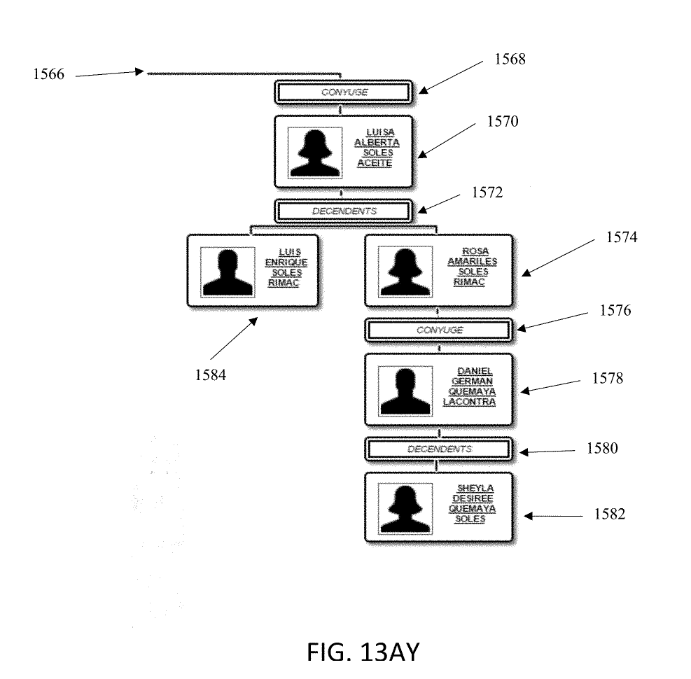

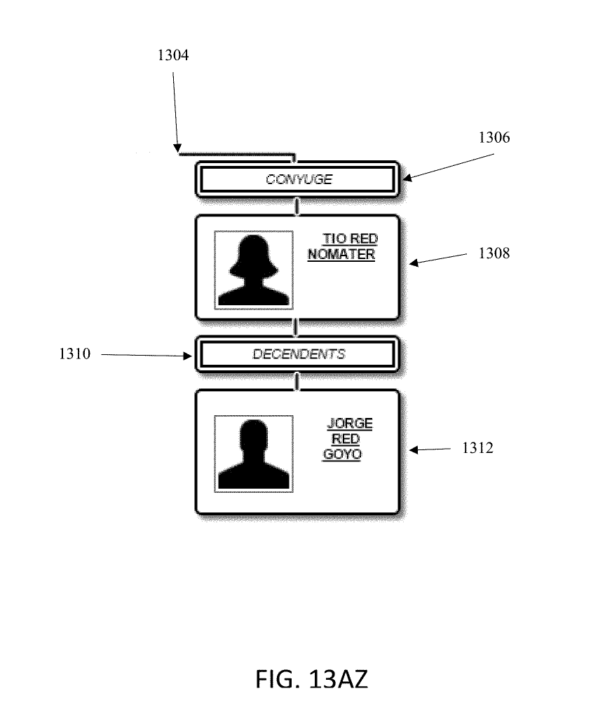

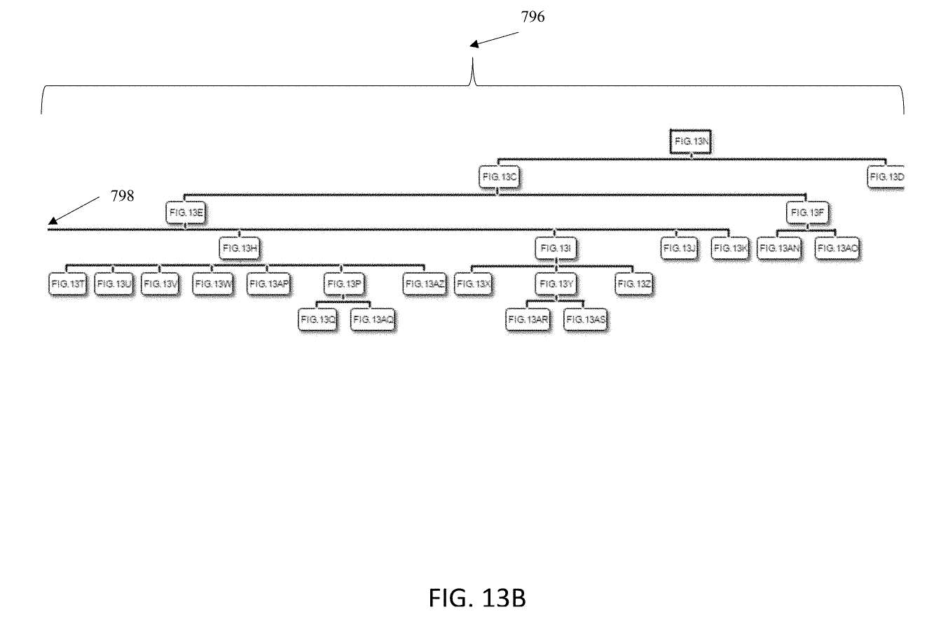

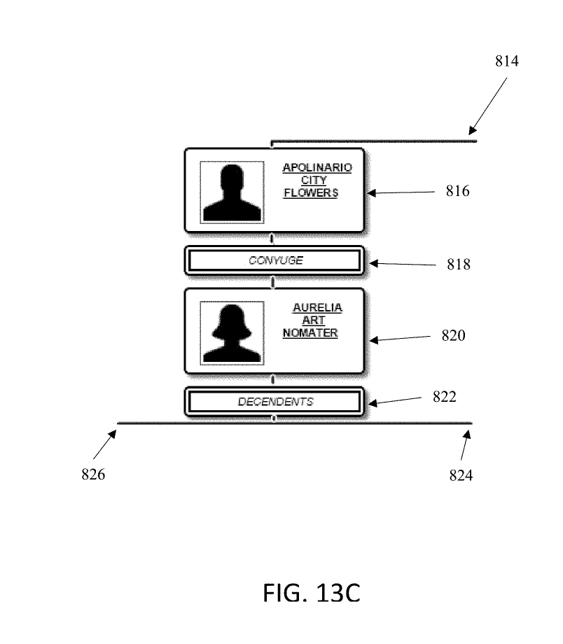

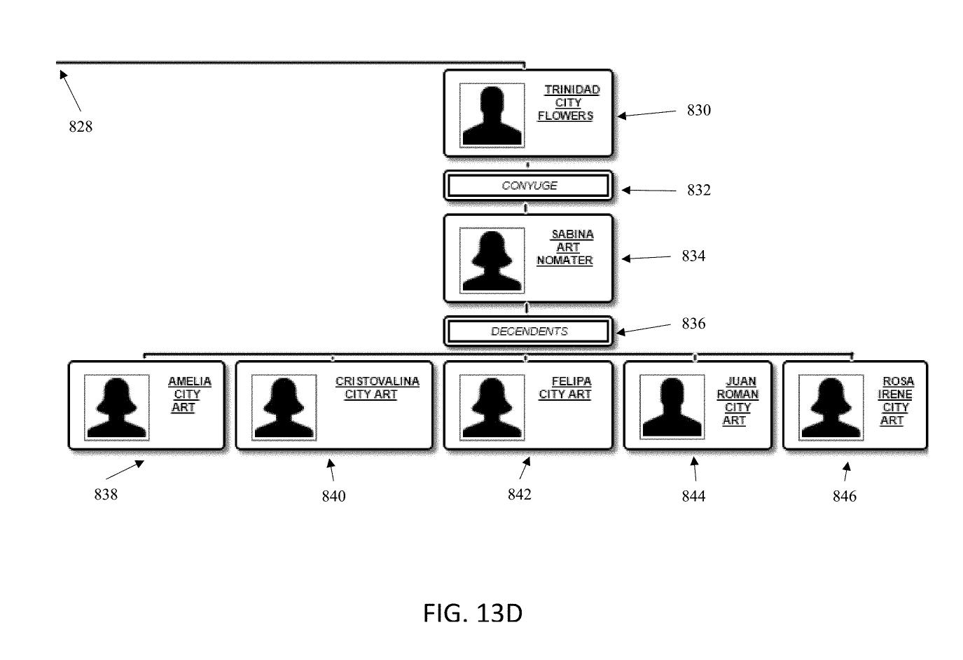

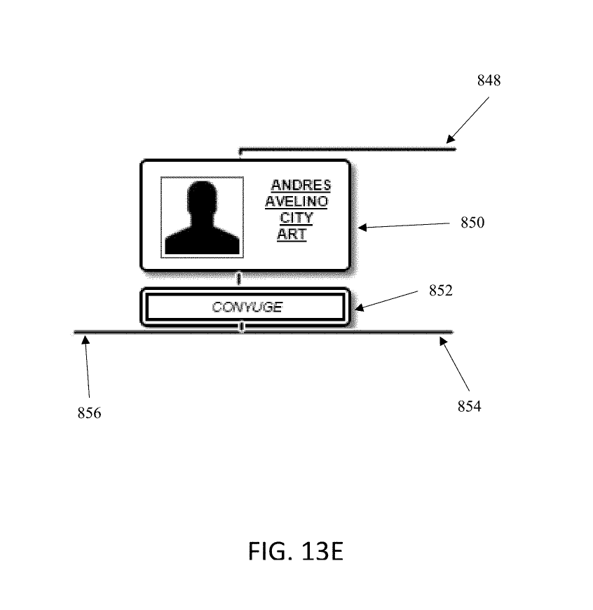

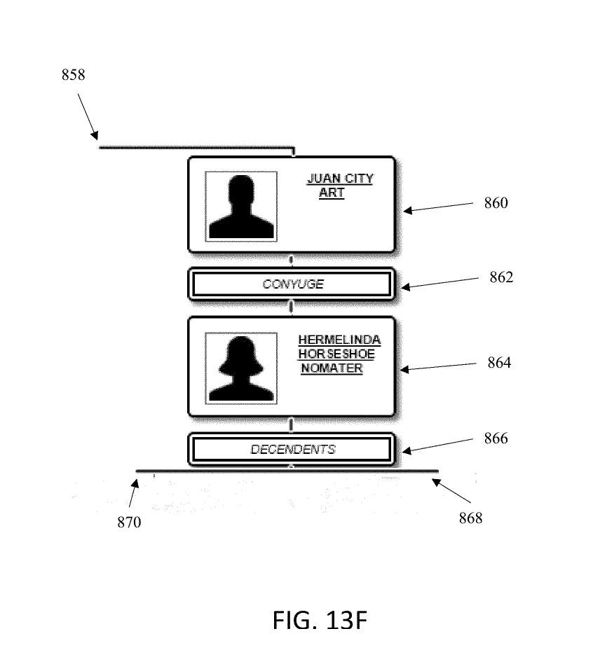

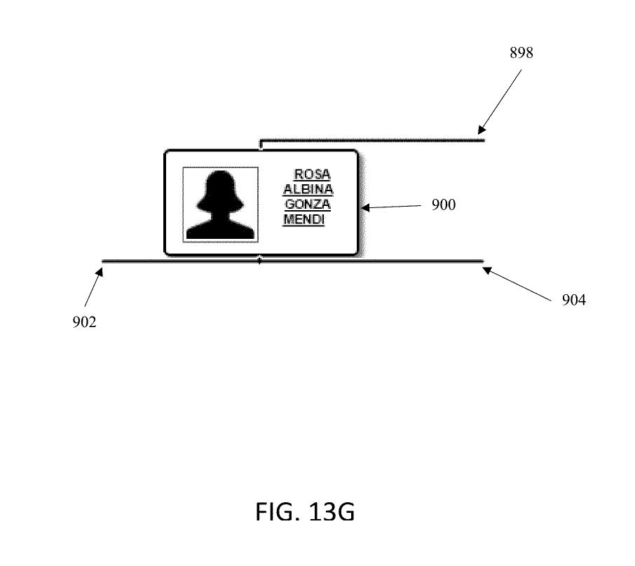

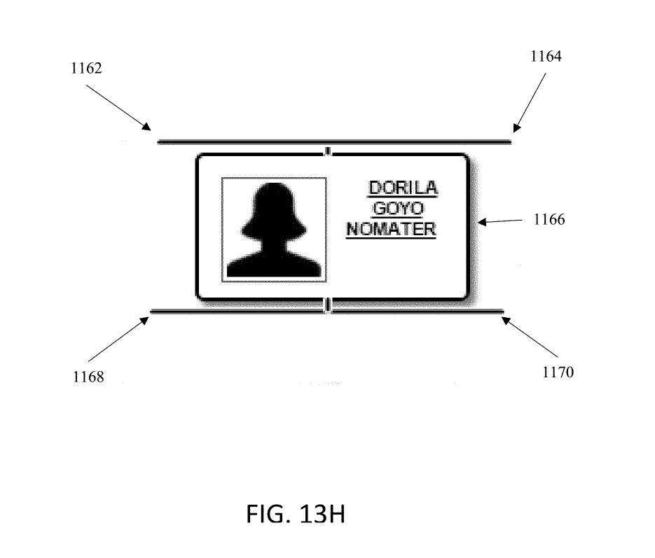

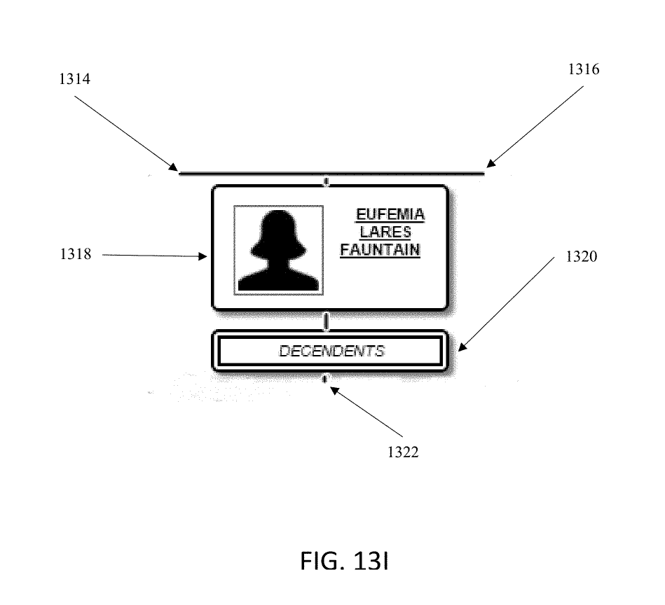

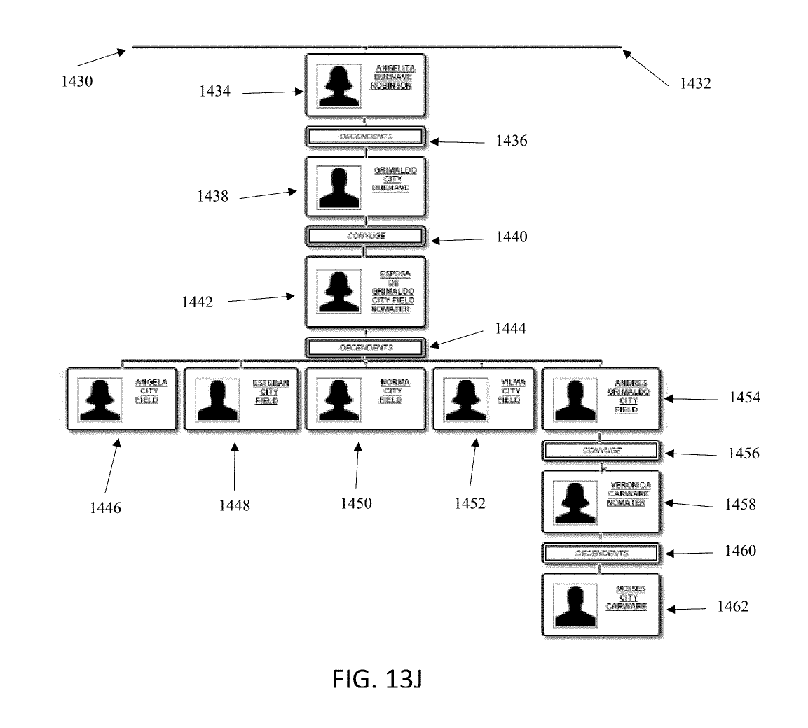

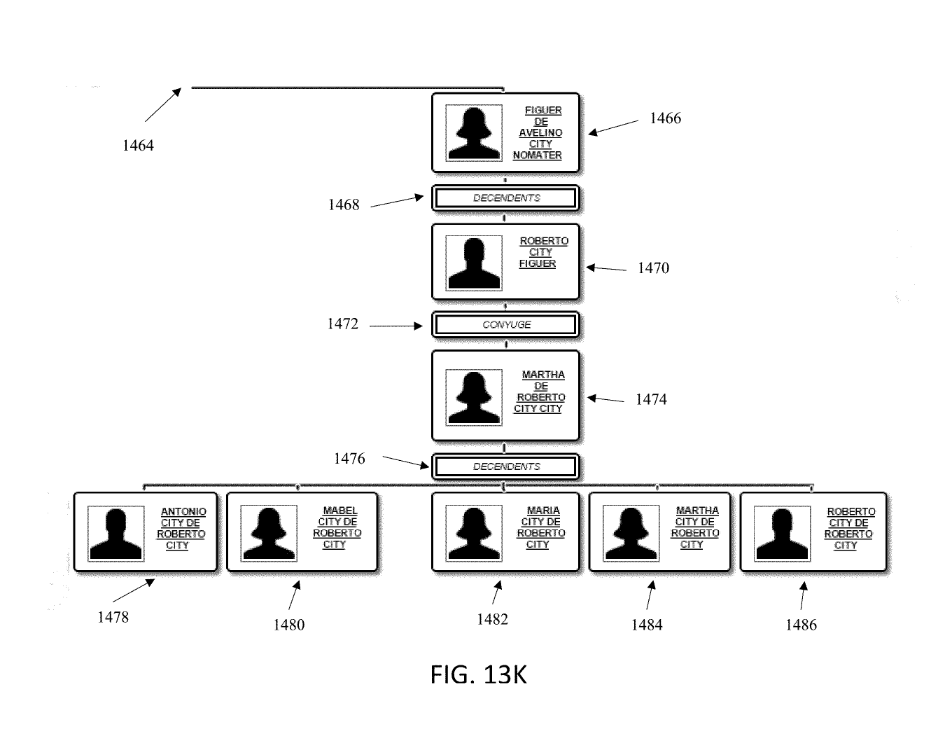

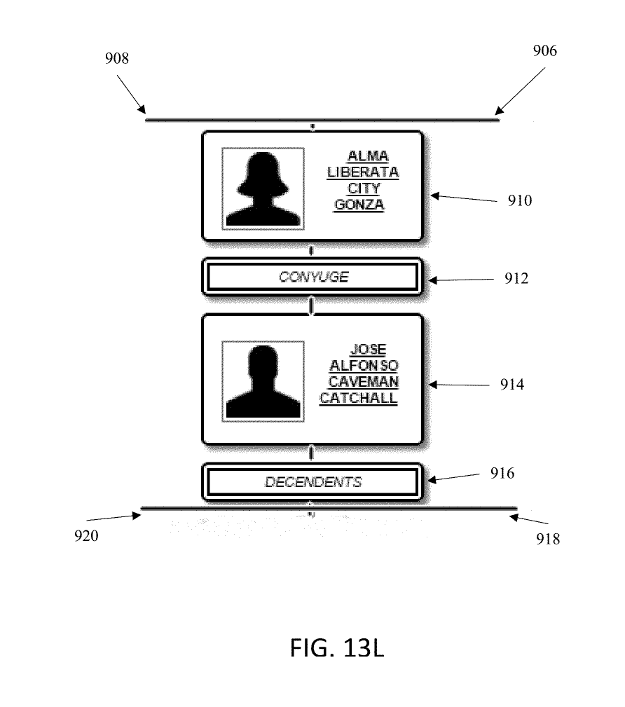

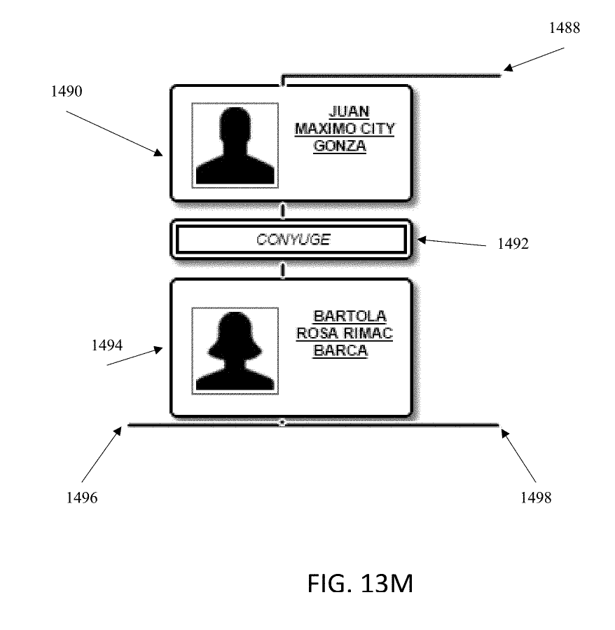

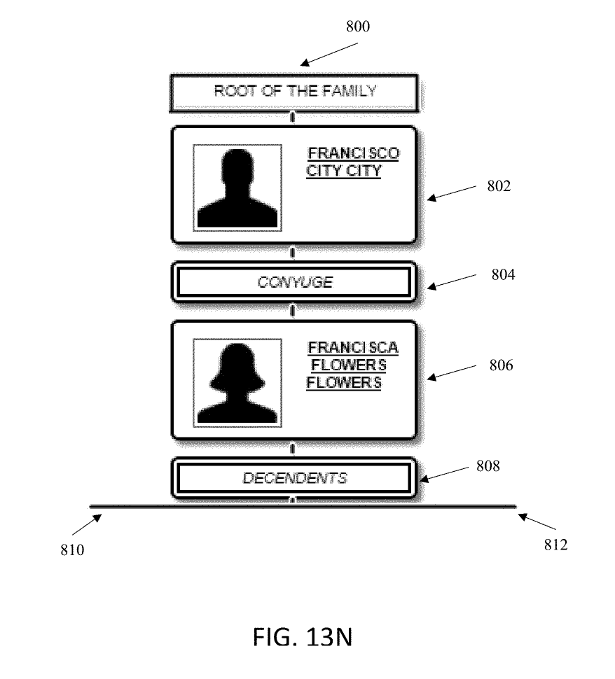

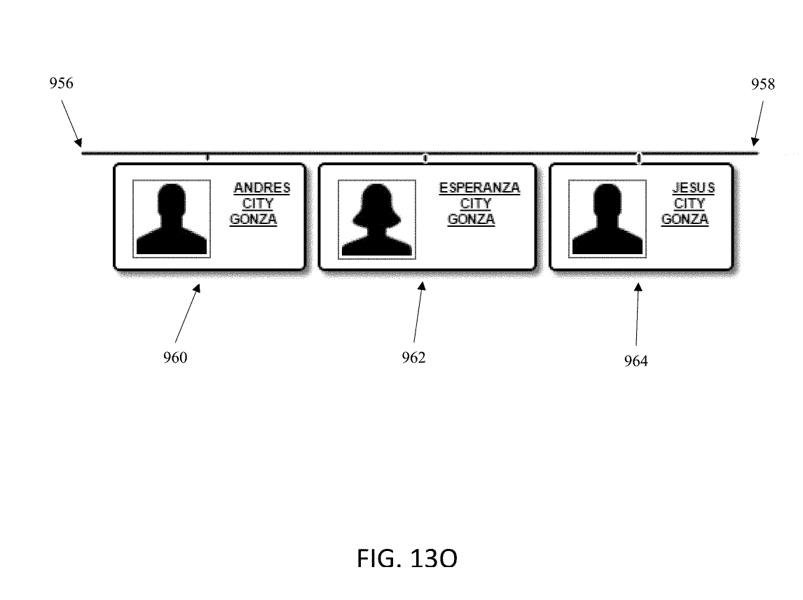

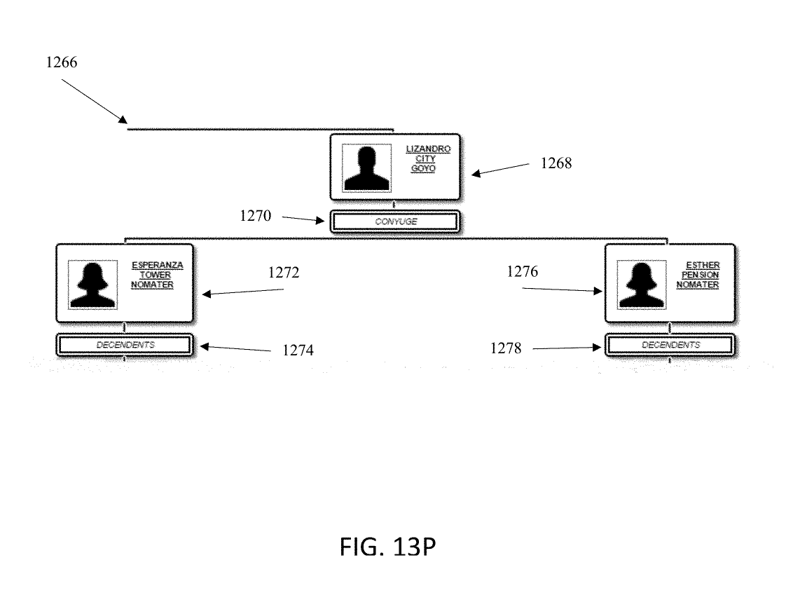

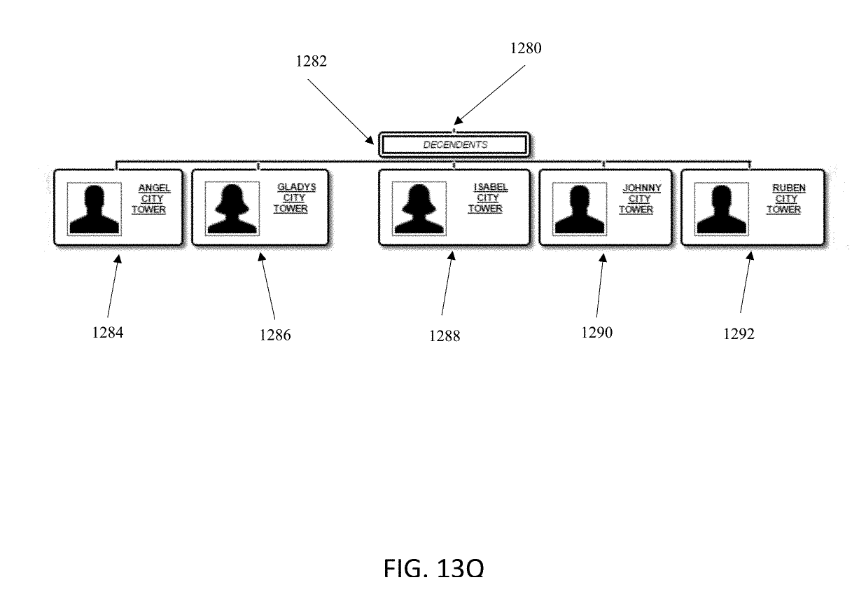

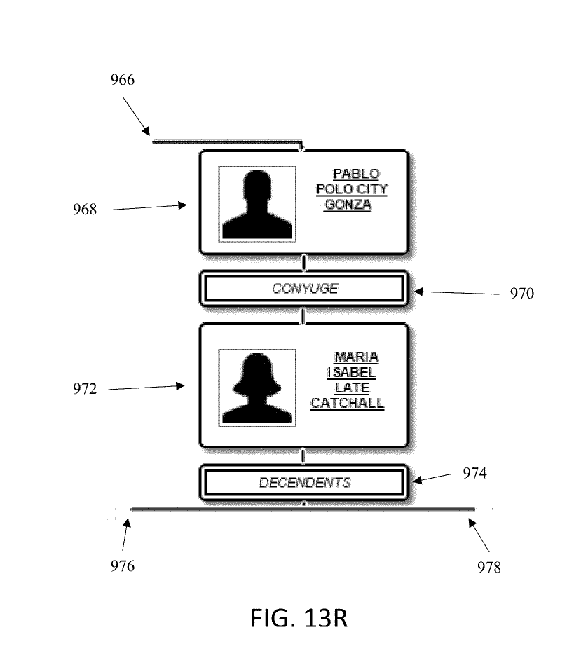

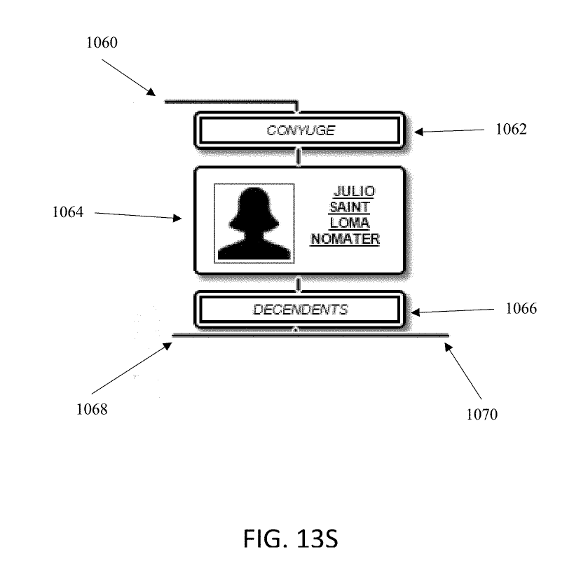

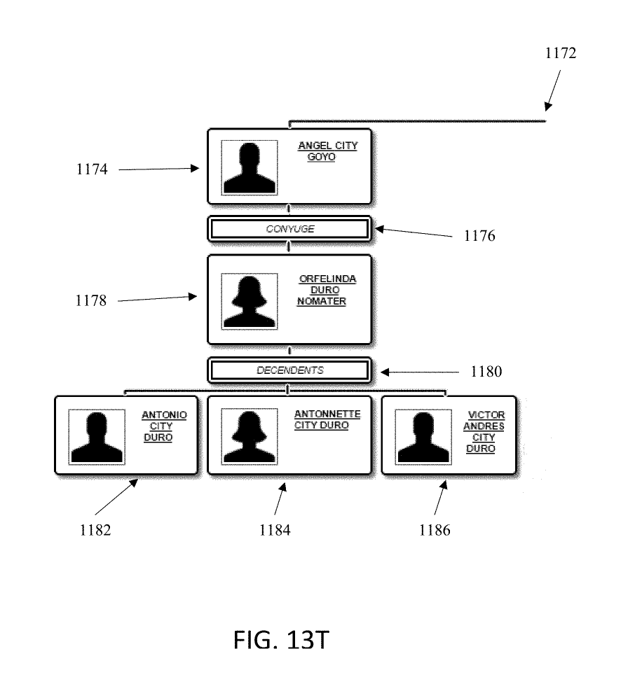

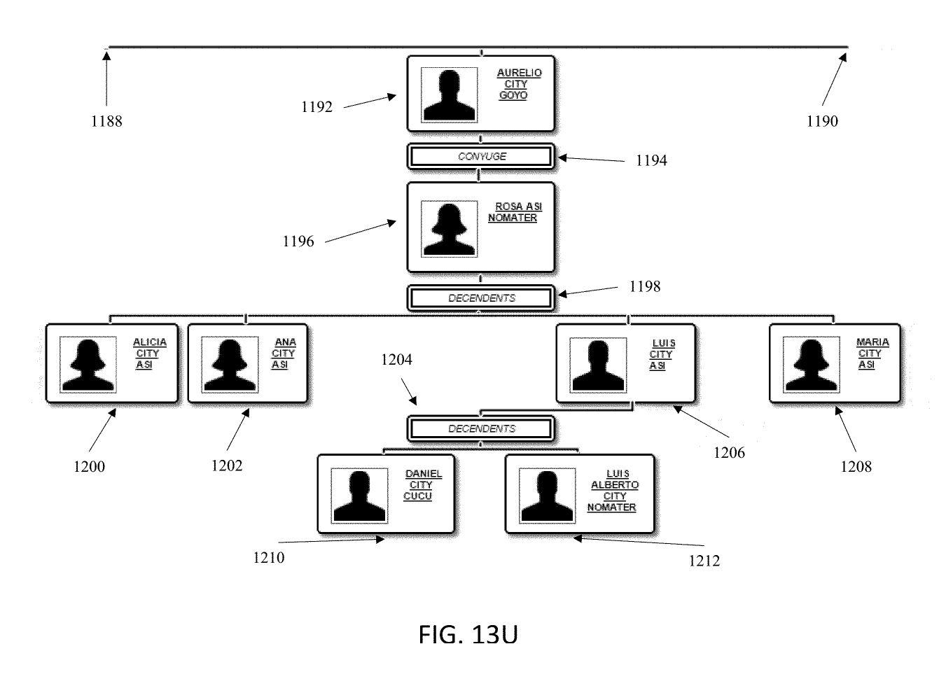

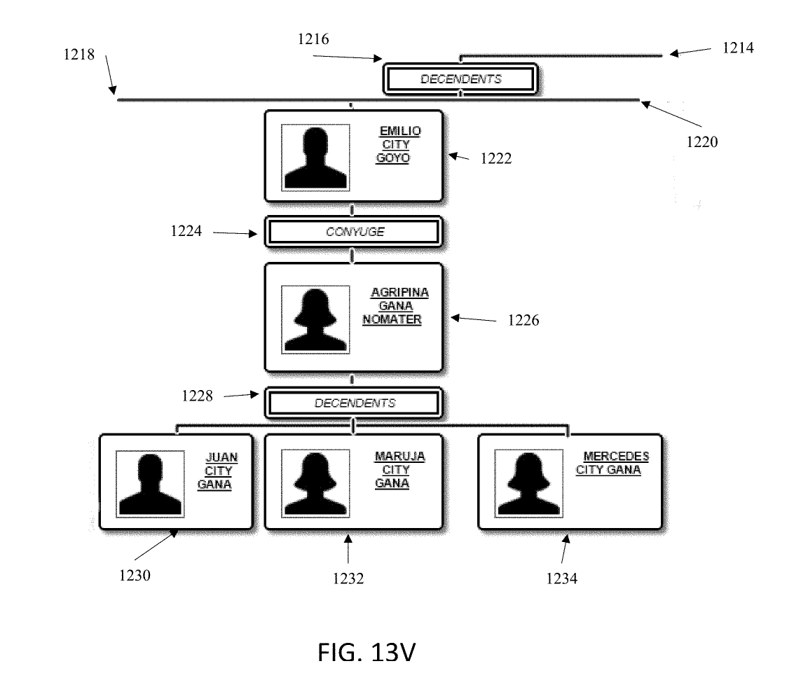

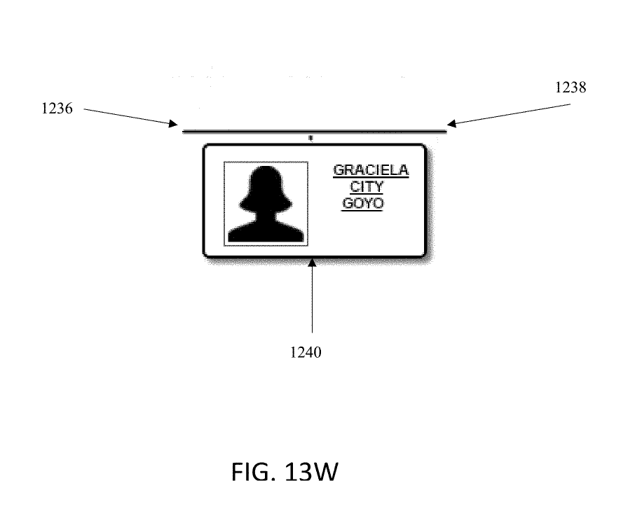

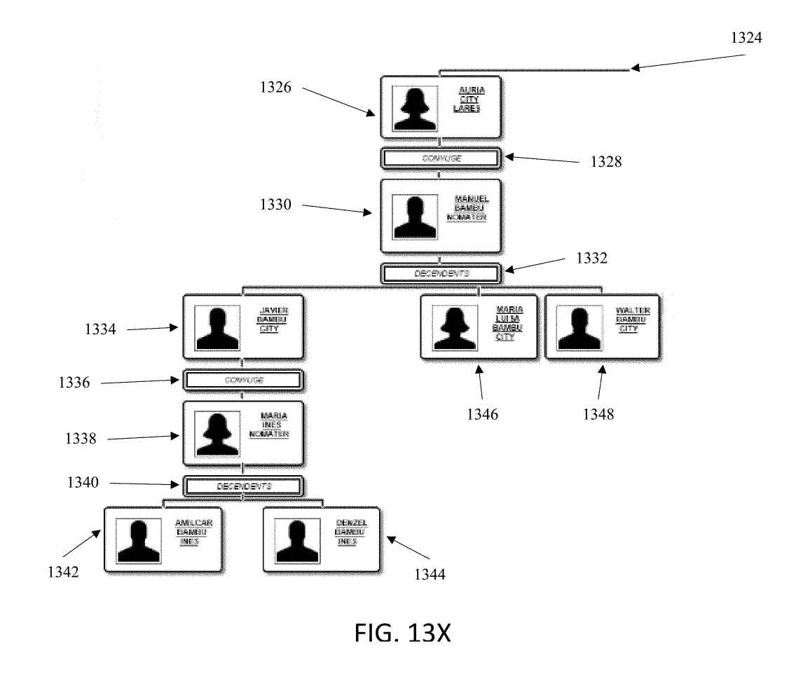

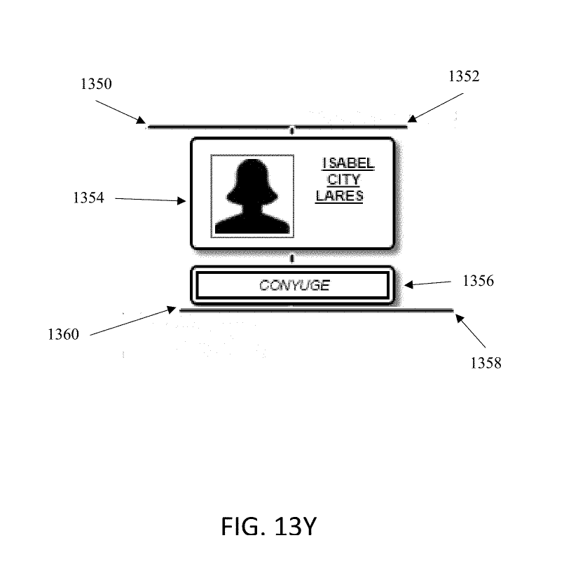

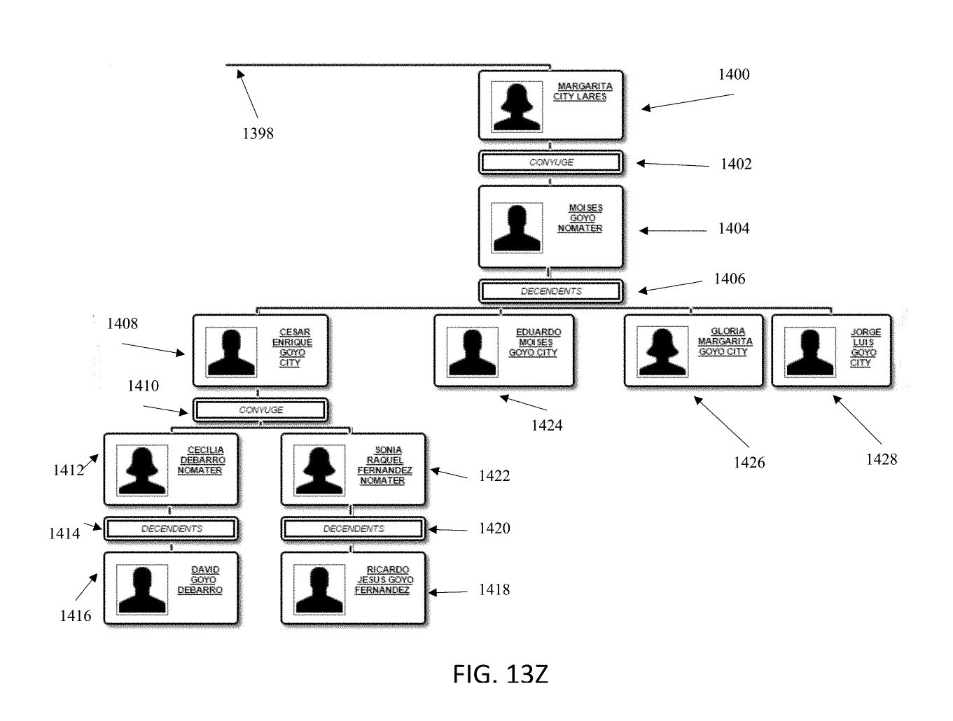

With reference now to the figures and in particular with references to FIGS. 13A-13AZ, are exemplary diagrams of graphical view of the depiction of the first parental family tree of the tree owner node, in which illustrative embodiments may be implemented. It should be appreciated that FIGS. 13A-13AZ are only exemplary and are not intended to assert or imply any limitation with regards to the environment in which different embodiments may be implemented. Many modifications to the depicted environments may be made.

With reference now to figure, FIG. 13A depicts a pictorial representation of an exemplary embodiment graphical summary view of the depiction of the first parental family tree of the tree owner node 792. It should be appreciated that FIG. 13A is only exemplary and is not intended to assert or imply any limitation with regards to the environment in which different embodiments may be implemented. Many modifications to the depicted environments may be made. 794 points to 798 in FIG. 13B Due to the vast representation of the graphical view and the magnitude of the embodiment of the family tree of less than 300 members, FIGS. 13C through 13AZ were located in the summary on their right position of overlay on FIGS. 13A-13B and subsequently discussed.

With reference now to figure, FIG. 13B and proceeding from FIG. 13A, FIG. 13B depicts a pictorial representation of an exemplary embodiment graphical summary view of the depiction of the first parental family tree of the tree owner node 796. It should be appreciated that FIG. 13B is only exemplary and is not intended to assert or imply any limitation with regards to the environment in which different embodiments may be implemented. Many modifications to the depicted environments may be made. 798 points to 794 in FIG. 13A. Due to the vast representation of the graphical view and the magnitude of the embodiment of the family tree of less than 300 members, FIGS. 13C through 13AZ were located in the summary on their right position of overlay on FIGS. 13A-13B and subsequently discussed.

With reference now to figure, FIG. 13N and proceeding from FIG. 13B, FIG. 13N depicts a pictorial representation of an exemplary embodiment for the sectional view of the depiction of the first parental family tree of the tree owner node. It should be appreciated that FIG. 13N is only exemplary and is not intended to assert or imply any limitation with regards to the environment in which different embodiments may be implemented. Many modifications to the depicted environments may be made. The root of the family label 800, the root of the family 802, the spouse or partner label 804, the spouse or partner for the root 806, label for children or off spring from the root 808. Reference 810 points to FIG. 13C and reference 812 points to FIG. 13D.

With reference now to figure, FIG. 13D and proceeding from FIG. 13N, FIG. 13D depicts a pictorial representation of an exemplary embodiment for the sectional view of the depiction of the first parental family tree of the tree owner node. It should be appreciated that FIG. 13D is only exemplary and is not intended to assert or imply any limitation with regards to the environment in which different embodiments may be implemented. Many modifications to the depicted environments may be made. Reference 828 points to FIG. 13N. Reference 830 is a child of 802 on FIG. 13N. Reference 832 is a spouse label between 830 and 834 and 834 is the spouse of 830. Reference 836 is the children label of 830 and 834. References 838, 840, 842, 844 and 846 are the children of 830 and 834.

With reference now to figure, FIG. 13C and proceeding from FIG. 13D, FIG. 13C depicts a pictorial representation of an exemplary embodiment for the sectional view of the depiction of the first parental family tree of the tree owner node. It should be appreciated that FIG. 13C is only exemplary and is not intended to assert or imply any limitation with regards to the environment in which different embodiments may be implemented. Many modifications to the depicted environments may be made. Reference 814 points to FIG. 13N. Reference 816 is another child of 802 on FIG. 13N. Reference is the spouse label between 816 and 820. Reference 820 is the spouse of 816. Reference 822 is the child label between 816 and 820. Reference 826 points to FIG. 13E. Reference 824 points to FIG. 13F.

With reference now to figure, FIG. 13F and proceeding from FIG. 13C, FIG. 13F depicts a pictorial representation of an exemplary embodiment for the sectional view of the depiction of the first parental family tree of the tree owner node. It should be appreciated that FIG. 13F is only exemplary and is not intended to assert or imply any limitation with regards to the environment in which different embodiments may be implemented. Many modifications to the depicted environments may be made. Reference 858 points to FIG. 13C. Reference 860 is a child of 816 and 820. Reference 862 is the spouse label between 860 and 864. Reference 864 is the spouse of 860. Reference 866 is children label of 860 and 868. Reference 870 points to FIG. 13AN. Reference 868 points to FIG. 13AO.

With reference now to figure, FIG. 13AN and proceeding from FIG. 13F, FIG. 13AN depicts a pictorial representation of an exemplary embodiment for the sectional view of the depiction of the first parental family tree of the tree owner node. It should be appreciated that FIG. 13AN is only exemplary and is not intended to assert or imply any limitation with regards to the environment in which different embodiments may be implemented. Many modifications to the depicted environments may be made. Reference 872 points to FIG. 13F. Reference 874 is the children label between 860 and 864. Reference 876 points to FIG. 13AO. References 884, 882, 880 and 878 are the children between 860 and 864.

With reference now to figure, FIG. 13AO and proceeding from FIG. 13AN, FIG. 13AO depicts a pictorial representation of an exemplary embodiment for the sectional view of the depiction of the first parental family tree of the tree owner node. It should be appreciated that FIG. 13AO is only exemplary and is not intended to assert or imply any limitation with regards to the environment in which different embodiments may be implemented. Many modifications to the depicted environments may be made. Reference 886 points to FIG. 13F. Reference 888 points to FIG. 13AN. References 890, 892, 894 and 896 are also the children between 860 and 864.

With reference now to figure, FIG. 13E and proceeding from FIG. 13AO, FIG. 13E depicts a pictorial representation of an exemplary embodiment for the sectional view of the depiction of the first parental family tree of the tree owner node. It should be appreciated that FIG. 13E is only exemplary and is not intended to assert or imply any limitation with regards to the environment in which different embodiments may be implemented. Many modifications to the depicted environments may be made. Reference 848 points to FIG. 13F. Reference 850 is the child of 816 and 820 on FIG. 13C. Reference 852 is the spouse label for 850, who has fathered children with spouses in FIGS. 13E-13K. Reference 856 points to FIG. 13G. Reference 854 points to FIG. 13H.

With reference now to figure, FIG. 13H and proceeding from FIG. 13E, FIG. 13H depicts a pictorial representation of an exemplary embodiment for the sectional view of the depiction of the first parental family tree of the tree owner node. It should be appreciated that FIG. 13H is only exemplary and is not intended to assert or imply any limitation with regards to the environment in which different embodiments may be implemented. Many modifications to the depicted environments may be made. Reference 1162 points to FIG. 13G. Reference 1164 points to FIG. 13I. Reference 1166 is the spouse of 850 on FIG. 13E. Reference 1168 points to FIG. 13W. Reference 1170 points to FIG. 13AP.

With reference now to figure, FIG. 13T and proceeding from FIG. 13H, FIG. 13T depicts a pictorial representation of an exemplary embodiment for the sectional view of the depiction of the first parental family tree of the tree owner node. It should be appreciated that FIG. 13T is only exemplary and is not intended to assert or imply any limitation with regards to the environment in which different embodiments may be implemented. Many modifications to the depicted environments may be made. Reference 1172 points to FIG. 13U. Reference 1174 is the child of 1166 on FIG. 13H and 850 on FIG. 13E. Reference 1176 is the spouse label between 1174 and 1178. Reference 1180 is the children label between 1174 and 1178. References 1182, 1184 and 1186 are the children of 1174 and 1178.

With reference now to figure, FIG. 13U and proceeding from FIG. 13T, FIG. 13U depicts a pictorial representation of an exemplary embodiment for the sectional view of the depiction of the first parental family tree of the tree owner node. It should be appreciated that FIG. 13U is only exemplary and is not intended to assert or imply any limitation with regards to the environment in which different embodiments may be implemented. Many modifications to the depicted environments may be made. Reference 1188 points to FIG. 13T. Reference 1190 points to FIG. 13V. Reference 1192 is the child of 1166 on FIG. 13H and 850 on FIG. 13E. Reference 1194 is the spouse label between 1192 and 1196. Reference 1196 is the spouse of 1192. Reference 1198 is the children label between 1192 and 1192. References 1200, 1202, 1206 and 1208 are the children between 1192 and 1196. Reference 1204 is the children label of 1206. References 1210 and 1212 are the children of 1206.

With reference now to figure, FIG. 13V and proceeding from FIG. 13U, FIG. 13V depicts a pictorial representation of an exemplary embodiment for the sectional view of the depiction of the first parental family tree of the tree owner node. It should be appreciated that FIG. 13V is only exemplary and is not intended to assert or imply any limitation with regards to the environment in which different embodiments may be implemented. Many modifications to the depicted environments may be made. Reference 1214 points to FIG. 13H. Reference 1216 is the children label of 1166 on FIG. 13H and 850 on FIG. 13E. Reference 1218 points to FIG. 13U. Reference 1220 points to FIG. 13W. Reference 1222 is the child of 1166 on FIG. 13H and 850 on FIG. 13E. Reference 1224 is the spouse label between 1222 and 1226. Reference 1226 is the spouse of 1222. Reference 1228 is the children label between 1222 and 1226. References 1230, 1232, and 1234 are the children between 1222 and 1226.

With reference now to figure, FIG. 13W and proceeding from FIG. 13V, FIG. 13W depicts a pictorial representation of an exemplary embodiment for the sectional view of the depiction of the first parental family tree of the tree owner node. It should be appreciated that FIG. 13W is only exemplary and is not intended to assert or imply any limitation with regards to the environment in which different embodiments may be implemented. Many modifications to the depicted environments may be made. Reference 1236 points to FIG. 13V. Reference 1236 points to FIG. 13AP. Reference 1240 is the child of 1166 on FIG. 13H and 850 on FIG. 13E.

With reference now to figure, FIG. 13AP and proceeding from FIG. 13W, FIG. 13AP depicts a pictorial representation of an exemplary embodiment for the sectional view of the depiction of the first parental family tree of the tree owner node. It should be appreciated that FIG. 13AP is only exemplary and is not intended to assert or imply any limitation with regards to the environment in which different embodiments may be implemented. Many modifications to the depicted environments may be made. Reference 1242 points to FIG. 13W. Reference 1246 points to FIG. 13P. Reference 1248 is the child of 1166 on FIG. 13H and 850 on FIG. 13E. Reference 1250 is the spouse label between 1248 and 1252, also 1248 and 1256. Reference 1252 is the spouse of 1248. Reference 1256 is the spouse of 1248. Reference 1258 is the children label between 1248 and 1256. References 1262 and 1264 are the children between 1248 and 1256. Reference 1254 is the child label between 1248 and 1252. Reference 1260 is the child of 1248 and 1252.

With reference now to figure, FIG. 13P and proceeding from FIG. 13AP, FIG. 13P depicts a pictorial representation of an exemplary embodiment for the sectional view of the depiction of the first parental family tree of the tree owner node. It should be appreciated that FIG. 13P is only exemplary and is not intended to assert or imply any limitation with regards to the environment in which different embodiments may be implemented. Many modifications to the depicted environments may be made. Reference 1266 points to FIG. 13AP. Reference 1268 is the child of 1166 on FIG. 13H and 850 on FIG. 13E. Reference 1270 is the spouse label between 1268 and 1272, also 1268 and 1276. Reference 1272 is the spouse of 1268. Reference 1276 is the spouse of 1268. Reference 1274 is the children label between 1268 and 1272. Reference 1278 is the children label between 1268 and 1276.

With reference now to figure, FIG. 13Q and proceeding from FIG. 13P, FIG. 13Q depicts a pictorial representation of an exemplary embodiment for the sectional view of the depiction of the first parental family tree of the tree owner node. It should be appreciated that FIG. 13Q is only exemplary and is not intended to assert or imply any limitation with regards to the environment in which different embodiments may be implemented. Many modifications to the depicted environments may be made. Reference 1282 is the children label between 1268 and 1272 on FIG. 13P. Reference 1280 points to FIG. 13P. References 1284, 1286, 1288, 1290 and 1292 are the children between 1268 and 1272 on FIG. 13P.

With reference now to figure, FIG. 13AQ and proceeding from FIG. 13Q, FIG. 13AQ depicts a pictorial representation of an exemplary embodiment for the sectional view of the depiction of the first parental family tree of the tree owner node. It should be appreciated that FIG. 13AQ is only exemplary and is not intended to assert or imply any limitation with regards to the environment in which different embodiments may be implemented. Many modifications to the depicted environments may be made. Reference 1294 is the children label between 1268 and 1276 on FIG. 13P. Reference 1296 points to FIG. 13P. References 1298, 1300 and 1302 are the children between 1268 and 1276 on FIG. 13P.

With reference now to figure, FIG. 13AZ and proceeding from FIG. 13AQ, FIG. 13AZ depicts a pictorial representation of an exemplary embodiment for the sectional view of the depiction of the first parental family tree of the tree owner node. It should be appreciated that FIG. 13AZ is only exemplary and is not intended to assert or imply any limitation with regards to the environment in which different embodiments may be implemented. Many modifications to the depicted environments may be made. Reference 1304 points to FIG. 13H. Reference 1306 is the civil union spouse label between 1308 and 1166 on FIG. 13H. Reference 1308 is the civil union spouse of 1166 on FIG. 13H. Reference 1310 is the civil union child label between 1308 and 1166 on FIG. 13H. Reference 1312 is the civil union child of 1308 and 1166 on FIG. 13H.

With reference now to figure, FIG. 13I and proceeding from FIG. 13AZ, FIG. 131 depicts a pictorial representation of an exemplary embodiment for the sectional view of the depiction of the first parental family tree of the tree owner node. It should be appreciated that FIG. 131 is only exemplary and is not intended to assert or imply any limitation with regards to the environment in which different embodiments may be implemented. Many modifications to the depicted environments may be made. Reference 1314 points to FIG. 13H. Reference 1316 points to FIG. 13J. Reference 1318 is the spouse of 850 on FIG. 13E. Reference 1322 is the children label between of 1318 and 850 on FIG. 13E.

With reference now to figure, FIG. 13X and proceeding from FIG. 13I, FIG. 13X depicts a pictorial representation of an exemplary embodiment for the sectional view of the depiction of the first parental family tree of the tree owner node. It should be appreciated that FIG. 13X is only exemplary and is not intended to assert or imply any limitation with regards to the environment in which different embodiments may be implemented. Many modifications to the depicted environments may be made. Reference 1324 points to FIG. 13Y. Reference 1326 is the child of 1318 on FIG. 13I and 850 on FIG. 13E. Reference 1328 is the spouse label between 1326 and 1330. Reference 1330 is the spouse of 1326. Reference 1332 is the children label between 1326 and 1330. References 1334, 1346 and 1348 are the children between 1326 and 1330. Reference 1336 is the spouse label between 1334 and 1338. Reference 1338 is the spouse of 1334. Reference 1340 is the children label between 1334 and 1338. References 1342 and 1344 are the children of 1334 and 1338.

With reference now to figure, FIG. 13Y and proceeding from FIG. 13X, FIG. 13Y depicts a pictorial representation of an exemplary embodiment for the sectional view of the depiction of the first parental family tree of the tree owner node. It should be appreciated that FIG. 13Y is only exemplary and is not intended to assert or imply any limitation with regards to the environment in which different embodiments may be implemented. Many modifications to the depicted environments may be made. Reference 1350 points to FIG. 13X. Reference 1352 points to FIG. 13Z. Reference 1354 is the child of 1318 on FIGS. 131 and 850 on FIG. 13E. Reference 1356 is the spouse label between 1354 and 1384 in FIG. 13AS and 1354 and 1388 in FIG. 13AS and 1354 and 1364 in FIG. 13AR and 1354 and 1368 in FIG. 13AR. Reference 1360 points to FIG. 13AR. Reference 1358 points to FIG. 13AS.

With reference now to figure, FIG. 13AR and proceeding from FIG. 13Y, FIG. 13AR depicts a pictorial representation of an exemplary embodiment for the sectional view of the depiction of the first parental family tree of the tree owner node. It should be appreciated that FIG. 13AR is only exemplary and is not intended to assert or imply any limitation with regards to the environment in which different embodiments may be implemented. Many modifications to the depicted environments may be made. Reference 1362 points to FIG. 13AS. References 1364 and 1368 are spouses of 1354 on FIG. 13Y. Reference 1366 is the children label between 1364 and 1354 on FIG. 13Y. References 1372 and 1374 are the children between 1364 and 1354 on FIG. 13Y. Reference 1370 is the children label between 1368 and 1354 on FIG. 13Y. References 1376, 1378 and 1380 are the children between 1368 and 1354 on FIG. 13Y.

With reference now to figure, FIG. 13AS and proceeding from FIG. 13AR, FIG. 13AS depicts a pictorial representation of an exemplary embodiment for the sectional view of the depiction of the first parental family tree of the tree owner node. It should be appreciated that FIG. 13AS is only exemplary and is not intended to assert or imply any limitation with regards to the environment in which different embodiments may be implemented. Many modifications to the depicted environments may be made. References 1382 points to FIG. 13AR. References 1384 and 1388 are spouses of 1354 on FIG. 13Y. Reference 1386 is the child label between 1384 and 1354 on FIG. 13Y. Reference 1392 is the child of 1384 and 1354 on FIG. 13Y. Reference 1390 is the children label between 1388 and 1354 on FIG. 13Y. References 1394 and 1396 are the children between 1388 and 1354 on FIG. 13Y.

With reference now to figure, FIG. 13Z and proceeding from FIG. 13AS, FIG. 13Z depicts a pictorial representation of an exemplary embodiment for the sectional view of the depiction of the first parental family tree of the tree owner node. It should be appreciated that FIG. 13Z is only exemplary and is not intended to assert or imply any limitation with regards to the environment in which different embodiments may be implemented. Many modifications to the depicted environments may be made. Reference 1398 points to FIG. 13Y. Reference 1400 is the child of 1318 on FIGS. 13I and 850 on FIG. 13E. Reference 1402 is the spouse label between 1400 and 1404. Reference 1404 is the spouse of 1400. Reference 1406 is the children label between 1400 and 1404. References 1408, 1424, 1426 and 1428 are the children between 1400 and 1404. Reference 1410 is the spouse label between 1408 and 1412 and between 1408 and 1422. Reference 1414 is the child label between 1408 and 1412. Reference 1416 is the child between 1408 and 1412. Reference 1420 is the child label between 1408 and 1422. Reference 1418 is the child between 1408 and 1422.

With reference now to figure, FIG. 13J and proceeding from FIG. 13Z, FIG. 13J depicts a pictorial representation of an exemplary embodiment for the sectional view of the depiction of the first parental family tree of the tree owner node. It should be appreciated that FIG. 13J is only exemplary and is not intended to assert or imply any limitation with regards to the environment in which different embodiments may be implemented. Many modifications to the depicted environments may be made. Reference 1430 points to FIG. 131. Reference 1430 points to FIG. 13K. Reference 1434 is the spouse of 850 on FIG. 13E. Reference 1436 is the child label between 1434 and 850 on FIG. 13E. Reference 1438 is the child between 1434 and 850 on FIG. 13E. Reference 1440 is the spouse label between 1438 and 1442. Reference 1442 is the spouse of 1438.

Reference 1444 is the children label between 1438 and 1442. References 1446, 1448, 1450, 1452 and 1454 are children between 1438 and 1442. Reference 1456 is the spouse label between 1454 and 1458. Reference 1458 is the spouse of 1454. Reference 1460 is the child label between 1454 and 1458. Reference 1462 is the child between 1454 and 1458.

With reference now to figure, FIG. 13K and proceeding from FIG. 13J, FIG. 13K depicts a pictorial representation of an exemplary embodiment for the sectional view of the depiction of the first parental family tree of the tree owner node. It should be appreciated that FIG. 13K is only exemplary and is not intended to assert or imply any limitation with regards to the environment in which different embodiments may be implemented. Many modifications to the depicted environments may be made. Reference 1464 points to FIG. 13J. Reference 1466 is the spouse of 850 on FIG. 13E. Reference 1468 is the child label between 1466 and 850 on FIG. 13E. Reference 1470 is the child between 1466 and 850 on FIG. 13E. Reference 1472 is the spouse label between 1470 and 1474. Reference 1474 is the spouse of 1470. Reference 1476 is the children label between 1470 and 1474. References 1478, 1480, 1482, 1484 and 1486 are the children of 1470 and 1474.

With reference now to figure, FIG. 13G and proceeding from FIG. 13K, FIG. 13G depicts a pictorial representation of an exemplary embodiment for the sectional view of the depiction of the first parental family tree of the tree owner node. It should be appreciated that FIG. 13G is only exemplary and is not intended to assert or imply any limitation with regards to the environment in which different embodiments may be implemented. Many modifications to the depicted environments may be made. Reference 898 points to FIG. 13I. Reference 900 is the spouse of 850 on FIG. 13E. Reference 902 points to FIG. 13O. Reference 904 points to FIG. 13R.

With reference now to figure, FIG. 13S and proceeding from FIG. 13G, FIG. 13S depicts a pictorial representation of an exemplary embodiment for the sectional view of the depiction of the first parental family tree of the tree owner node. It should be appreciated that FIG. 13S is only exemplary and is not intended to assert or imply any limitation with regards to the environment in which different embodiments may be implemented. Many modifications to the depicted environments may be made. Reference 1060 points to FIG. 13R. Reference 1062 is the civil union spouse label between 1064 and 900 on FIG. 13G. Reference 1064 is the civil union spouse of 900 on FIG. 13G. Reference 1066 is the children label between 1064 and 900 on FIG. 13G. Reference 1068 points to FIG. 13AK. Reference 1070 points to FIG. 13AL.

With reference now to figure, FIG. 13AM and proceeding from FIG. 13S, FIG. 13AM depicts a pictorial representation of an exemplary embodiment for the sectional view of the depiction of the first parental family tree of the tree owner node. It should be appreciated that FIG. 13AM is only exemplary and is not intended to assert or imply any limitation with regards to the environment in which different embodiments may be implemented. Many modifications to the depicted environments may be made. Reference 1136 points to FIG. 13AL. Reference 1138 is the civil union child between 1064 in FIG. 13S and 900 in FIG. 13G. Reference 1140 is the spouse label between 1138 and 1142. Reference 1142 is the spouse of 1138. Reference 1144 is the children label between 1138 and 1142. References 1146, 1148 and 1150 are the children between 1138 and 1142. Reference 1152 is the civil union spouse label between 1142 and 1154. Reference 1154 is the civil union spouse of 1142. Reference 1156 is the children label between 1142 and 1154. References 1158 and 1160 are the children between 1142 and 1154.

With reference now to figure, FIG. 13AL and proceeding from FIG. 13AM, FIG. 13AL depicts a pictorial representation of an exemplary embodiment for the sectional view of the depiction of the first parental family tree of the tree owner node. It should be appreciated that FIG. 13AL is only exemplary and is not intended to assert or imply any limitation with regards to the environment in which different embodiments may be implemented. Many modifications to the depicted environments may be made. Reference 1122 points to FIG. 13AM. Reference 1120 points to FIG. 13AK. References 1124 and 1126 are the civil union children between 1064 in FIG. 13S and 900 in FIG. 13G. Reference 1128 is the spouse label between 1126 and 1130. Reference 1130 is the spouse of 1126. Reference 1132 is the child label between 1130 and 1126. Reference 1134 is the child between 1130 and 1130.

With reference now to figure, FIG. 13AK and proceeding from FIG. 13AL, FIG. 13AK depicts a pictorial representation of an exemplary embodiment for the sectional view of the depiction of the first parental family tree of the tree owner node. It should be appreciated that FIG. 13AK is only exemplary and is not intended to assert or imply any limitation with regards to the environment in which different embodiments may be implemented. Many modifications to the depicted environments may be made. Reference 1100 points to FIG. 13AL. Reference 1098 points to FIG. 13AJ. Reference 1102 is the civil union child between 1064 in FIG. 13S and 900 in FIG. Reference 1104 is the spouse label between 1102 and 1106 and between 1102 and 1114. References 1106 and 1114 are spouses of 1102. Reference 1108 is the child label between 1102 and 1106. Reference 1110 is the child between 1102 and 1106. Reference 1116 is the children label between 1102 and 1114. References 1112 and 1118 are the children between 1102 and 1114.

With reference now to figure, FIG. 13AJ and proceeding from FIG. 13AK, FIG. 13AJ depicts a pictorial representation of an exemplary embodiment for the sectional view of the depiction of the first parental family tree of the tree owner node. It should be appreciated that FIG. 13AJ is only exemplary and is not intended to assert or imply any limitation with regards to the environment in which different embodiments may be implemented. Many modifications to the depicted environments may be made. Reference 1072 points to FIG. 13AK. Reference 1074 is the civil union child between 1064 in FIG. 13S and 900 in FIG. Reference 1076 is the spouse label between 1074 and 1078. Reference 1078 is the spouse of 1074. Reference 1080 is the children label between 1074 and 1078. References 1082, 1088, 1090, 1092, 1094 and 1096 are the children between 1074 and 1078. Reference 1084 is the single child label of 1088. Reference 1086 is the child of 1088.

With reference now to figure, FIG. 13R and proceeding from FIG. 13AJ, FIG. 13R depicts a pictorial representation of an exemplary embodiment for the sectional view of the depiction of the first parental family tree of the tree owner node. It should be appreciated that FIG. 13R is only exemplary and is not intended to assert or imply any limitation with regards to the environment in which different embodiments may be implemented. Many modifications to the depicted environments may be made. Reference 966 points to FIG. 13O. Reference 968 is the child between 900 in FIG. 13G and 850 in FIG. 13E. Reference 970 is the spouse label between 968 and 972. Reference 972 is the spouse of 968. Reference 970 is the children label between 968 and 972. Reference 978 points to FIG. 13AH. Reference 976 points to FIG. 13AG.

With reference now to figure, FIG. 13AI and proceeding from FIG. 13R, FIG. 13AI depicts a pictorial representation of an exemplary embodiment for the sectional view of the depiction of the first parental family tree of the tree owner node. It should be appreciated that FIG. 13AI is only exemplary and is not intended to assert or imply any limitation with regards to the environment in which different embodiments may be implemented. Many modifications to the depicted environments may be made. Reference 1046 points to FIG. 13AH. Reference 1048 is the child between 968 and 972 in FIG. 13R. Reference 1050 is the spouse label between 1048 and 1052. Reference 1052 is the spouse of 1048. Reference 1054 is the children label between 1048 and 1052. References 1056 and 1058 are the children between 1048 and 1052.

With reference now to figure, FIG. 13AH and proceeding from FIG. 13AI, FIG. 13AH depicts a pictorial representation of an exemplary embodiment for the sectional view of the depiction of the first parental family tree of the tree owner node. It should be appreciated that FIG. 13AH is only exemplary and is not intended to assert or imply any limitation with regards to the environment in which different embodiments may be implemented. Many modifications to the depicted environments may be made. Reference 1028 points to FIG. 13AI. Reference 1026 points to FIG. 13AG. Reference 1030 is the child between 968 and 972 in FIG. 13R. Reference 1032 is the spouse label between 1030 and 1034. Reference 1034 is the spouse of 1030. Reference 1036 is the children label between 1030 and 1034. References 1038 and 1040 are the children between 1030 and 1034. Reference 1042 is the child label of 1038. Reference 1044 is the child of 1038.

With reference now to figure, FIG. 13AG and proceeding from FIG. 13AH, FIG. 13AG depicts a pictorial representation of an exemplary embodiment for the sectional view of the depiction of the first parental family tree of the tree owner node. It should be appreciated that FIG. 13AG is only exemplary and is not intended to assert or imply any limitation with regards to the environment in which different embodiments may be implemented. Many modifications to the depicted environments may be made. Reference 996 points to FIG. 13AH. Reference 998 points to FIG. 13AF. Reference 1000 is the child between 968 and 972 in FIG. 13R. Reference 1002 is the spouse label between 1000 and 1004 and between 1000 and 1008 and between 1000 and 1012. References 1004, 1008, and 1012 are spouses of 1000. Reference 1006 is the children label between 1000 and 1004. References 1016 and 1018 are the children between 1000 and 1004. Reference 1010 is the children label between 1000 and 1008. References 1020 and 1022 are the children between 1000 and 1008. Reference 1014 is the child label between 1000 and 1012. Reference 1024 is the child between 1000 and 1012.

With reference now to figure, FIG. 13AF and proceeding from FIG. 13AG, FIG. 13AF depicts a pictorial representation of an exemplary embodiment for the sectional view of the depiction of the first parental family tree of the tree owner node. It should be appreciated that FIG. 13AF is only exemplary and is not intended to assert or imply any limitation with regards to the environment in which different embodiments may be implemented. Many modifications to the depicted environments may be made. Reference 980 points to FIG. 13AG. Reference 982 is the child between 968 and 972 in FIG. 13R. Reference 984 is the spouse label between 982 and 986. Reference 986 is the spouse of 982. Reference 988 is the children label between 982 and 986. References 990, 992 and 994 are the children between 982 and 986.

With reference now to figure, FIG. 130 and proceeding from FIG. 13AF, FIG. 13O depicts a pictorial representation of an exemplary embodiment for the sectional view of the depiction of the first parental family tree of the tree owner node. It should be appreciated that FIG. 13O is only exemplary and is not intended to assert or imply any limitation with regards to the environment in which different embodiments may be implemented. Many modifications to the depicted environments may be made. Reference 958 points to FIG. 13R. Reference 956 points to FIG. 13L. References 960, 962 and 964 are the children between 900 in FIG. 13G and 850 in FIG. 13E.

With reference now to figure, FIG. 13L and proceeding from FIG. 13O, FIG. 13L depicts a pictorial representation of an exemplary embodiment for the sectional view of the depiction of the first parental family tree of the tree owner node. It should be appreciated that FIG. 13L is only exemplary and is not intended to assert or imply any limitation with regards to the environment in which different embodiments may be implemented. Many modifications to the depicted environments may be made. Reference 906 points to FIG. 13O. Reference 908 points to FIG. 13M. Reference 910 is the child between 900 in FIG. 13G and 850 in FIG. 13E. Reference 912 is the spouse label between 910 and 914. Reference 914 is the spouse of 910. Reference 916 is the children label between 910 and 914. Reference 918 points to FIG. 13AW. Reference 920 points to FIG. 13AT.

With reference now to figure, FIG. 13AW and proceeding from FIG. 13L, FIG. 13AW depicts a pictorial representation of an exemplary embodiment for the sectional view of the depiction of the first parental family tree of the tree owner node. It should be appreciated that FIG. 13AW is only exemplary and is not intended to assert or imply any limitation with regards to the environment in which different embodiments may be implemented. Many modifications to the depicted environments may be made. Reference 948 points to FIG. 13AV. References 950, 952 and 954 are the children between 910 and 914 in FIG. 13L.

With reference now to figure, FIG. 13AV and proceeding from FIG. 13AW, FIG. 13AV depicts a pictorial representation of an exemplary embodiment for the sectional view of the depiction of the first parental family tree of the tree owner node. It should be appreciated that FIG. 13AV is only exemplary and is not intended to assert or imply any limitation with regards to the environment in which different embodiments may be implemented. Many modifications to the depicted environments may be made. Reference 930 points to FIG. 13AW. Reference 932 points to FIG. 13AT. Reference 934 is the child between 910 and 914 in FIG. 13L. Reference 936 is the spouse label between 934 and 938. Reference 938 is the spouse of 934. Reference 940 is the children label between 934 and 938. References 942, 944 and 946 are the children between 934 and 938.

With reference now to figure, FIG. 13AT and proceeding from FIG. 13AV, FIG. 13AT depicts a pictorial representation of an exemplary embodiment for the sectional view of the depiction of the first parental family tree of the tree owner node. It should be appreciated that FIG. 13AT is only exemplary and is not intended to assert or imply any limitation with regards to the environment in which different embodiments may be implemented. Many modifications to the depicted environments may be made. Reference 922 points to FIG. 13AV. References 928, 926 and 924 are the children between 910 and 914 in FIG. 13L.

With reference now to figure, FIG. 13M and proceeding from FIG. 13AT, FIG. 13M depicts a pictorial representation of an exemplary embodiment for the sectional view of the depiction of the first parental family tree of the tree owner node. It should be appreciated that FIG. 13M is only exemplary and is not intended to assert or imply any limitation with regards to the environment in which different embodiments may be implemented. Many modifications to the depicted environments may be made. Reference 1488 points to FIG. 13L. Reference 1490 is the child between 900 in FIG. 13G and 850 in FIG. 13E. Reference 1492 is the spouse label between 1490 and 1494. Reference 1494 is the spouse of 1490. Reference 1498 points to FIG. 13AY. Reference 1496 points to FIG. 13AA.

With reference now to figure, FIG. 13AY and proceeding from FIG. 13M, FIG. 13AY depicts a pictorial representation of an exemplary embodiment for the sectional view of the depiction of the first parental family tree of the tree owner node. It should be appreciated that FIG. 13AY is only exemplary and is not intended to assert or imply any limitation with regards to the environment in which different embodiments may be implemented. Many modifications to the depicted environments may be made. Reference 1566 points to FIG. 13AA. Reference 1568 is the civil union spouse label between 1570 and 1494 in FIG. 13M. Reference 1570 is the civil union spouse of 1494 in FIG. 13M. Reference 1572 is the civil union children label between 1570 and 1494 in FIG. 13M. References 1584 and 1574 are the civil union children between 1570 and 1494 in FIG. 13M. Reference 1576 is the spouse label between 1574 and 1578.

Reference 1578 is the spouse of 1574. Reference 1580 is the child label between 1574 and 1578. Reference 1582 is the child between 1574 and 1578.

With reference now to figure, FIG. 13AA and proceeding from FIG. 13AY, FIG. 13AA depicts a pictorial representation of an exemplary embodiment for the sectional view of the depiction of the first parental family tree of the tree owner node. It should be appreciated that FIG. 13AA is only exemplary and is not intended to assert or imply any limitation with regards to the environment in which different embodiments may be implemented. Many modifications to the depicted environments may be made. Reference 1500 points to FIG. 13AY. Reference 1502 is the children label between 1490 and 1494 in FIG. 13M. References 1504, 1514 and 1526 are the children between 1490 and 1494 in FIG. 13M. Reference 1506 is the spouse label between 1504 and 1508. Reference 1508 is the spouse of 1504. Reference 1510 is the child label between 1504 and 1508. Reference 1512 is the child between 1504 and 1508. Reference 1516 is the spouse label between 1514 and 1518. Reference 1518 is the spouse of 1514. Reference 1520 is the child label between 1514 and 1518. Reference 1513 is the child between 1514 and 1518. Reference 1528 is the spouse label between 1526 and 1530. Reference 1530 is the spouse of 1526. Reference 1532 is the children label between 1526 and 1530. References 1520 and 1534 are the children between 1526 and 1530. Reference 1524 points to 1540 on FIG. 13AB. Reference 1536 points to 1542 on FIG. 13AB. Reference 1538 points to 1546 on FIG. 13AB.

With reference now to figure, FIG. 13AB and proceeding from FIG. 13AA, FIG. 13AB depicts a pictorial representation of an exemplary embodiment for the sectional view of the depiction of the first parental family tree of the tree owner node. It should be appreciated that FIG. 13AB is only exemplary and is not intended to assert or imply any limitation with regards to the environment in which different embodiments may be implemented. Many modifications to the depicted environments may be made. Reference 1540 points to 1524 on FIG. 13AA. Reference 1542 points to 1536 on FIG. 13AA. Reference 1558 is the spouse label between 1522 in FIG. 13AA and 1560. Reference 1560 is the spouse of 1522 in FIG. 13AA. Reference 1562 is the child label between 1522 in FIG. 13AA and 1560. Reference 1564 is the child between 1522 in FIG. 13AA and 1560. Reference 1544 is the children label of 1534 in FIG. 13AA. References 1556 and 1554 are the children of 1534 in FIG. 13AA. Reference 1546 is the spouse label between 1534 in FIG. 13AA and 1548. Reference 1550 is the child label between 1534 in FIG. 13AA and 1548. Reference 1552 is the child between 1534 in FIG. 13AA and 1548.

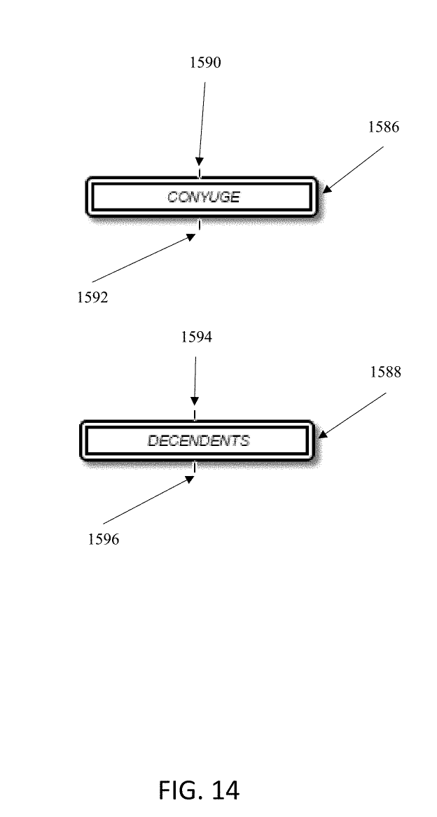

With reference now to FIG. 14, is an exemplary of the tags to join all member nodes in the graphically depicted family tree, in which an illustrative embodiment may be implemented. It should be appreciated that FIG. 14 is only exemplary and is not intended to assert or imply any limitation with regards to the environment in which different embodiments may be implemented. Many modifications to the depicted environments may be made.

With reference now to the figure, FIG. 14 depicts a pictorial representation of an exemplary embodiment of the tags to join all member nodes in the graphically depicted family tree, each member node is liked by the tags and provide the ability to connect multiple nodes in inclusive consanguinity, affinity and fictive kinship family tree relationships. Reference 1590 points to one or a series of spouses but not limited to civil unions, surrogate or common law. Reference 1586 is the label to display a connection between one or a series of spouses but not limited to civil unions, surrogate or common law; the label term conyuge is only exemplary and is not intended to assert or imply any limitation with regards to the environment in which different embodiments may be implemented. Many modifications to the depicted environments may be made. Reference 1592 points to one or a series of spouses but not limited to civil unions, surrogate or common law referenced by the pointing of 1590. Reference 1594 points to one or a series of spouses parenting a child or children or offsprings by the pointing referenced by 1596 and it is not limited to civil unions, surrogate or common law. Reference 1588 is the label to display a connection between one or a series of spouses but not limited to civil unions, surrogate or common law and the references in 1590 and 1592; the label term decedents is only exemplary and is not intended to assert or imply any limitation with regards to the environment in which different embodiments may be implemented. Many modifications to the depicted environments may be made.

I claim:

1. A method and system for internet/cloud graphical depiction of inclusive of consanguinity, affinity and fictive kinship family tree members nodes using hierarchy of relationships comprising:
Selecting family trees and hierarchies for member tree owners of inclusive of consanguinity, affinity and fictive kinship relationships;
displaying depicting family trees and hierarchies for member tree owners of inclusive of consanguinity, affinity and fictive kinship relationships;
utilizing an internet/cloud network/marketplace with independently participating merchants and service providers;
aiding modern and traditional families by providing a network/marketplace directed to procure good services for alive and deceased members of their family tree and hierarchy;
depicting family trees and hierarchies for member tree owners of inclusive of consanguinity, affinity and fictive kinship relationships; and
matching member nodes in their family trees and hierarchies for member tree owner for all the member parents inclusive of consanguinity, affinity and fictive kinship relationships.

2. The method of claim 1, wherein a reduction of effort, time and cost by matching member nodes part of family trees and hierarchies to merchant and service providers using node's geo locations.

3. A system for internet/cloud graphical depiction of inclusive of consanguinity, affinity and fictive kinship family tree members nodes using hierarchy of relationships, said system comprising:
one or more hypertext transfer protocol pages;
one or more computer connected to the internet or cloud;
one or more servers connected to the internet or cloud;
one or more databases stored in server in the internet or cloud;
one or more devices able to connected the internet or cloud;
one or more members of family trees and hierarchies able to connect to the internet or cloud;
more than one merchants or service providers in a network/marketplace connected to the internet or cloud.
